(19) United States
(12) Patent Application Publication
(10) Pub. No.: US 2011/0291940 A1
(43) Pub. Date: Dec. 1, 2011

(54) DATA ENTRY SYSTEM

(76) Inventor: Benjamin Firooz Ghassabian, Jerusalem (IL)

(21) Appl. No.: 13/146,203

(22) PCT Filed: Feb. 4, 2010
(86) PCT No.: PCT/IL10/00098

§ 371 Date: Jul. 26, 2011

(30) Foreign Application Priority Data
Feb. 4, 2009 (IL) 196898
Feb. 5, 2009 (IL) 196933
Feb. 9, 2009 (IL) 196969
Mar. 26, 2009 (IL) 197861
Apr. 7, 2009 (IL) 198068
Jun. 9, 2009 (IL) 199258
Jun. 21, 2009 (IL) 199466
Jul. 19, 2009 (IL) 199947
Aug. 16, 2009 (IL) 200428
Aug. 20, 2009 (IL) 200513
Sep. 21, 2009 (IL) 201089
Nov. 19, 2009 (IL) 202245

(51) Int. Cl. G06F 3/02

(52) U.S. Cl. 345/169

(57) ABSTRACT

A system for data entry is provided. The system includes a touch sensitive pad for inputting user gestures and a processor to assign a virtual keypad to the touch sensitive pad such that user gestures on the pad correspond to keys of the virtual keypad. According to one embodiment gestures on the touch sensitive pad correspond to key presses on a cellular phone type keypad.

### RELATED APPLICATIONS

The present application claims the benefit, under Israeli patent applications:

196898 filed Apr. 2, 2009

196933 filed May 2, 2009;

196969 filed Sep. 2, 2009;

197861 filed 26 Mar. 2009;

198068 filed Jul. 4, 2009;

199258 filed Sep. 6, 2009;

199466 filed 21 Jun. 2009;

199947 filed 19 Jul. 2009;

200428 filed 16 Aug. 2009;

200513 filed 20 Aug. 2009;

201089 filed 21 Sep. 2009;

202245 filed 19 Nov. 2009, the disclosures of which are all incorporated herein by reference in their entirety.

This application is also related to various prior PCT publication, including WO01/131788, titled “Integrated Keypad System”, WO03/007288 titled “Features to Enhance Data Entry Through a Small Data Entry Unit”, WO04/095414 titled “System to Enhance Data Entry in Mobile and fixed Environment”, WO05/122401 titled “System to Enhance Data Entry in Mobile and fixed Environment”, WO07/114,833 titled “Data Entry System”, WO08/114,086 titled “Combined Data Entry Systems”, WO09/027,817 titled “Improved Data Entry System”, PCT/IL2009/000790 titled “Data Entry System”, and PCT/IL2009/000794 titled “Data Entry System”, the disclosures of all of which are also incorporated herein, by reference, in their entirety.

### FIELD OF THE INVENTION

The present invention relates to data input devices and particularly to devices and methods for entering data/text including letters and other symbols.

### BACKGROUND OF THE INVENTION

Mobile devices such as cellular phones, personal digital aids and miniature computers are widely used as they are easily carried around and can perform many tasks. One problem of the mobile devices is text entry, which is problematic due to their small size. One solution for text entry in mobile devices is using a limited key set in which at least some of the keys are ambiguously associated with a plurality of letters.

One problem with the use of ambiguous keys is when a user inadvertently presses an incorrect key. In such cases the system will suggest to the user words that were not intended. The user then needs to erase the incorrect letter and enter the correct key stroke.

U.S. Pat. No. 5,818,437 suggests providing, in addition to a main window, an additional window which provides feedback on the keys pressed, in the form of the letters associated with each key pressed for the current word. In one embodiment, the 5,818,437 patent suggests displaying a plurality of possible words directly in the main window for the user to select the intended word. These feedback methods may, however, be confusing and may not provide the user sufficient ease in identifying errors in typing.

It also has been suggested to encode all the letters of the alphabet by pairs of keys. Such suggestions are described, for example, in US patent publication 2006/0066583 to Toutonghi et al., titled: “Text entry method and system using a numeric or non-QWERTY keypad” and in U.S. Pat. No. 5,982,303 to Smith, titled: “Method for Entering Alphanumeric Data”. This method, however, requires that the user remember the key sequences for all the letters.

Another problem of mobile devices is entering symbols other than the alphanumeric characters. The number of keys on the mobile devices is limited and various methods have been suggested to allow simple entering of symbols with limited keys. Still there is a need for better solutions.

Some mobile devices receive user input through a touch screen. Touch screens are also used on non-portable devices. US patent application 2007/0097092 to Jung et al., titled: “Method of using a Touch Screen and user interface apparatus employing the same” describes using a touch screen with a plurality of zones having identical keys for different users.

US patent publication 2009/0073002 to Alvarado describes a scheme in which the letters of the alphabet are entered by straight line traces on a touch screen. The touch screen is divided into various cells and traces in different locations are given different interpretations.

US patent publication 2002/0180797 to Backmann uses a combined method of strokes and key presses to enter words. The strokes are assigned to the vowels and to shortcuts.

U.S. Pat. No. 7,519,748 to Kuzmin, titled: “Stroke-Based Data Entry Device, System and Method”, describes a method in which strokes are associated with letters for input. The strokes are interpreted according to their direction and their starting zone. U.S. Pat. No. 7,170,496 to Middleton, describes an input method using gestures of a data entry system. The system provides feedback in the form of the symbol corresponding to the gesture currently entered, so the user can change the gesture if necessary. These methods require that the user remember the associations between the strokes and the letters, a task which may be problematic for some users.

Several other input methods may be used with a keyboard having few keys wherein to each of at least some of said keys more than one symbol such as character or letter are ambiguously assigned. In such keypads, generally an interaction such as a pressing action on a key may ambiguously correspond to any of the symbols assigned to the key (such key may be called an “ambiguous key”).

According to one method, a multi-tap scheme in which the user indicates the intended letters by using different numbers of taps on the same key may be used for disambiguation. Use of a multi-tap scheme, however, is slow and inconvenient to many users.

According to another method, in order to enter one of the symbols (such as a letter) among the group of symbols assigned to a key, the user may provide a predefined interaction with the key such as a pressing action on the key and provide a speech information corresponding to the symbol (such as speaking the appellation of the letter) for selecting the letter among the letters that are assigned to the key, and wherein the speech information may be detected and analyzed based on at least one of, the user's voice and/or the user's lip movements. According to one method symbols such as letters having ambiguously resembling predefined speech and that are hard to distinguish from each other through their corresponding speech may be separated from each other being assigned to different keys.

The data entry systems providing precise characters may be combined with the principles of a word predictive system based on key presses alone, to provide a highly accurate data/text entry system using few keys. The principles of word predictive systems based on key presses alone (e.g. T9) are known by people skilled in the art.

Methods for text entry using word predictive systems in which at least one letter is input unambiguously and other letters can be input ambiguously, are known. WO 2009/027817 (to Ghassabian) describes a data entry system that uses a system having two keypads. The first keypad has all the letters of an alphabet distributively assigned to a small number of keys (e.g. four) such that at least two of the letters are assigned to at least one of said keys of the first keypad keys. The second keypad (for example a telephone-type keypad) also includes all of the letters of the alphabet of the language, distributively assigned to at least some of its keys such that at least two of the letters are assigned to at least one of the keys of the second keypad set of keys. Typically, the letters are distributed such that an ambiguous key of the first keypad and an ambiguous key of the second keypad have at most one common letter/character. For entering a letter precisely, the user may first press on the key of the first keypad to which said character is ambiguously assigned. The system may predict an undesired character. The user then may press on the key of the second keypad to which the desired character is also ambiguously assigned. As described, said pair of keys may have at most one common character which in this case is the desired character. The system thus provides said the desired character.

For entering a word the user uses/taps-on the corresponding keys of the first keypad and the system predicts a corresponding word (if the word is in the dictionary), or a chain of characters (if the word is not in the dictionary). A correction procedure may be performed by the user when the system offers (predicts) an undesired word, in which the first keypad is used for character entry and the second keypad is used to replace one (or more) ambiguous character of the predicted word by one (or more) precise character (to correct a wrongly predicted set of characters). By using key-presses of two keypads, the data entry system may provide precise character identification, with the unique character common to the two keys being unambiguously selected thereby. By considering the ambiguous characters and the precise character(s) provides as described, the system may propose another word to the user.

Word predictive systems based on key press information use at least a dictionary of words that may also include a database the corresponding key presses for each word.

Data may be input through means other or additional to key presses. For example, a user may perform gliding actions upon a touch sensitive screen to duplicate or imitate key interactions.

### SUMMARY OF THE INVENTION

This application is generally related to a word predictive data entry system that may receive input of ambiguous and/or unambiguous characters. Furthermore, the system is designed to duplicate or imitate the functionalities of at least a PC keyboard permitting a user to enter letters, numbers and any special character, command, and function available on the keyboard quickly and easily. The system generally uses a first set of input signals and one or more different sets of second/additional input signals. The main information corresponding to data entry (e.g., text input) is provided through the first set of input signals. If the output provided by the system based on the input provided through the first input signal is not accurate or undesired, then, at least a second set of input signals is also used to provide an accurate or desired output by the system, considering the input provided through the first and second set of input signals. According to one embodiment, the first set of input signals comprises less signals than the second set of input signals.

Although throughout this patent applications, common means such as keys, and interactions such as pressing actions and/or gliding actions to duplicate key interactions, are generally used to describe providing said input signals, any other type of means and interaction may be used by people skilled in the art to provide said input signals to be used with the embodiments, methods, and other features, of the invention.

The first and second sets of keys may support the at least the Latin alphabet and/or any other alphabet of interest, such as Arabic, Hebrew, Korean, etc., or at least portions thereof. Furthermore, the first and second sets of keys may cover additional symbols, such as digits, punctuation marks and/or other symbols conventionally appearing on keyboards. In some embodiments of the invention the system may be used to enter text in languages based on phonetic symbols/alphabet such as Chinese or Japanese.

Alternatively, some symbols which are less frequently used may be provided using unambiguous key strokes, such as using the keys of the first set or of the second set with a state selection key (e.g., a shift button). In one embodiment of the invention one or more of the keys of the first or second set may additionally serve as state selection keys, such as when depressed for longer than a predetermined duration, for example.

Optionally, the number of symbols supported by the system may include substantially all of the elementary symbols, such as alphanumeric characters, punctuation marks, commands, and functions for either the input or editing of a text or for the manipulation of a computer. Other symbols such as macros or portion-of-words (e.g. described in other patent applications filed by this inventor), may also be distributively assigned to the reduced number of keys.

In accordance with an exemplary embodiment of the invention, there is therefore provided: a computerized device, comprising (i) a first input interface adapted to identify a plurality of different first user input signals, (ii) a second input interface adapted to identify a plurality of second user input signals and (iii) a processor configured to ambiguously correspond each of at least one of the first input signals with a first plurality of symbols, and to ambiguously correspond actuation of each of at least one of the second input signals with a second plurality of symbols. The processor associates each of the second plurality of symbols with one of the first input signals, in such a manner that the second plurality of symbols corresponds to a plurality of the first input signals.

The data entry systems of the invention using the first and second set of keys based on principles just described are being described in detail in PCT application WO09/027,817 titled “Improved Data Entry System” and PCT applications 043BG and YS filed by this inventor, the disclosures of which are incorporated herein, by reference. It is the purpose of this patent application to provide several enhancements to the data entry systems of the invention.

An aspect of some embodiments of the invention relates to a data entry unit which receives user selections of keys of at least the well known 12 key telephone keypad in the form of gliding actions (e.g. vectors) which indicate respective positions of keys in at least the 12 key telephone pad. For example, the vectors may be interpreted as relating to the key to which the vector points if its start point is at the middle 5 button of the telephone keypad.

Optionally, the data unit is adapted to receive indications of 5 or at least 7 keys of the well known telephone keypad using the vectors. The other keys may be provided using other means or the data unit may not be adapted to receive indications of the other keys.

An aspect of some embodiments of the invention relates to using gliding/taping actions in order to dial a telephone number.

In some embodiments of the invention, the vectors are received in the form of gliding (e.g. swiping) gestures on a touch sensitive surface such as a touch screen of the data entry unit. In another embodiment, the vectors are received in the form of pressing a sequence of two keys in the direction of the vector. Optionally, the vectors are associated with the keys of the 12 key telephone keypad only based on their direction. Alternatively, the length and or the speed of the vector is also taken into consideration. The vectors are optionally associated with the keys without relation to their starting position on the touch screen.

An aspect of some embodiments of the present invention relates to a selection means and its corresponding marker that permits navigating within the letters of the/a (e.g. current) word to select one of its letters and wherein the system relates the next input information provided by the user to said character position.

An aspect of some embodiments of the present invention relates to capitalizing a letter in a character position during the entry of a word, by providing a predefined interaction preferably other than a short tapping action a predefined key preferably of the first keypad and providing a pressing action on the desired ambiguous letter key of the first keypad, causing to enter a corresponding letter in said character position in upper case.

An aspect of some embodiments of the present invention relates to creating systems and methods so that the system automatically relates a gliding action or a tapping action to either data entry system of the invention or to a computer mouse function. For example, a gliding/tapping action provided during the entry of word may be related to providing input information corresponding to said word, and a gliding/tapping action which is not provided during the entry of word may be related to a corresponding mouse function.

An aspect of some embodiments of the present invention relates to grouping symbols such as at least the special characters, functions, commands, etc., in few groups each group based on one or more predefined common characteristics. Each of said group of symbols being assigned a predefined interaction other than a simple tapping action with/on preferably the keys other than the keys of the second keypad, preferably to the keys of the first keypad. Said predefined interaction preferably being a long pressing (e.g. and holding) action for at least a predefined of time on the corresponding key. When such predefined action is provided on a corresponding key, the system enters into a corresponding mode instance and predefinely relates each of the characters of the corresponding group to one of the keys of at least the second keypad. Optionally. providing a pressing action simultaneously or immediately after on a key of the second keypad may enter the symbol on said key.

An aspect of some embodiments of the present invention relates to displaying all of the letters relating to each of the ambiguous character positions. Optionally, the letters for each character position are shown in “letter column”. Optionally, the letter columns are displayed when a “BackSpace” key is pressed and are removed when a letter key of the first keypad is pressed.

An aspect of some embodiments of the present invention relates to a first keypad of the invention including ambiguously both the alphanumeric characters of a language and any special character to support entering words including any type of character (e.g. formulas, URLs, computer programming languages, slings, etc.). Optionally, the system may include at least two different second keypads for the correction procedure in case the system does not predict the desired word based on the key presses provided through the first keypad alone.

An aspect of some embodiments of the present invention relates to a data entry unit which receives, for at least some character positions within a word or a chain of characters, user input signals ambiguously associated with a plurality of letters and displays for those character positions a single letter selected in an attempt to guess the letter intended by the user. The data entry unit displays letters representing character positions associated with a plurality of letters in a manner different than it displays letters representing character positions associated with a single letter.

In some embodiments of the invention, the letters of single letter character positions are displayed in a different font, color or size than letters of multi-letter character positions. Alternatively or additionally, letters representing multi-letter character positions are displayed with a marking on, above, or below, the letter. In some embodiments of the invention, the marking includes the other letters with which the character position is associated, preferably in a larger font than the letter of the character position anywhere on the screen.

An aspect of some embodiments of the invention relates to a method of data input in which user swiping gestures result in different functions responsive to the width of the gesture. Optionally, a data entry unit differentiates between swiping gestures provided by a stylus and gestures provided by a finger, or between gestures provided by different fingers.

An aspect of some embodiments of the present invention relates to a data entry unit of an electronic device including a touch sensitive surface (e.g. pad, screen), which relates differently to similar movements on different zones of the screen. Optionally, the unit may also include few hard keys associated with at least the letters to enter the main portion of the text through said hard keys rather through the touch sensitive surface.

Optionally, the screen is divided to at most six zones.

An aspect of some embodiments of the present invention relates to a reduced-size data entry unit used mainly as a keyboard for an electronic device mainly a computing device. The unit may include the first and the second sets of keys as described. Optionally, the unit may include at least one touch sensitive surface (e.g. pad, screen) to replace the second set of keys through different gliding actions. Optionally, the touch sensitive surface may also be used to duplicate the use of the first set of keys, therefore replacing also said first set of keys. The unit may include its own processor which may be a low powered processor used mainly with the data entry system. The unit may also include its own memory which may be of reduced size used mainly with the data entry system. The Unit may also include its own display unit mainly used to print the text for user review. Optionally, the unit communicates with the corresponding electronic device through wires or wirelessly.

An aspect of some embodiments of the present invention relates to a detachable keypad which includes keys corresponding to all the letters of the alphabet, which is operable when detached such that the letters may be split between at least two detachable units. Optionally, the keypad communicates with the corresponding electronic device through wires or wirelessly.

An aspect of some embodiments of the invention relates to a data entry system which during the entry of a word the system displays soft keys for the letters/characters associated with the first character position of the word associated ambiguously with a plurality of characters. Optionally after the user selects one of said characters, the system displays soft keys for the next character position of the word associated ambiguously with a plurality of characters.

### BRIEF DESCRIPTION OF FIGURES

Exemplary non-limiting embodiments of the invention will be described with reference to the following description of embodiments in conjunction with the figures. Identical structures, elements or parts which appear in more than one figure are preferably labeled with a same or similar number in all the figures in which they appear, in which:

FIG. 1 is a schematic illustration of a first and a second keypad and portions of the word database and a device using those features;

FIGS. 1A-1F are schematic illustration of different group of symbols in different mode instances, in accordance with some exemplary embodiments of the invention;

FIGS. 2-2C are schematic illustration of single finger and multi-finger interactions, in accordance with some exemplary embodiments of the invention;

FIGS. 3A-3C are schematic illustration of short and long gliding actions, in accordance with some exemplary embodiments of the invention;

FIGS. 4A-4C are schematic illustration of short and long gliding actions, in accordance with some exemplary embodiments of the invention;

FIGS. 5A-5C are schematic illustration of short and long gliding actions, in accordance with some exemplary embodiments of the invention;

FIGS. 6A-6B are schematic illustration of different groups of symbols on the second keypad corresponding to different mode, in accordance with an exemplary embodiment of the invention;

FIGS. 7A-7B are schematic illustration of different directions and zones of gliding actions to imitate interactions with keys of a keypad, in accordance with an exemplary embodiment of the invention;

FIGS. 8A-8D are schematic illustration of different directions and zones of gliding actions to imitate interactions with keys of a keypad, in accordance with an exemplary embodiment of the invention;

FIG. 9 is a schematic illustration of a second keypad displayed on the screen of a device and a gliding action to duplicate an interaction with a key of the keypad, in accordance with an exemplary embodiment of the invention;

FIGS. 10A-10C are schematic illustration of different directions and zones of gliding actions to imitate interactions with keys of a keypad, in accordance with some exemplary embodiments of the invention;

FIGS. 11A-11D are schematic illustration of a data entry unit, in accordance with some exemplary embodiments of the invention;

FIGS. 12A-12D are schematic illustration of a data entry unit, in accordance with some exemplary embodiments of the invention;

FIGS. 13A-13C are schematic illustration of a on-screen helping feature, in accordance with some exemplary embodiments of the invention;

FIGS. 14A-14C are schematic illustration of a on-screen helping feature, in accordance with some exemplary embodiments of the invention;

FIGS. 15A-15B are schematic illustration of a touch sensitive surface divided in different portions, in accordance with some exemplary embodiments of the invention;

FIGS. 16A-16B are schematic illustration of multi gliding actions, in accordance with some exemplary embodiments of the invention;

FIGS. 17A-17D are schematic illustration of combinations of pressing actions on more than one key of the first keypad for entering symbols, in accordance with some exemplary embodiments of the invention;

FIGS. 18A-18D are schematic illustration of combinations of pressing actions on more than one key of the first keypad for a correction procedure, in accordance with some exemplary embodiments of the invention;

FIGS. 19A-19B are schematic illustration of combinations of pressing actions on more than one key of the first keypad, in accordance with some exemplary embodiments of the invention;

FIGS. 20A-20D are schematic illustration of combinations of pressing actions on more than one key of the first keypad, in accordance with some exemplary embodiments of the invention;

FIGS. 21A-21E are schematic illustration of the entry of a letter and its derivatives, in accordance with some exemplary embodiments of the invention;

FIGS. 22A-22G are schematic illustration of the entry of some words in a language wherein some of its letters have derivatives, in accordance with some exemplary embodiments of the invention;

FIG. 23A is a schematic illustration of the entry of a letter and its derivatives, in accordance with some exemplary embodiments of the invention;

FIG. 24 is a schematic illustration of the entry of combined-characters, in accordance with some exemplary embodiments of the invention;

FIGS. 25A-25G are schematic illustration of the entry of words having combined-characters, in accordance with some exemplary embodiments of the invention;

FIGS. 26A-26E are schematic illustration of the entry of a character and its derivation, in accordance with some exemplary embodiments of the invention;

FIGS. 27A-27C are schematic illustration of the entry of words, in accordance with some exemplary embodiments of the invention;

FIG. 28 is a schematic illustration of the entry of words and selecting an item in a media search interface, in accordance with some exemplary embodiments of the invention;

FIGS. 29A-29B are schematic illustration of the entry of words and selecting an item in a media search interface, in accordance with some exemplary embodiments of the invention;

FIGS. 30A-30B are schematic illustration of a learning game, in accordance with an exemplary embodiment of the invention;

### DETAILED DESCRIPTION OF EMBODIMENTS

According to a preferred embodiment of the invention, the system may include a first set of input signals provided for example through a first set of few keys (e.g. the first keypad) wherein at least the letters of one (e.g., or more) language are disributively and ambiguously assigned to at least some (e.g. preferably four) of said few keys such that to each of said at least some of said few keys more than one of said letters are ambiguously assigned (e.g. ambiguous keys). Preferably, said letters are distributed on said keys such that when a user presses the keys corresponding to the characters (e.g. letters) of a desired word (e.g. first input information) mostly the desired word is proposed to the user by the system based on said key presses (e.g. said first input information) alone. It is understood that in some cases the desired word may not be proposed as a first choice to the user (e.g. the desired word may not have the highest priority among the words that correspond to the same key presses) and the system may propose another word (e.g. a non desired word that has a higher priority).

According to a preferred embodiment, the system may include at least a second set of input signals provided for example through a second set of keys (e.g. the second keypad) such as a telephone-type keypad keys wherein to at least some of the keys of said second set of keys at least the letters of the same one (e.g., or more) language are distributively assigned such that to each of said at least some of said keys of the second set of keys more than one of said letters are ambiguously assigned.

According to one embodiment of the invention, the letters on said few (e.g. four ambiguous) keys of said first set of keys and the letters on said additional/second set of keys (e.g. telephone-type kepad) may be distributed such that a (e.g. any) key of said ambiguous (letter) keys of said first keypad and a (e.g. any) key of said ambiguous (letter) keys of said second keypad may have at most one common character (e.g. letter).

Thus, by pressing a key of a first set of keys and a key of the second set of keys for a specific character/letter or for a specific character location within a word (e.g. a word may have one or more characters), the user indicates a specific letter/character (e.g. the common letter/character) unambiguously. In other words, in order to enter a precise character/letter the user may first press the key of the first keypad corresponding to said character/letter and then press the key of the second keypad also corresponding to said desired character/letter, or vice-versus. By considering said key presses and the fact that there is at most one common character on the two keys, the system precisely selects/enters the desired (e.g. the common) character/letter.

By using key-presses of two keys, the data entry system of the invention thus provides precise character identification, with the unique, character common to the two keys being unambiguously selected thereby. Although having utility on its own, the system as described hereinabove may usefully be used together with a software based word predictive system wherein ambiguous key selections are compared with words within a database including words and corresponding key press information as known, to predict or confirm the user's intention. The principles of such word predictive systems are known to those skilled in the art.

As an example, in order to enter a desired word, according to one method the user may first provide a first input information by pressing the (ambiguous) keys of the first keypad corresponding to the characters of the desired word. The system may propose a word from the database corresponding to the first input information. In accordance with one method, the word suggested is the word having the highest priority among the words corresponding to the input information. If the proposed word is not the desired word, the user may proceed with what is referred to herein as a correction procedure providing additional input information by pressing a key of the second keypad corresponding to one of the characters, eventually, the first character, of the desired word. By relating the key presses of the first and the second keypad corresponding to the character, and the fact that there is at most one character common to both selected keys, the character is precisely and unambiguously selected, and the system precisely recognizes the character. By considering the combined input information, the system proposes another word from the database corresponding to the combined information. If the new word proposed by the system is not the desired word, the user may provide additional input information, e.g. by pressing the key of the second keypad corresponding to another character preferably the next character of the desired word, and so on, until the system proposes the desired word.

According to another method, the user may first provide precisely at least one character of the desired word as described above, and additionally press the ambiguous keys of the first keypad that (non-uniquely) correspond to the remaining characters of the desired word. By precisely recognizing at least one character of the word and by also considering the ambiguous key presses corresponding to the remaining characters of the word, the system is able to more accurately predict the desired word and proposes it to the user. If the proposed word is not the desired word, the user may provide additional pressing actions on the keys of the second keypad corresponding to the additional characters of the desired word until the system predicts/proposes the desired word.

If the desired word is not in the dictionary, then, in addition to the first input information provided through the first keypad, generally, the user presses the keys of the second keypad corresponding to all of the letters of the desired word.

Preferably, the first keypad of the invention has generally less (letter) keys (e.g. preferably four letter keys) than the second keypad (e.g. a telephone type keypad having eight letter keys). This is because the main portion of a text may be entered through the first keypad without the need of using the second keypad. Obviously, having/using less keys makes the text entry easier and faster.

The data entry system and correction thereof as described hereinabove is a very fast and easy system. Briefly stated, according to a preferred method, the user types the desired word through the first keypad. Generally, the system proposes the right (e.g. desired) word. If not the user begins to retype the word using the second keypad. If the word is in the dictionary, most of the time, the system proposes the word as soon as retyping the word through the second keypad commences. If the word is not in the dictionary, the user generally retypes all of the letters/characters of said word. With such word predictive data/text entry system, the user does not have to worry about if the word is or is not in the dictionary database. He knows that at some point during typing/using the first keypad (e.g. the system may also include a word completion method) or during the retyping procedure using the second keypad the system will propose the desired word.

The embodiments described above are being explained through the example hereafter.

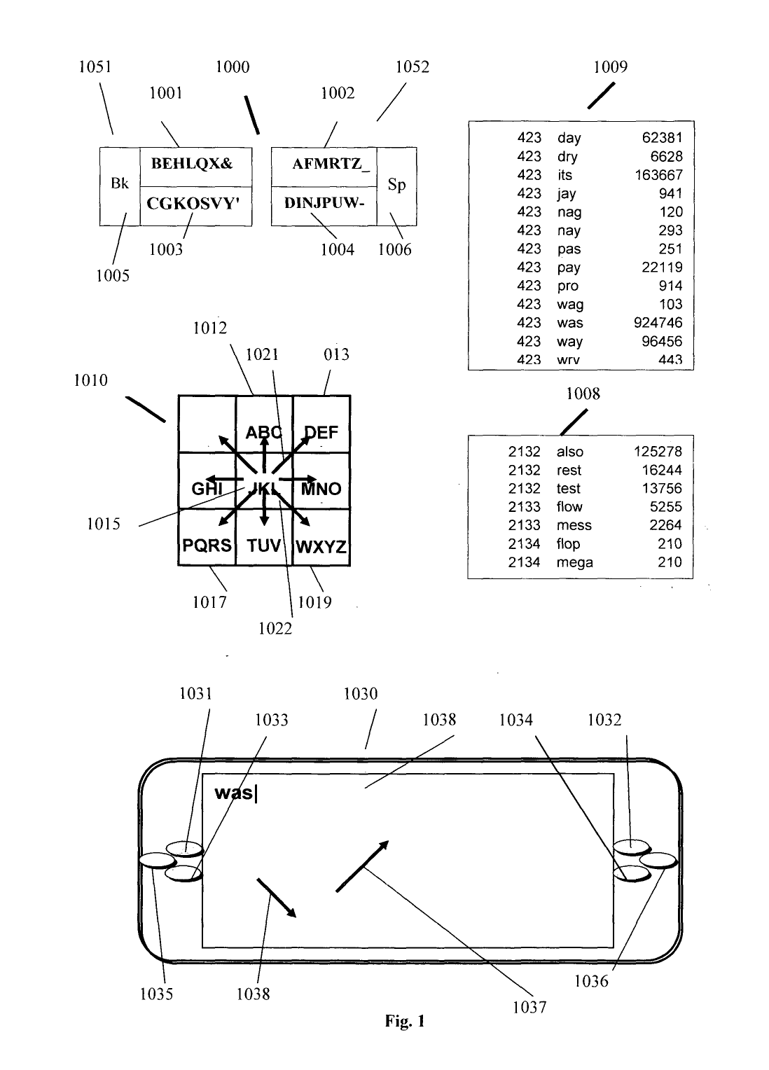

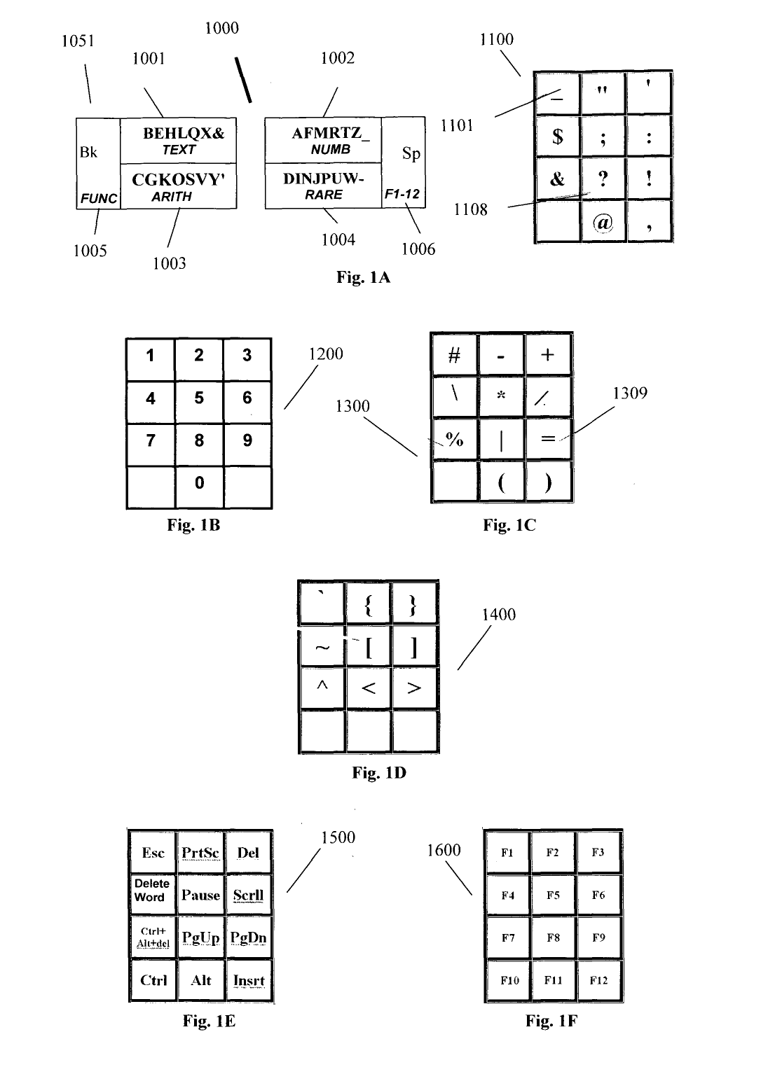

FIG. 1 shows as an example, an exemplary first keypad 1000 as described above wherein to four of its keys 1001-1004 all of the letters of the English language are distributively assigned. The keypad 1000 also includes two additional keys 1006, 1005 to respectively provide Space character and BackSpace function.

FIG. 1 also shows an exemplary second keypad 1010 of the invention which in this example is a telephone-type keypad wherein all of the letters of the English language are also distributively assigned to eight of its keys.

As an example, by considering the portion of the database of words 1009 used by the system, in order to enter the word “day” the user may press on ambiguous keys 1004, 1002, 1003. The system may propose/predict the word “was” which corresponds to said key presses and has the highest priority among the words of the database corresponding to said key pressing actions. At this time the user may proceed to the correction procedure of the invention and press on the key 1013 of the second keypad 1010 to which the first character (e.g. “d”) of the desired word id assigned. By considering the key pressing action corresponding to the first character of the desired word provided on the key 1001 of the first keypad 1000 and on the key 1013 of the second keypad 1010, the systems understands that the only common character (e.g. “d”) on said keys is precisely the first character of the desired word. By considering said character and the key press information corresponding to the remaining characters of the desired provided through the first keypad the system proposes the word “day” which corresponds to the combined information provided by the user an has the highest priority among the words of the database corresponding to said combined information.

As described above, the interaction with the keys of a keypad may be duplicated of imitated by providing gliding or swiping actions preferably on a touch sensitive surface or in the air. For example, if the device relating to the data entry system of the invention has a touch sensitive surface and the second keypad of the invention is an imaginary telephone-type keypad model, according to one embodiment of the invention, providing a tapping action on any location on said surface may duplicate a taping action on the center key of said keypad to which the characters “JKL5” are generally assigned. In order to duplicate an interaction with another key of said keypad, the user may provide a gliding action on the touch sensitive wherein said gliding action duplicates a gliding action departing from the center key of the imaginary second keypad towards the desired key of said keypad.

As an example, FIG. 1 shows a device 1030 having a touch screen 1038 and using the data entry system of the invention. Said device includes/uses the first keypad being split in two portions wherein the first portion includes the keys 1031, 1033, 1035 duplicating the keys 1001. 1003, 1005 of the keypad 1000, and the second portion includes the keys 1032, 1034, 1036 duplicating, the keys 1002, 1004, 1006, of said keypad 1000. The device 1030 also uses an imaginary keypad model 1010 which is in the form of a telephone-type keypad and is used as the second keypad. In the example of the entry of the word “day”, after the user presses the corresponding keys of the first keypad of the device, the system may propose the word “was”, In order to duplicate/imitate the pressing action on the key 1013 of the imaginary second keypad, the user may provide the gliding action 1037 that duplicates a gliding action departing from the center letter key 1015 of the imaginary keypad model 1010 towards the desired key 1013. The system recognizes that the user interacts with the key 1013 of the imaginary keypad model, and based on the principles as described in detail, proposes the word “day”.

Also as an additional example, the gliding action 1038, duplicates the imaginary gliding actions 1022, which corresponds to interacting with the keys 1019 of the imaginary keypad model 1010

Symbols such as special characters, commands, and functions, of PC keyboard and/or customized, may be grouped in different categories based on their characteristics (e.g. digits 0-9, punctuations, arithmetic characters, PC commands, etc.). Each group may be assigned to a different mode instance provided by providing a predefined type of interaction (e.g. a long, double, strong, pressing action) other than another the predefined type of interaction (e.g. a short, soft, tapping/pressing action) which is used/required with the keys of at least the first keypad for entering ambiguous characters such as letters. According to one embodiment, after the system enters into a corresponding mode, the system shows each of the symbols of the corresponding group on one of the keys of an on-screen keyboard for example if form of a telephone-type keypad. The user then may provide a pressing action, or a gliding action on or corresponding to the desired key shown on the screen. FIGS. 1A to 1F are shown to describe as an example the “mode” keys of the invention in detail.

FIG. 1A shows as an example, the first keypad 1000 as was shown in FIG. 1. in this example, the special symbols used with the data entry system are grouped in six categories, “TEXT” (e.g. mostly punctuation mark characters), “NUMB” (e.g. mostly digits 0-9), ARITH (e.g. mostly arithmetic characters), “RARE” (e.g. mostly other and/or rarely characters), “FUNC” (e.g. mostly PC and/or customized functions), and “F1-F12”. Each of said groups is assigned, respectively, to one of the keys 1001-1006 of the first keypad 1000. The appellation of each group is printed on the corresponding key.

As an example, if the user desires to enter a punctuation mark character “?” which belongs to “TEXT” group, according to one embodiment, he may press and hold the key 1001 for a predefined laps of time to enter the system in the mode instance corresponding to said group. The system may show each of the characters of said group on one of the keys of an on-screen (e.g. telephone-type) keypad 1100. In this example, the symbol “?” is shown on the key 1108. According to one method, in order to enter the symbol “?”, if the screen is touch sensitive, then the user may press the key 1108 or he may provide another interaction such as a gliding action to duplicate said key interaction. If the screen is not touch sensitive, and the device uses a physical telephone-type keypad as the second keypad, then the user may press the corresponding key of said physical keypad.

Also as another example, in order to enter the symbol “_”, the user may press (e.g. and hold) the key 1000 and press then press the key 1101 if the screen is touch sensitive.

FIGS. 1B to 1F show five more groups of symbols, corresponding to five more modes assigned to the keys 1002 to 1006, respectively. For example, in order to enter arithmetic character “=”, the user may press and hold the key 1003 corresponding to the “ARITH” mode of the first keypad 1000, and for example, after the system shows the second keypad 1300 as shown in FIG. 1C showing the locations of the symbols of “ARITH” group on said second keypad, the user interacts with the corresponding key 1309 to enter his desired special character “=”.

Systems and methods according to embodiments of the invention may include inputting symbols such, as letters, numbers, functions etc., through key interactions and other input device interactions such as gliding or swiping actions/procedures which may duplicate/imitate key interactions.

According to one embodiment, the gliding (e.g. swiping) actions/procedures relating to duplicating the key interactions of the data entry system of the invention must be defined such that the system easily distinguishes them from the gliding actions relating to the mouse interactions provided by the user.

According to one embodiment, a user input device may be provided which includes a touch-sensitive surface which may be divided into at least two zones and wherein interactions such as gliding actions on a first zone may correspond to duplicate imitating the interacting with the keys of the data entry system, and interactions such as gliding actions on a second zone may correspond to duplicating mouse interactions.

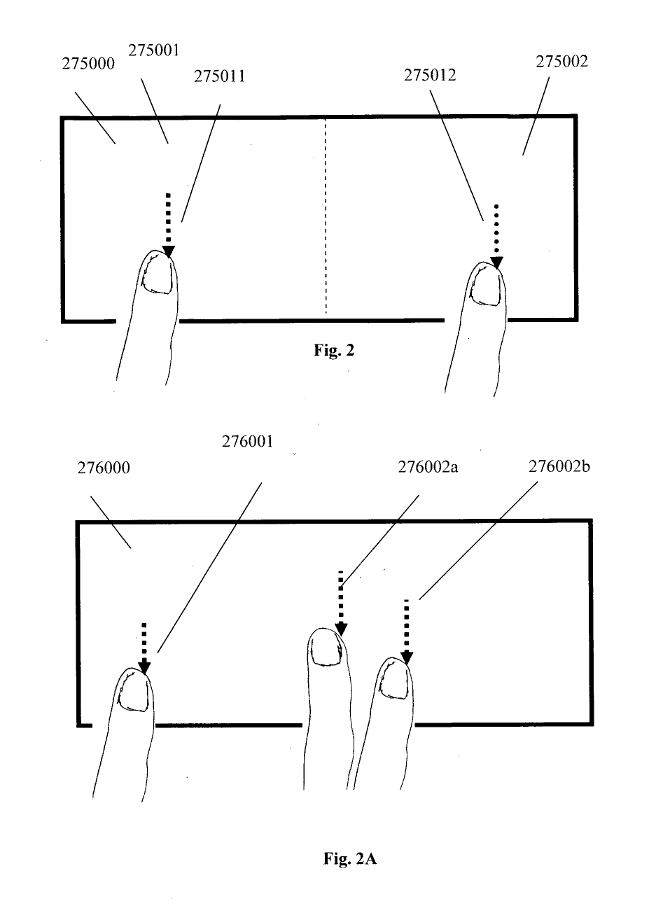

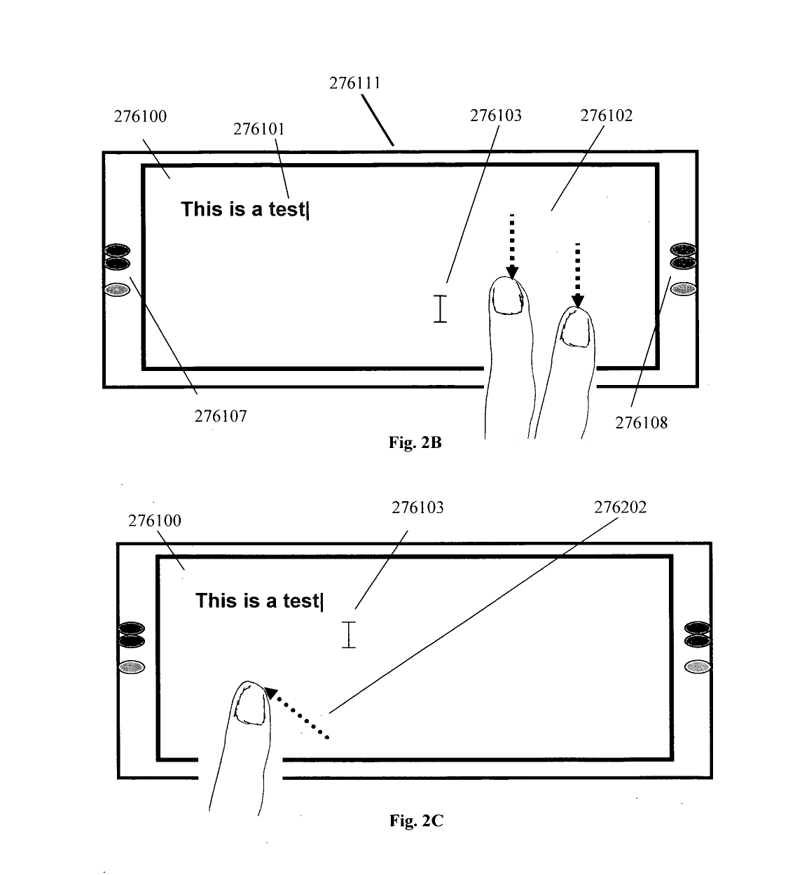

Reference as an example is now made to FIG. 2 in which a system according to one embodiment of the invention is provided. In FIG. 2 a touch-sensitive surface 275000 such as a touch-sensitive screen corresponding to a device is divided (possibly virtually) into two zones, one zone 275002 dedicated to interacting with an arrangement of a specific keypad (e.g. a telephone-type keypad used for example as the second keypad for the correction procedure of the system) and the other zone 275001 is dedicated to mouse interactions (or vice-versa). In this example, providing the gliding action 275012 (from up to down) in the zone 275002 may correspond to interacting with the key of a telephone keypad including/representing the digit 8 (e.g. and the letters “tuv”). Also in this example, providing the gliding action 275011 (from up to down) in the zone 275001 may correspond to moving the pointing symbol (e.g. generally, in form of an arrow) of the mouse. According to some embodiments, a taping action in the zone 275002 may correspond to interacting with the key of the telephone keypad including the digit 5, and providing a taping action in the zone 275002 may duplicate e.g., a left click of a PC mouse.

According to one embodiment the departing point of the gliding action in a zone relates said gliding action to the mode that is assigned to said zone. In this case the user may start the gliding action in the desired zone and end it outside said zone such as in another predefined zone belonging to another mode. The system relates said gliding action to the zone where said gliding action began.

According to another embodiment the system may predefinely relate a gliding action to a zone (and obviously to the mode said zone represents) where the largest portion of said gliding action is provided.

According to another method, providing interactions such as gliding/taping actions with one finger on a touch-sensitive surface may duplicate interacting with the keys of the data entry system of the invention as described, and providing interactions such as gliding and/or taping actions with (e.g. simultaneously) at least two fingers of the user (i.e. multi-finger interaction) may duplicate mouse interactions, or vice-versa.

As an example, FIG. 2A shows a touch-sensitive surface 276000 corresponding to a device. In this example, providing the gliding action 276001 (e.g. from up to down) with one finger (anywhere) on the surface may correspond to interacting with a key, for example, a key of a telephone-type keypad e.g., corresponding to the digit 8 (and the letters “tuv”). Also in this example, providing the gliding action 276002a and 276002b with two fingers, typically simultaneously on the surface of the touch sensitive surface 276000 may correspond to moving the pointing icon of the mouse system (e.g. moving the cursor within a text).

According to one embodiment a cursor or other mouse imitating inputs may include moving the mouse in a direction corresponding to the direction of the gliding action. Multi finger interactions may be of any predefined type such as gliding or tapping with two fingers, or pressing-and-holding with one finger and gliding with a second finger etc.

According to some embodiments, after an interaction has begun the user may remove one of his fingers from the touch sensitive surface 200 and continue said interaction with only one of his fingers without changing the mode of the action and the entire interaction may be considered a multi-finger interaction.

According to a one embodiment of the invention, a multi finger interaction may correspond to interacting with a second keypad of the invention (e.g. a keypad used with a correction procedure such as the correction procedure described in WO2009/027817, which is incorporated herein by reference), and interacting with one finger may correspond/be-related to providing mouse functions/interactions.

FIG. 2B shows as an example a device 276111 having a touch-screen surface 276100 and the split first keypad of the invention having two portions 276107 and 276108 each having three keys duplicating respectively the keys of the portions 1051, 1052 of the first keypad 1000 of the invention of FIG. 1a. A pointing icon 276103 is located on said screen.

Some examples of the present invention will be described with reference to a two keypad system as described before in several patent applications filed by this inventor such as the current application and WO2009/027817.

A word predictive system such as that described in WO2009/027817 may also be included within the system.

By considering the portion 1008 of the exemplary word database of the invention shown in FIG. 1a, in order to enter the word “test” the user may press the corresponding keys of the first keypad and the system may proposes the word “rest”. At this time the user may proceeds to the correction procedure of the invention and provide a predefined multi-finger (e.g. simultaneously) gliding action 276102 (e.g. in this example, with two of fingers) corresponding to the key of the virtual second keypad of the invention (e.g. a telephone-type keypad which is not shown in this example) to which the letter “t” is assigned to. At this time the system proposes the word “test” 276101.

According to one embodiment, the multi-finger gliding action 276102 may be provided on the touch-screen surface or it may be provided on a touch-sensitive surface/pad such as that of a mouse corresponding/connected to said device. In this embodiment, for example, a taping action (e.g. simultaneously) with two fingers may correspond to interacting with for example the center key (e.g. the key including the digit 5) of the telephone-type keypad.

According to some embodiment, the user may interact with a touch screen (or with any touch-sensitive surface) having a single/shared zone, wherein the mode of the interaction is determined based on the type of finger interaction, rather than on the location of the interaction on the screen. For example, an interaction with one finger on/with a touch sensitive surface, such as the pad of a mouse corresponding to a device, may be related to the corresponding mouse function. As an example, as shown in FIG. 2C, if the user provides with one finger a gliding action 276202 on the surface 276100, then the system may provide the corresponding mouse function and for example moves the pointing icon 276103 accordingly (e.g. in the a direction parallel to the gliding action). According to one method, a press-and-holding action with a first finger on said surface and (simultaneously) providing an interaction such as a gliding action with another finger on said surface may be related/correspond to interacting with the second keypad of the invention (e.g. relating to providing a corresponding “mode” instance of the invention). By using the current embodiment the user may easily provide the gliding actions corresponding to the second keypad of the invention and he can also provide the mouse interactions as he is used to.

According to some embodiments interactions with different portions of the finger may provide different types of inputs. For example, interacting with the tip and flat portions of a finger to provide two different input signals/functions. According to one another embodiment of the invention, interacting such as providing a gliding action on a touch sensitive surface with a first portion such as the tip portion of the finger may correspond/be-related to interacting with the second keypad of the invention (e.g. the keypad used for example with the correction procedure of the invention), and interacting such as providing a gliding action on a touch sensitive surface with another portion such as the flat portion of the/said finger may correspond/be-related to providing mouse functions/interactions, or vice versa. Possibly, instead of using two and one fingers, as an example the tip and the flat portion (or vice versa) of the finger may be used to duplicate the same/corresponding functions, respectively.

According to one embodiment of the invention, the system may relate the user's gestures (e.g. gliding actions on a touch-sensitive surface) to the corresponding desired function/procedure (e.g. a mouse function, or duplicating an interaction with the second keypad of the invention) based on different parameters. According to some embodiments the speed of the gliding action may differentiate one input from another. For example, in order to provide a gliding action corresponding to a second keypad, the user may provide an entire gliding action quickly or alternatively at least the a portion of the gliding action is provided quickly, wherein in order to provide a gliding action corresponding to a mouse function, the user may provide the entire gliding action slowly or alternatively at least a portion of said gliding action is provided slowly. (Typically, real life user mouse movements are ended slowly). By considering these principles, the system may analyze a user's gliding action and relate it to the corresponding function. For example, if a gliding action is provided quickly the system relates it to an interaction with the second keypad of the invention, and if it is provided slowly the system relates to the corresponding mouse function.

According to one embodiment, if a user provides the major portion of a gliding action slowly but provides the last portion of said gliding action quickly then the system may consider the (entire) gliding action as being provided quickly and may relates said gliding action to the corresponding function such as interacting with the second keypad and not to the mouse interaction. In this embodiment, in order to make the system user friendly, according to one method, during providing a slow gesture (e.g. gliding action) the system may behave as if said gesture corresponds to a mouse function but if the user provides the last portion of said gesture quickly then the system may relate the whole gesture to interacting with the second keypad of the invention and deletes the corresponding mouse function provided until then (i.e. provided during the/said slow gesture).

According to some embodiments, a finger tap is associated with a specifically located key; wherein the speed of the finger tap may differentiate between modes. For example, a quick taping action on (e.g. less than or equal to a predefined short amount of time of interaction with the surface of) the touch-sensitive surface may be related to interacting with a predefined key of the second key keypad of the invention such as the key of a telephone-type keypad to which the digit “5” and the letters “jkl” are assigned, and longer taping/pressing actions on the touch-sensitive surface may be related to mouse interactions. For example, a taping/pressing action with a first predefined longer time of interaction (e.g. longer than said predefined short amount of time of interaction and shorter than another predefined longer time of interaction) with said touch-sensitive surface may be related to the mouse left click, and a press-and-holding action for a longest time (e.g. longer than said another predefined time of interaction) on a point on said touch sensitive surface may be related to the mouse right click, etc.

According to one embodiment the slow gestures/gliding-actions may be related to the second keypad of the invention and the quick gestures may be related to the mouse function).

According to one embodiment of the invention, providing two different levels of pressure on the touch-sensitive surface may correspond to two different procedures. For example, providing a gesture such as a gliding action by pressing strongly on the touch sensitive surface may correspond to interacting with the second keypad of the invention, and providing a gesture such as a gliding action by pressing slightly on the touch sensitive surface may correspond to a mouse interaction (or vice-versa). According to another embodiment, providing an interaction such as a tapping/gesture by pressing strongly on the touch sensitive surface may correspond to a first mode such as interacting with a second keypad and providing an interaction such as a tapping/gesture by pressing slightly on the touch sensitive surface may correspond to a second mode such as a mouse interaction (or vice-versa). According to one method, the degree/level of the pressure of a predefined portion such as the beginning portion of a gliding action on the touch sensitive surface may define the corresponding mode relating to the entire said gliding action. For example, if the user presses strongly on a point on a touch sensitive surface and continues said interaction (e.g. without removing his finger) on said surface by providing softly a gliding action on said surface, then the entire gliding action may be considered as a strong gliding action provided on said surface and be related to the corresponding mode.

According to one embodiment, if the system is entered in the corresponding mode, the same/similar methods may be used for duplicating the arrows functions of a PC keyboard such as to navigate the cursor in four directions within a text. For example, according to some embodiments, a first zone may be dedicated to duplicating the key interactions of the second keypad, and the second zone may be dedicated to duplicating the arrows functions of a PC keyboard.

According to one embodiment of the invention, after the system enters into the mouse mode by for example pressing (e.g. an holding) a mode key, gliding actions in different directions (preferably anywhere) on the touch sensitive surface may duplicate the corresponding mouse functions (e.g. such as navigating a pointing icon on the screen of a device by moving a (PC) mouse on a surface such as on a desk).

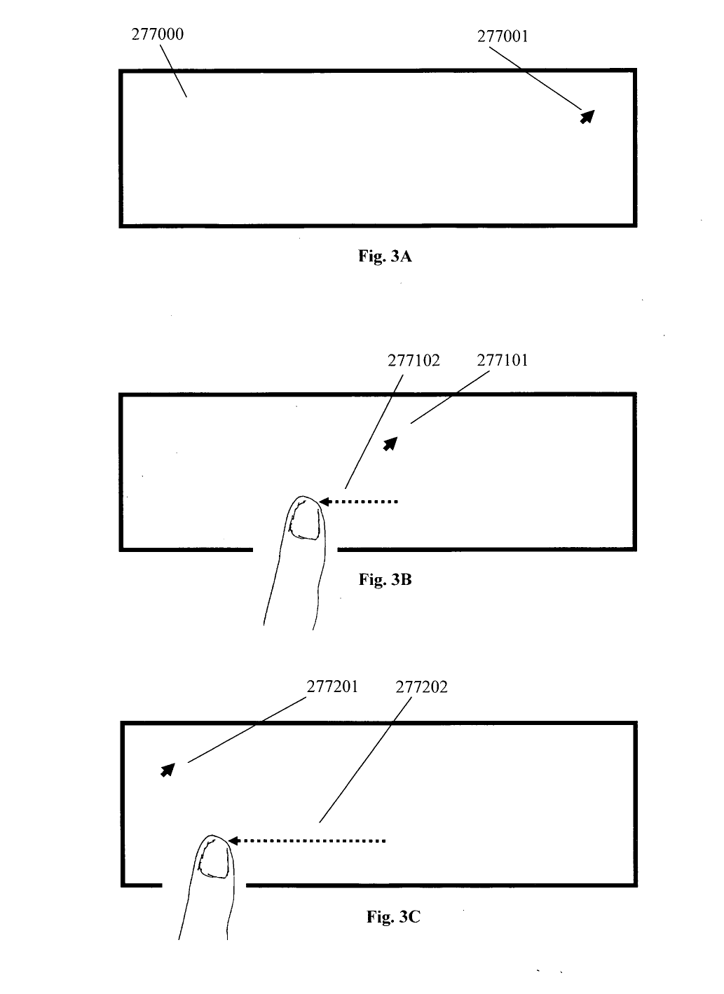

FIG. 3A shows as an example a touch-screen 277000 of a device in which a pointing icon 277001 is situated somewhere on said screen. For example, as shown in FIG. 3B, providing a gliding action 277002 (in this example, from right to left) may correspond to moving the pointing icon 277001 in the same/parallel direction on the touch-sensitive surface. According to one embodiment, the position of the pointing icon and the location of the user's finger interacting with the touch-sensitive surface during the gliding action may not coincide. For example, in devices with small touch screen it will easier for the user to see the pointing icon if he does not cover it with his finger. Also, the length of the gliding trajectory may preferably be different from the length of the trajectory of the pointing icon on the screen. According to some embodiments, the distance between different points of the gliding trajectory may proportionally define the distance between the relating points of the corresponding trajectory of the pointing icon as shown through FIGS. 3B to 3C. According to one embodiment, for each predefined portion of the trajectory of the gliding action the system moves the pointing icon a predefined distance on the screen in the (parallel) direction of the gliding action.

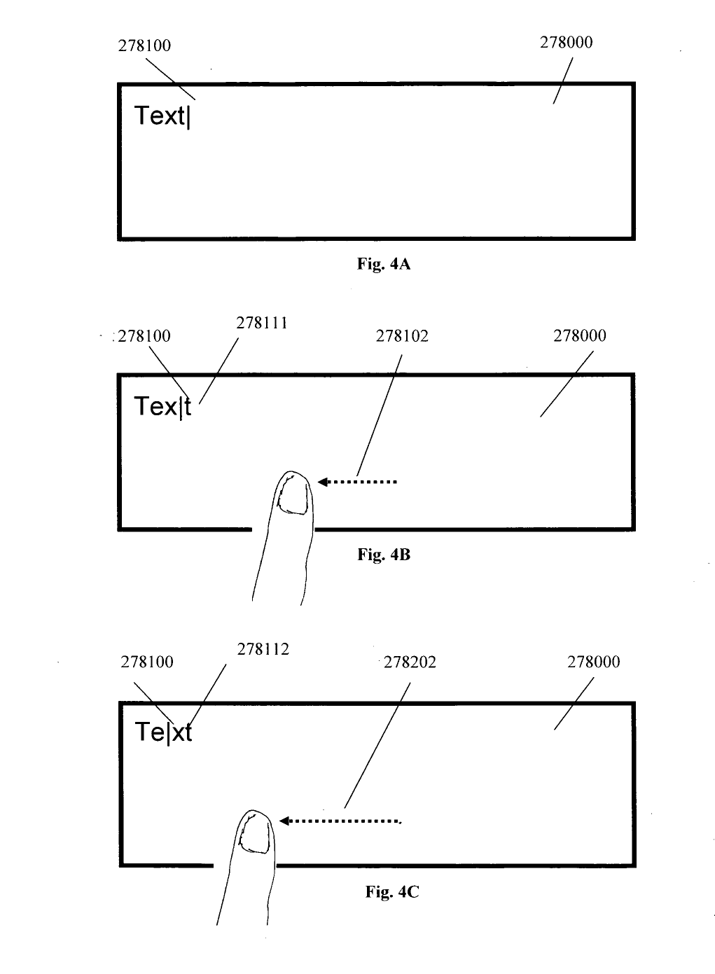

According to one embodiment of the invention, an appropriate mode by for example pressing (and holding) the corresponding mode key, gliding actions in different directions (preferably anywhere) on the touch sensitive surface may duplicate the corresponding arrow functions (e.g. such as navigating the cursor within text printed on a/said surface by using the “ARROW” keys of a (PC) keyboard). FIG. 4A shows as an example a touch-screen 278000 of a device wherein a cursor 278100 is located at the end of a text printed on said screen. For example, as shown in FIG. 4B providing a gliding action 278102 (in this example, from right to left) on the touch-screen 278000 may correspond to moving the cursor 278100 from left to right within the text. Preferably, the position of the cursor and the location of the user's finger interacting with the touch-sensitive surface during the gliding action do not have to coincide. Also, the length of the gliding trajectory may be different from the length of the trajectory of the cursor within the text. According to some embodiments, the length of the gliding trajectory may (proportionally) define the number of times the cursor should move over the characters within the text. As shown through FIGS. 4B to 4C as an example, for each predefined portion 278102, 278202 of the trajectory of the gliding action the system moves the cursor 278100 on a character respectively, 278111, 278112 (e.g. (typically an additional character) within the text in the direction of the trajectory.

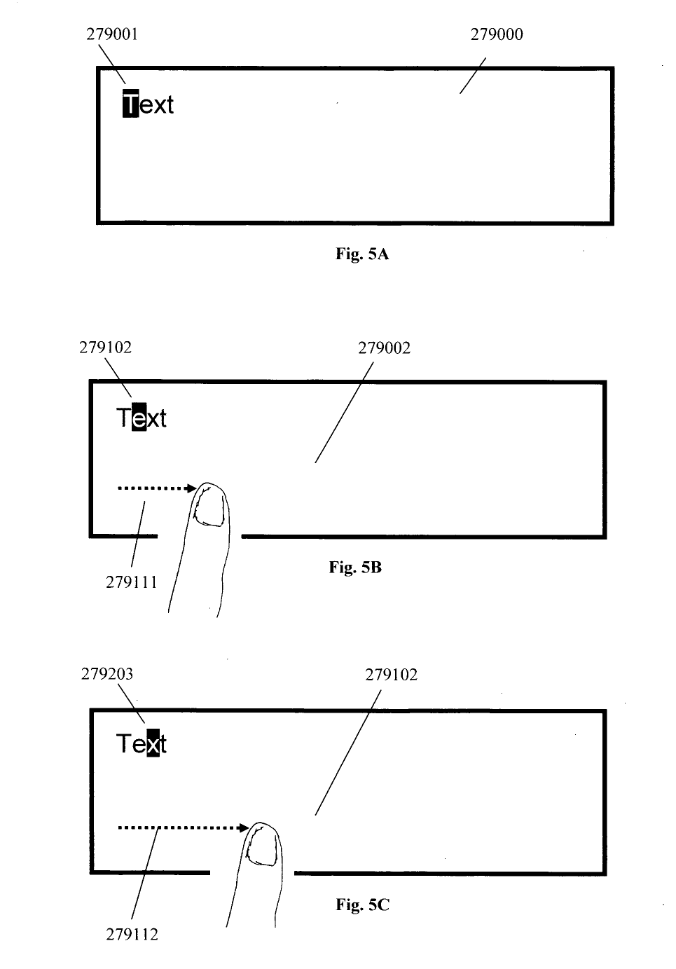

The principles just described may also be applied (e.g. after the system being entered in the appropriate mode) for selecting letters within a word as shown through FIGS. 5A to 5C. Selecting a desired letter within a word in view of for example replacing it by another letter through the correction procedure of the invention has already been described previously by this inventor. In FIG. 5A a first letter 279001 of a string of text on screen 279000 is selected. In FIG. 5B a gliding action having a trajectory 279111 selects the next letter 279102. In FIG. 5C a gliding action having a longer trajectory 279112, selects the next letter 279203, and so on.

According to one embodiment of the invention, a short gliding action in a predefined direction may correspond to a first symbol/function, and a longer gliding action in the same direction may correspond to another symbol/function. For example, a word in English language having its last character selected by the system may be printed on said screen. Providing, for example, a short gliding action from right to left on said touch-sensitive surface may correspond to interacting with the key of the telephone-type keypad that includes the digit four (and the letters “ghi”), while providing a long gliding action from right to left on said touch-sensitive surface may for example correspond to the procedure of selecting letters within the word. Once the trajectory of a gliding action is being considered as a long trajectory by the system, the system may select the next letter within the word in the direction of the gliding action. If the user continues the gliding action in said direction, then the system selects the following letter in said direction within the word, and so on until the user terminates said gliding action. It may be appreciated that, said principles may be applied for gliding actions in other directions such as from right to left direction.

Obviously, said principles will/may be applied for gliding actions in other directions such as from right to left, down to up, up to down, or in diagonal directions too.

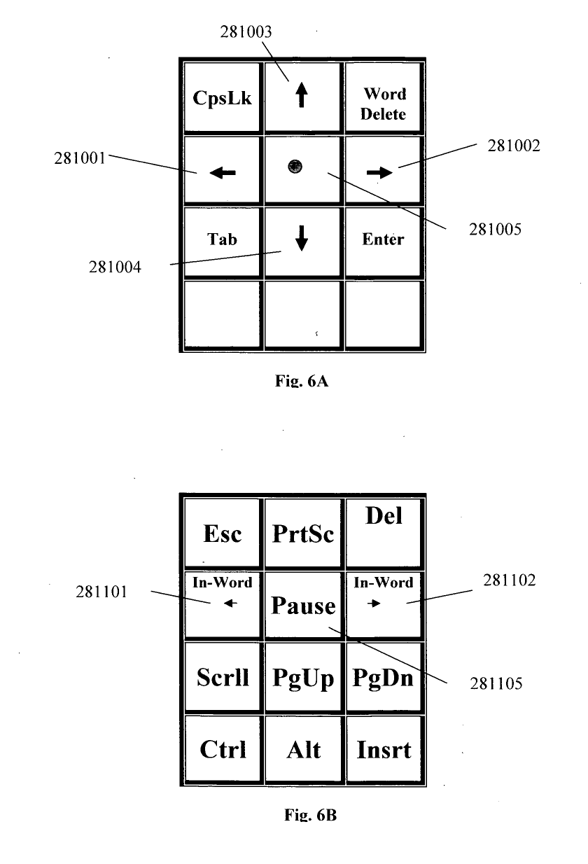

FIG. 6A shows an exemplary symbol arrangement according to one embodiment of the invention, in which PC command symbols are distributed among the keys of the second keypad of the invention during a “COMMAND” mode instance. As an example, after the user enters into said mode, a gliding action provided anywhere on the screen duplicating a gliding action departing from the center key 281005 in the direction of any of the four (“arrow”) keys 281001 to 281004 may duplicate the function of the corresponding arrow key of a PC keyboard such as navigating the on-screen text cursor in the corresponding direction within the text, or navigating the on-screen pointing icon in the corresponding direction on the screen.

In another example, FIG. 6B shows an exemplary symbol/function distribution among the keys of the second keypad of the invention that relates to a “FUNCTION” mode. As an example, after the user enters into said mode instance, a gliding action anywhere on the screen duplicating a gliding action departing from the center key 281105 in direction of any of the two (“in-word arrow”) keys 281101 to 281102 (e.g. corresponding to the letter selection within a word) may duplicate the function of the corresponding key such as navigating-and-selecting a letter within a word as described earlier.

According to one embodiment a procedure of entering a symbol such as a character or a function (such as moving a cursor within a text) may be repeated without having to repeat the input action (such as key pressing or gliding). According to one embodiment of the invention, the user may press and-hold a mode key and then press and hold the key corresponding to the symbol to be repeated. The system repeats entry of the symbol until the user stops pressing one of the keys (e.g. preferably, after stopping to press the key of the second keypad). The key pressing (e.g. and holding) action corresponding to the second keypad may be duplicated through the corresponding gliding action as described in this patent application. If the user uses a gliding action to duplicate the invention with the key of the second keypad, he may provide said gliding action but does not remove his finger from the touch-sensitive surface. The system repeats providing said symbol until the user removes his finger from the sensitive surface. As an example, to repeat a cursor movement to the left the user may press and hold the corresponding mode key (e.g. a key of a first keypad) and then provide the gliding action corresponding to interaction with the key of a second keypad relating to moving the cursor towards the left (for example, within the text (e.g. left arrow)) without removing the finger from the touch-sensitive surface. The cursor will be moved towards the left within the text until the user removes his finger from the touch sensitive surface.

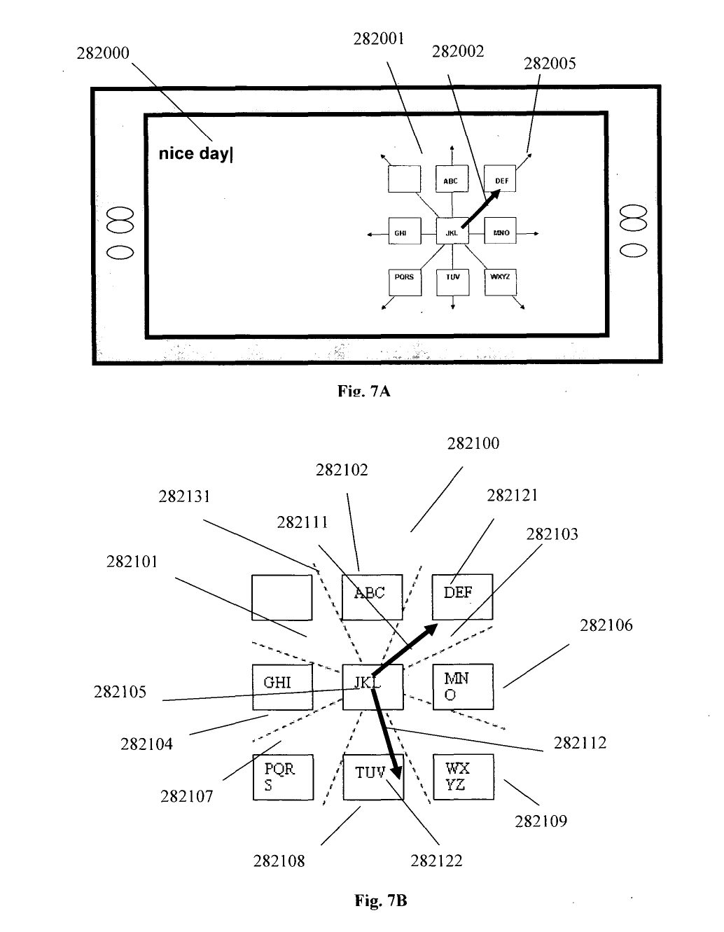

The system according to one embodiment of the invention, includes a device having two keypads corresponding to it. According to one embodiment, when a user touches a touch sensitive surface such as the screen of the device, the system dynamically shows the second keypad on the screen such that the center of said second keypad corresponds to the point being touched on the screen. At this time, for example, if the user desires to correct a word he can see the location of the letter he desires to input in the correction procedure relating to the point in which his finger touches the screen and (optionally, without removing his finger from the touch-sensitive surface) thus the user can perform the gliding action in the correct FIG. 7A shows as an example, a device having a touch-screen 282000. By considering the portion 1009 of the exemplary database of words of the system as shown in FIG. 1 and the exemplary second keypad of the invention 1010, and by using the letter keys 1001-1004 of the exemplary first keypad 1000, if the user uses the first keypad of the invention to enter the word “day” the system may propose the word “was” which has the highest priority among the words corresponding to the input information (i.e. key presses provided) in the system's word database.

The user may perform a correction procedure to correct the proposed word by entering the letter “d”. For such purpose the user may provide a gliding action to the position of the letter “d” on the second keypad. In this example, when the user's finger touches the touch screen 282000 the system may show the second keypad 282001 and optionally the directions of the gliding actions (e.g. 282005) corresponding to each key, at a location on the screen as described above so that the user can see in which direction he should glide (e.g. swipe) his finger. In this example after providing the corresponding gliding action 7005 the system proposes the word “day”.

According to one embodiment showing the second keypad when beginning to provide a gliding action may be optional. A switching method may be used, such as pressing button to switch between showing or not showing the keypad, for example, during a correction procedure.

It must be noted that other symbols (e.g. digits, punctuation mark, functions, etc.) may be entered by using the methods of gliding actions as described above during a mode instance of the invention.

Instead of showing the directions of the keys of the second keypad, the system may show the limits of the zone within which a gliding action departing from a point, representing the center key of the second keypad, may be provided. FIG. 7B shows as an example, a second keypad 282000 of the invention wherein eight zones 282101-282104 and 282106-282109 (in this example delimited by discontinued lines (e.g. 282131) are defined by the system wherein any gliding action (e.g. 282111 and 282112) provided from the center 282105 of the (optionally dynamic) second keypad 282100 within the corresponding zone may correspond to interacting with the corresponding key (e.g. 282121 and 282122, respectively).

According to one embodiment of the invention, if a gliding action (e.g. 282112) is provided in a first zone (e.g. 282108) but near a neighboring zone (e.g. 282109) then in addition to considering said gliding action as being provided within said first zone the system also may consider that there may have been an error and that the user may have intended to provide said gliding action within said neighboring zone and as a result the system may provide an alternative word. For example, based on the design of the system, by considering the language rules the system may propose a word based on input signals that include the gliding action in said neighboring zone.

In order to provide a more user friendly interaction with the second keypad, different methods of showing the corresponding key/symbol arrangement of the second keypad may be provided. Some of them are demonstrated hereafter.

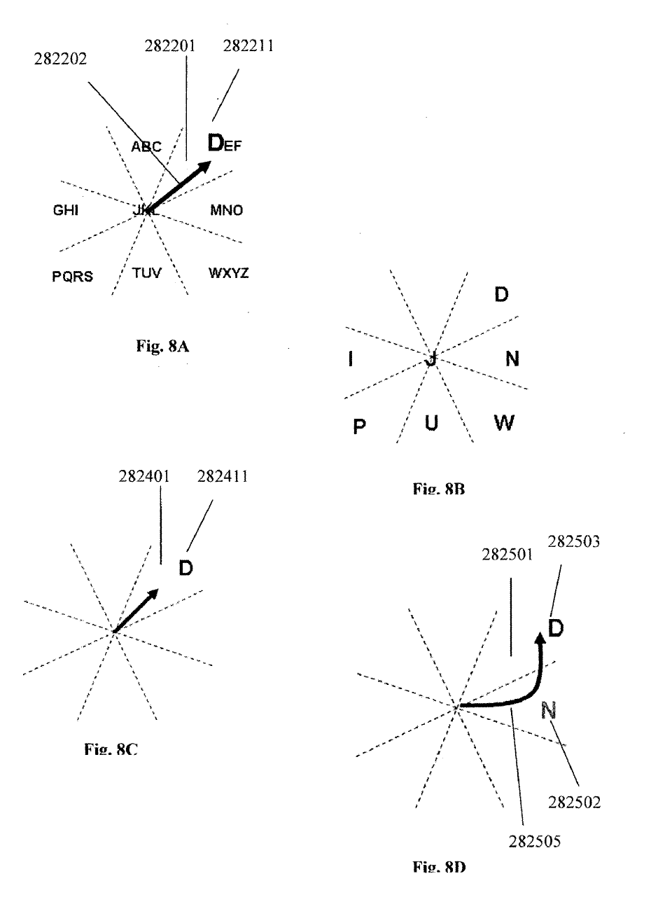

According to one method when the user provides the gliding action corresponding to interacting with a key of the second keypad, the corresponding character may be shown/highlighted. As shown in FIG. 8A, for example, during the correction procedure, in order to change the proposed word “was” by the desired word “day” the user may provide the gliding action 282202 in the required direction to zone 282201. The system may show on the screen the letters represented by the corresponding key wherein the selected letter 282211 among them is highlighted.

According to another method, when the user touches the touch-sensitive surface, the system may shows only the characters of the second keypad relevant to the corresponding key of the first keypad. For example, during the correction procedure of the invention when the user touches the screen of the device the system shows only the relevant letters relating to the corresponding input signal provided through the first keypad of the invention. As an example, FIG. 8B shows the letters corresponding to different gliding direction/zone relating to interaction with the keys of the second keypad, corresponding to the first input signal provided through the first keypad for entering the word “was”.

According to another method, the system may show only the corresponding character during providing a gliding action. FIG. 8C shows an example of such a method during a correction procedure relating to the above-mentioned example in order to enter precisely the first letter of the desired word a gliding action 282401 within a zone 282411 is provided and based on that the system then proposes the word “day”.

According to one method, the system relates a gliding action to interacting with a key of the second keypad only if the last portion (e.g. a portion having a predefined length) of the gliding action is provided rapidly (e.g. with a predefined speed). One of the advantages of such a method is that if the user is not sure about the location of a character on the keys of the second keypad he may begin to provide a gliding action in the direction that he thinks is the right direction. The system may show the corresponding character. On one hand, if said character is the desired character then the user may provide the rest (e.g. the last portion) of the gliding action in a fast manner. On the other hand, if said character is not the desired character, then the user may lift his hand from the touch-sensitive surface (e.g. the user ends the gliding action) and the system may not relate said gliding action to a characters. As mentioned previously, according to one method, the system may correspond said gliding action (e.g. provided slowly at its end) to a corresponding mouse procedure/function. Note that a gliding action while the user stops it but does not remove his finger from the touch-sensitive surface, is not considered by the system as being ended therefore the last portion of such gliding action is considered to be long in time and therefore is considered to be slow. It should be noted that although in this embodiment the speed of the last portion defines the purpose of the gliding action, obviously, the speed in which any other portion(s) of the gliding action is provided may be considered based on the user's behavior for example during the entry of a word or providing mouse functions to relate said gliding action to a predefined symbol or a mouse function as described before.

If the user provides a gliding action in wrong direction, the system may show the corresponding wrong letter, in this case according to one method, without lifting his finger from the touch-sensitive surface, the user may change the direction of said gliding action towards the desired zone and the system may hide the wrong letter and show the letter corresponding to the new zone. FIG. 8D shows as an example, a gliding action 282505 that at the beginning was provided in the wrong direction/zone 282502 wherein the system at the beginning showed the letter “n”. The user may change the direction to end the gliding action in the zone 282501. The system may hide the letter “n” and show the letter “d”. According to one embodiment the system considers the end zone 282503 of the gliding action to be the zone selected by the user.

According to one embodiment, even if the last portion of a gliding action is provided out of the desired zone but the ending point is within the desired zone the system may correspond said gliding action as being provided within the desired zone.

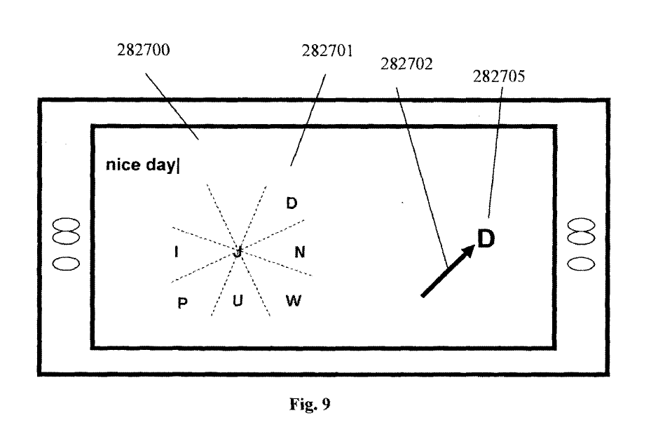

According to one embodiment of the invention, when the user touches a touch-sensitive surface, the system may show the arrangement of the second keypad (for example, as described with reference to FIGS. 8A-D) in one location on the screen, and may show the symbol corresponding to the user's gliding or other input (such as tapping) action on the touch-sensitive surface, in another location on the screen. As an example, as shown in FIG. 9, when the user touches the screen 282700 of a device, the system may show somewhere on the screen the gliding zones 282701 corresponding to the letters which correspond to the relating input signal that was provided through the first keypad (e.g. the input signal corresponding to a character within a word selected manually, or automatically by the system). Aa an example, when the user provides the gliding action 282702 corresponding to a desired character (“D” in this example) the system may shows said character at another (visible) location 282705, preferably, near the user's finger.

According to one method, instead of showing the gliding zones on a location on the screen, alternatively, the system may show the second keypad on said location.

In order to make the system more user-friendly, when the user provides an interaction corresponding to selecting a letter of a word in order to, for example, correct said letter (and eventually the corresponding word), according to one method, the system may show said letter of said word in a location on the screen (e.g. preferably near the user's finger interaction point on the touch-sensitive surface) and/or (alternatively) highlighting said letter or said word such that the user can see it easily. FIG. 10A shows as an example, the screen 283000 of an electronic device wherein the word “was” is being presented to the user based on the first input information provided by the user. The first letter 283001 being inputted by the user is highlighted. However, the user does not intend to input the word “was” but rather he intends to input the word “day”. The user may then attempt to correct the predicted word. As shown in FIG. 10B, the user may erroneously provide a gliding action 283101 in wrong direction (in the current example the system relates the erroneous gliding action to the letter “u”). Consequently, the system may propose the wrong word “ufo” and may even automatically select the next letter 203102 of the proposed word. According to one example, as shown in FIG. 10C, at this time the user may use a manual letter selecting means such as providing a gliding action (e.g. in this example towards the zone 283205) to move the letter selecting indicator 283202 backward within the proposed word to select the first letter of the word to correct it. In this example, the system shows said word 283204 in highlighted manner (for example, in color or in bigger letters) near the user' interaction zone on the screen. The user then may proceed to correcting again said character and the system may propose another word.

In the example above, any other means of selecting a character within a word including those described earlier in this application, such as the “in-word” left or right letter selecting means, may be considered. In another example, the user may position the cursor at a predefined location relating to the letter to be modified (e.g. after, before, etc.). According to another example, the standard selecting means of a word processor may be used for the same purpose

According to one embodiment of the invention, a character (e.g. letter) of a word may be selected (e.g. manually) by the user so that he may modify that letter (and eventually get the system to propose another word). According to one method, after the character is selected by the user, if the user provides a new input signal through the first keypad it may replace the previous input signal provided through the first keypad relating to said character. By considering said new input signal provided through the first keypad (e.g. and also considering the last input signal provided through the second keypad of the invention relating to said character, if any was provided), the system may change said character/letter and eventually accordingly, provide the corresponding, (e.g. the desired), word. According to one embodiment, if a character of the word is selected automatically by the system, in order to replace a previous input signal corresponding to said character provided through the first keypad with a new input signal to be provided also through the first keypad and corresponding to said character, then according to one method, the user may reselect said character manually by any selecting means (e.g. such as those described before) in order to provide a correcting procedure as just described to replace the corresponding previous input signal provided through the first keypad by a new input signal to be provided by the user through said first keypad. According to one method, after the user provides said new input signal through the first keypad, the system may continue to keep selecting the current corresponding character/letter, wherein according to another method, the system may automatically select another (e.g. ambiguous) character/letter of the current word based on principles described before. If the system continues to select the current letter, then the user may provide a gliding action corresponding to interacting with a key of the second keypad, then the system may consider said gliding action and the last input signal provided through the first keypad of the invention relating to said current character and may change said character/letter with a new one and get the system to propose another word.

It must be noted that if the system automatically selects the first or the last character of a word, and the user desires to correct the input signal corresponding to said character provided through the first keypad, then as an example, respectively, providing a “left-in-word” signal may be considered as reselecting said first character and providing a “right-in-word” signal may be considered as reselecting said last character of said word.

As mentioned before, according to one embodiment of the invention, the system may be capable of disambiguating a gliding action and relating it to its corresponding purpose such as an interaction with a key (e.g. of the second keypad) or a mouse function. For this purpose, some predefined rules may be considered. For example, as mentioned before, a gliding action whose last portion is provided rapidly may correspond to the corresponding interaction with the corresponding key of the second keypad and the gliding action whose ending portion is provided slowly may correspond to the corresponding mouse function. This is because in real life, a gliding action corresponding to a mouse function is generally ended slowly. Therefore, according to this embodiment, a user can provided short or long gliding actions in a slow or rapid manner and end them slowly so that the system may relate them to corresponding mouse function.

It should be noted, that although until now the procedures of recognizing different types of gliding actions (slow, fast, slow during providing any predefined portion such as the last portion of it, fast during providing any predefined portion such as the last portion of it, etc.) and relating them to corresponding symbols have been described and used for text entry and/or mouse functions and the manner to distinguish between them, obviously said gliding actions may be used for providing other different (group of) symbols and how to distinguish them from each other.

According to one embodiment of the invention, if the device includes/relates to a touch sensitive surface, during entry of a word the tapping/gliding actions provided on said surface may correspond to the correction procedure and/or entry of special symbols, and when the user is not entering a word, the tapping/gliding actions provided on said surface may correspond to corresponding mouse inputs/functions.

Duplicating interactions with keys such as with at least the four letter keys by using means such as different fingers, portions of one or more fingers, finger caps, gloves, etc. According to one embodiment of the invention, in addition, those means may include other means to duplicate the interactions with the keys of the second keypad of the invention on a surface or in the air. For example, said means duplicating the interactions with the keys of the first keypad of the invention may include other means such as a touch-sensitive surface (e.g. touch-screen), an accelerometer, etc., so that to permit to the user to duplicate the interactions with the keys of the second keypad of the invention on said surface or in the air, accordingly.

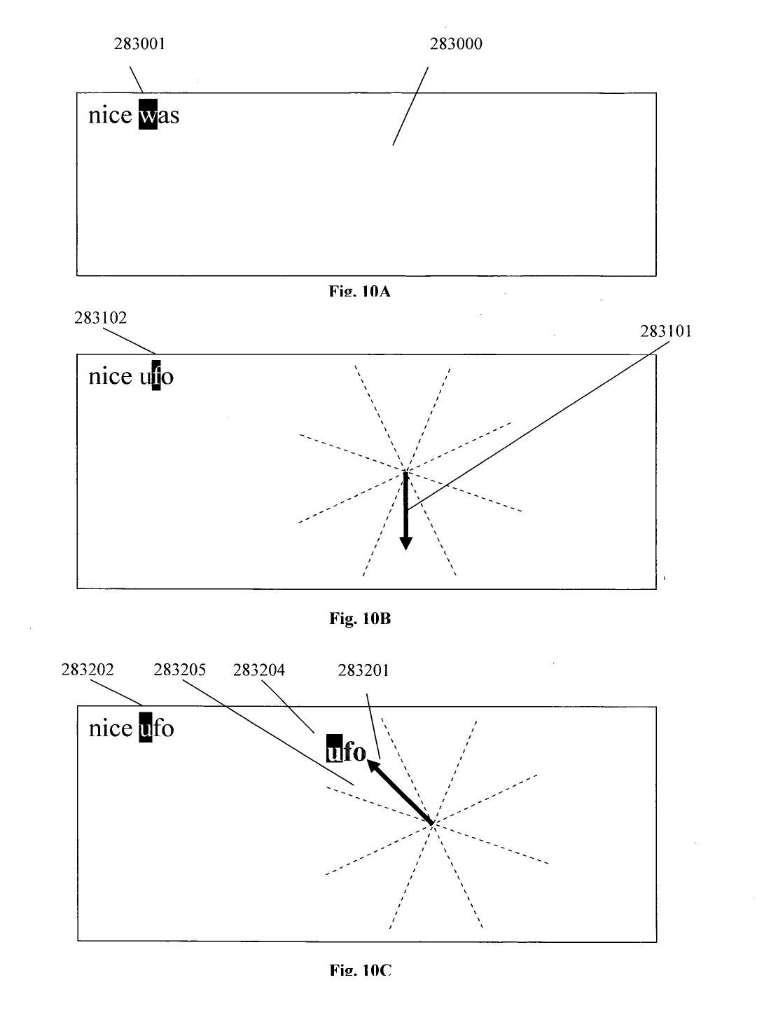

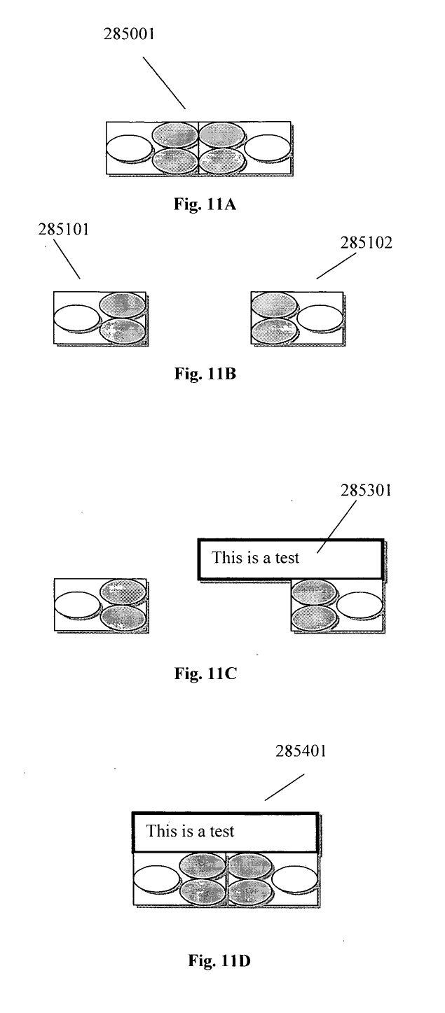

According to one embodiment of the invention, a mobile data/text entry unit based on the principles of the invention for interacting wirelessly or through the wires with a remote electronic device such as a computer may be considered. FIG. 11A shows as an example, a first keypad 285001 of the invention having six keys duplicating the keys 1001-1006 of keypad 1000 of FIG. 1, wherein four of said keys (the darker keys) duplicate the keys 1001-1004. As shown in FIG. 11B said keypad may be designed such that to include two detachable sections 285101, 285102. The user, at his convenience, may use said keypad in attached or detached configuration. Different attaching/detaching means may be considered.

As shown in FIGS. 11C and 11D, said keypad may also include a display 285301 to at least show the text (e.g. the words) that the user is entering so that the user can verity the words he enters. The remote electronic device may also have its own display. The display 285301 of data entry unit and the display of the remote electronic device (not shown) may each may have a cursor. The display 285301 of the data entry unit may display a portion of the display of the remote electronic device preferably, e.g., the portion of data such as text near/around the position of the cursor of the electronic device. Preferably, the cursor of the data entry unit 285001 has also the same position within the said text, therefore if the user navigates the cursor of the data entry unit within the text printed on the display 285301 of the data entry unit then the cursor of the electronic device also moves accordingly within the text (printed on the screen) of the electronic device. The display 285301 of the data entry unit may be touch-sensitive so that the user may provide on-screen interactions such as tapping actions on the on-screen keys (e.g., of the second keypad) of or providing gliding actions so that to duplicate the interactions with the keys (e.g., keys of the second keypad) of the invention. Optionally, the data entry unit 285001 may also include means such as an accelerometer so that to recognize a user's gliding actions in the air duplicating interactions with the keys of the second keypad. In this case, optionally, the display of the data entry unit 285001 may not be touch-sensitive. The data entry unit 285001 may also include wires and/or wireless means so that to connect respectively through said wires or wirelessly with the a remote electronic device. According to some embodiments the keypad shown in FIGS. 11A to 11D may be manufactured such that to be detachable (as in FIGS. 11B-11C) or not.

A data entry unit according to embodiments of the invention may also include its own processor/or memory. According to one embodiment the processor and/or memory may be mainly used with the data entry system/software of the invention for the purpose of text entry thus enabling the system to be low power, small sized, and typically of reduced cost. Such a standalone data entry unit may become a mobile small keypad working like a full keyboard for every mobile and fixed device.

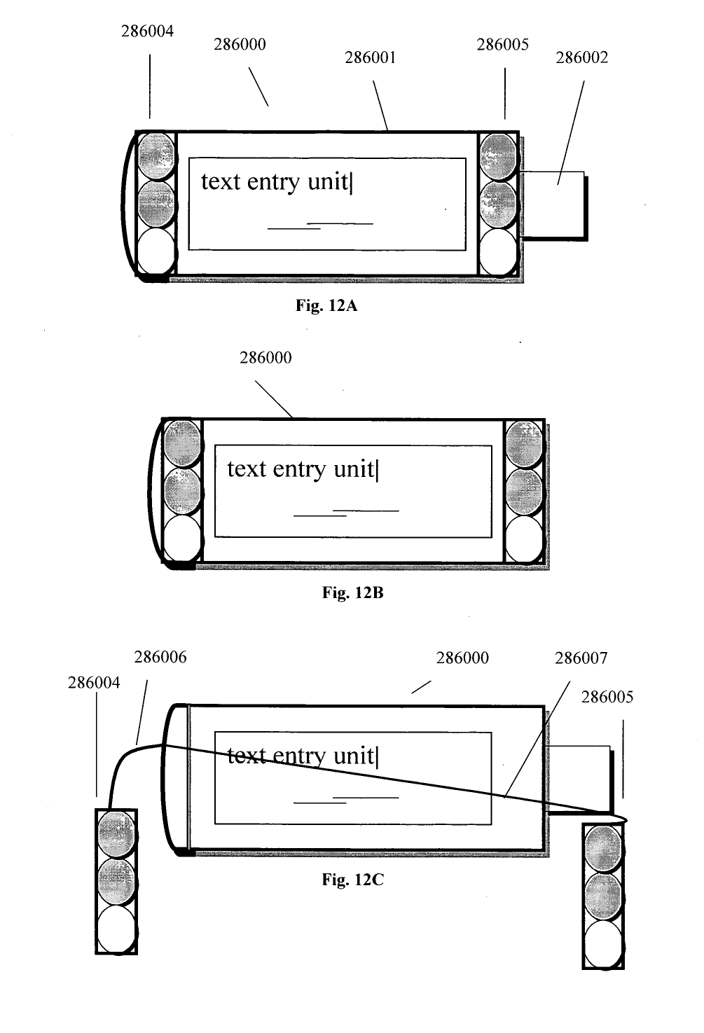

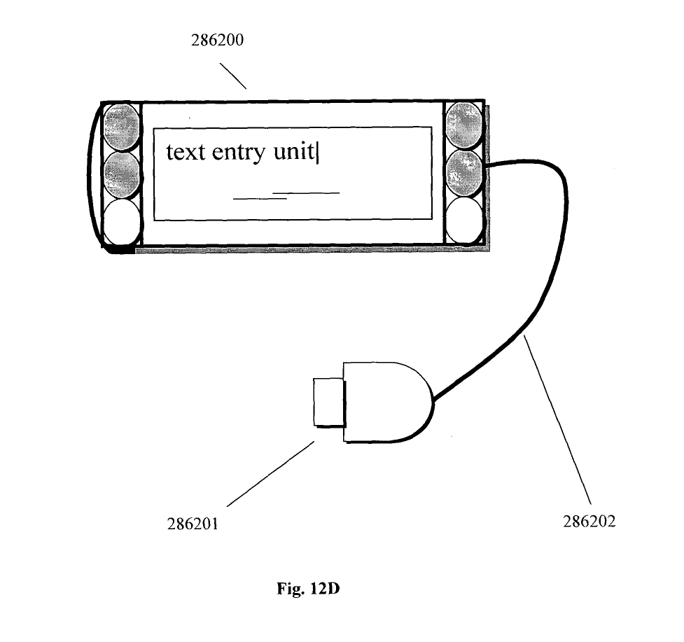

FIG. 12A shows, as an example, another type of standalone data entry unit 286000 having two key portions 286004, 286005, and display unit 286001 (possibly, touch sensitive). The unit 1286000 may include an accelerometer, wired or wireless connections, processor, memory, and other components. For example the data entry unit 286000 may also include a USB connection 1286002, for example to be charged through an electronic device such as a computer when connected to it. For easier use of the data entry unit 286000, as shown in FIG. 12B, during, for example, entering a text, the USB connecting portion 286002 may be retracted when said portion is not in use. Alternatively, the unit 286000 may include other types of connections or need not include any connections to external or remote devices. In addition, data entry unit 286000 may also be used as a memory storage (e.g. disk-on-key) of other electronic devices. As shown in FIG. 12C, the key portions 286004 and 286005, of the data entry unit 286000 may be detachable but connected to said data entry unit 286000 for example through wires 286006 and 286007, or wirelessly, such that for example while the data entry unit 286000 is connected through its USB connection 286002 (e.g. for charging) to a remote electronic device, the user can use said data entry unit for entering data/text. According to one embodiment, the data entry system software and its database may be integrated within the data entry unit 286000. When the user connects said data entry unit 286000 through the USB connection 286002 to an electronic device, the data entry system and its software may remain on the data entry unit 286000 but use the resources such as the processor and the RAM of the remote electronic device for running the data entry system/software.

According to one embodiment shown in FIG. 12D, the USB connector 286201 of the data entry unit 286200 may be detachable or be a separate piece from said unit 286200 and may be connected to unit 286200 through wire 286202. In this case even if the keys of the unit are not detachable, the user can still work from far with a remote device while said data entry unit 286200 is attached (e.g. for charging purposes) to the remote electronic device.

As shown in WO2009/027817, during providing the first input information (e.g. key pressing actions) corresponding to the characters of a word, the system may also show at least some of the characters/letters ambiguously corresponding to every input signal (e.g. key press) provided by the user (e.g. shown in a column under each letter of the proposed word (e.g. hereafter referred to as “letters column(s)”) on the screen. Said letter columns may include or exclude the corresponding character/letter of the proposed word. The elements (e.g. letters, different zones on each letter column to which a character is assigned, etc.) of each column of said letter columns may be responsive to user's interaction and therefore another type of procedure of correction procedure according to an embodiment of the invention may be considered which is described hereafter in detail. The procedure of correction according to an embodiment of the invention may replace or be used as an additional type of correction procedure of the system. For example, for correcting non-desired words which requires few tapping/gliding actions, the user may use a correction procedure through the second keypad for example, as described in WO2009/027817, and for correcting non-desired words requiring entering many precise characters (e.g. for out-of-dictionary words), the user may use the correction procedure using the letter columns, according to an embodiment of the invention, which is described hereafter.

According to one embodiment of the invention, (e.g. the word before the cursor, or the word selected/pointed to by the user) a word (or stem) and its corresponding letter columns may be shown differently such as for example in bigger and/or highlighted characters. If said word is not the desired word, the user may proceed to a correction procedure according to one embodiment of the invention by entering precisely at least one of the characters of the desired word. For this purpose, the user may select/enter said desired character among the characters within the column corresponding to said character position. In order to select/enter said precise character, for example, the user may tap on said character (or on a zone within said column corresponding to said character) within said column. The system may consider/enter said precise character and eventually may propose another word based on all of the input information corresponding to the word provided until that moment. The user may repeat said procedure (e.g. on more columns) for entering more precise characters of the desired word until the system proposes the desired word. If the desired word is not in the word dictionary database, the user may repeat said procedure for all of characters of the word.

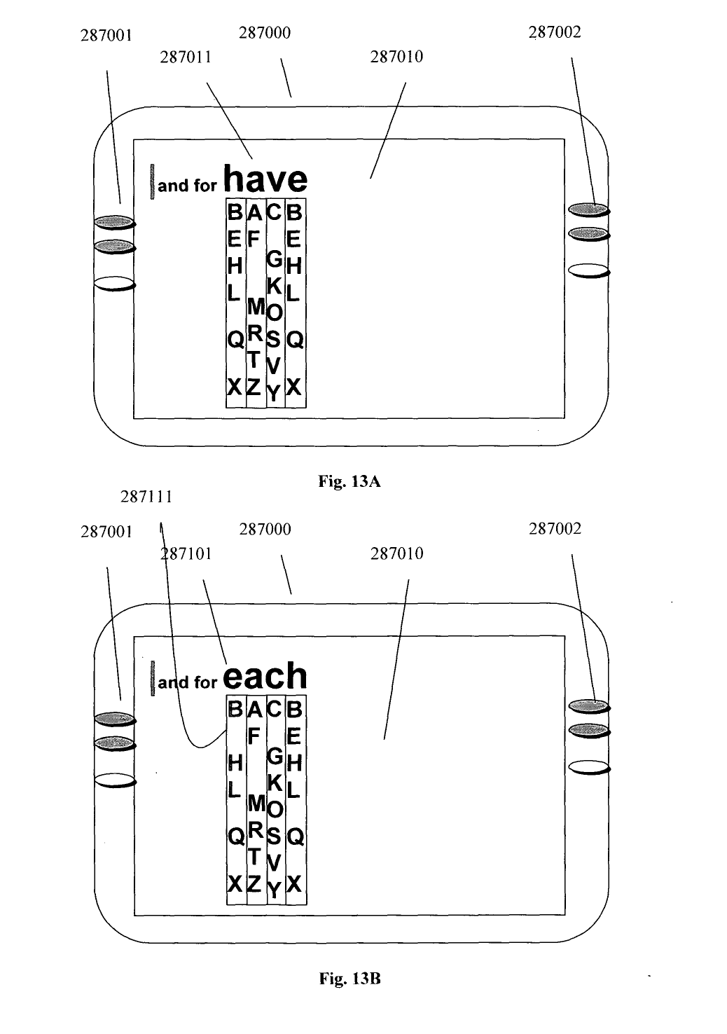

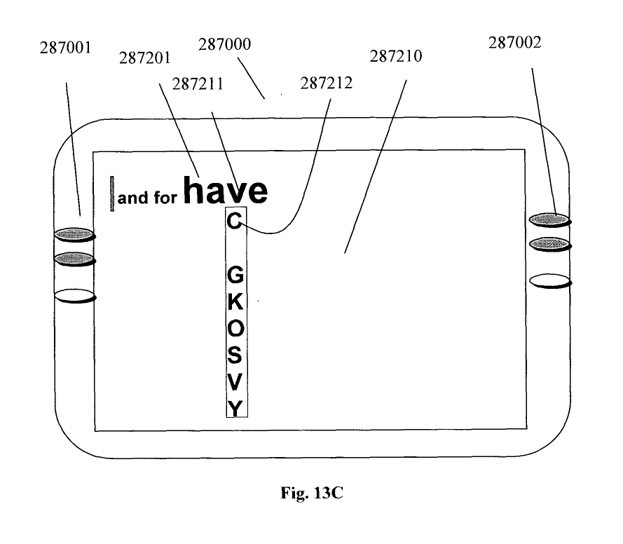

As an example, FIG. 13A shows a device 287000 wherein the word “have” 287011 is being printed on its screen 287010 through the first input information provided by interacting with the split keys on keypad sections 287001 and 287002, of the exemplary first keypad of the invention duplicating the keypad portions 1051 and 1052 of keypad 1000 of FIG. 1. In this example, the current word “have” 287011 and the corresponding letter columns are being shown in bigger characters so that they are easier to interact with. As shown in FIG. 13B, if the user desires to enter the word “each” instead of “have” he may tap on the letter “e” 287111 in the first/corresponding letter column. The system may replace the word “have” by a new word that begins with the letter “e”. In this example, said word is the word “each” 287101 having the highest priority (in the system's word database) among the words corresponding to the input information provided by the user until that moment. Alternatively, instead of the first character, the user may enter any other character of the word by using this procedure (e.g. by tapping on the desired letter within the corresponding letter column).

With continuous description of the current embodiment, showing or hiding the letter columns may be optional. According to one method, if the system does not show the letter columns automatically, the user may tap on a desired letter in a proposed/selected word and the system may show its corresponding letter column. As an example, FIG. 13C shows the word “have” 287201 and the column letter corresponding to its third character which is presented by the system based on a tapping action provided by the user on the letter “v” 287211. In order to change said word to the desired word “each”, at this time, for example, the user may tap on the desired letter “c” 287212 within the letter column. Then the system may replace the letter “v” by the letter “c” and eventually also replace the word “have” by the word “each” corresponding to the input information provided until then and having the highest priority among the words corresponding to said input information. The system may also hide said third letter column.

It must be noted that according to one method, a word is highlighted or shown in bigger characters after the user selects it or points to it (e.g. by using a cursor or his finger, etc.).

According to one embodiment of the invention, letter columns corresponding to all of the characters of an entered word, may be shown as a result of a predefined user interaction such as, for example, a gliding action on at least a portion of said word or pointing to said word, etc. As an example, as shown in FIG. 14A, if the user desires to enter the French word “champetre” which for example does not exist in the word database of the system, then after providing the first input information through the first keypad of the invention, the system may propose the word “sharper” 287307 followed by the characters “*”. In this example, the input signals corresponding to the seven beginning characters of the word may correspond to the word “sharper” included within the database. The input information corresponding to eight beginning characters of the word does not correspond to any of the words or stems in the database of the system. Therefore according to one method, the system keeps the proposed word corresponding to the first seven input signals and adds a “*” character at the eighth character position of said word. The system repeats said character when the user enters the ninth character of the said desired word (since there is also no matching word for the provided nine input signals). At this time the user may proceed to the correction procedure according to an embodiment of the invention by using the letter columns. For example, the user may first provide a gliding action 287308 on the proposed word. The system shows the letter columns 287305 corresponding to all of the characters of the proposed word. The user may tap on the desired characters on each of the corresponding columns (e.g. preferably in the order of the positions of the letters within said word). According to one method, as shown in FIG. 14B, each time the user taps on a letter within a letter column to select/enter a corresponding letter, said letter column disappears. As shown, in this example, the user has selected six beginning characters of the desired word. FIG. 14C shows the desired letter being entered entirely after the user having tapped on all of the desired letters on the corresponding columns. At this time, in this example, all of the letter columns disappeared.

With the continuous description of the current embodiment, if the user taps on a character of the proposed word (e.g. the system may show the corresponding letter column), then providing a new (another) input signal through the first keypad may replace said character of the proposed word by a new character based on the principles of the data entry system of the invention. The system may, eventually, also propose a new word.

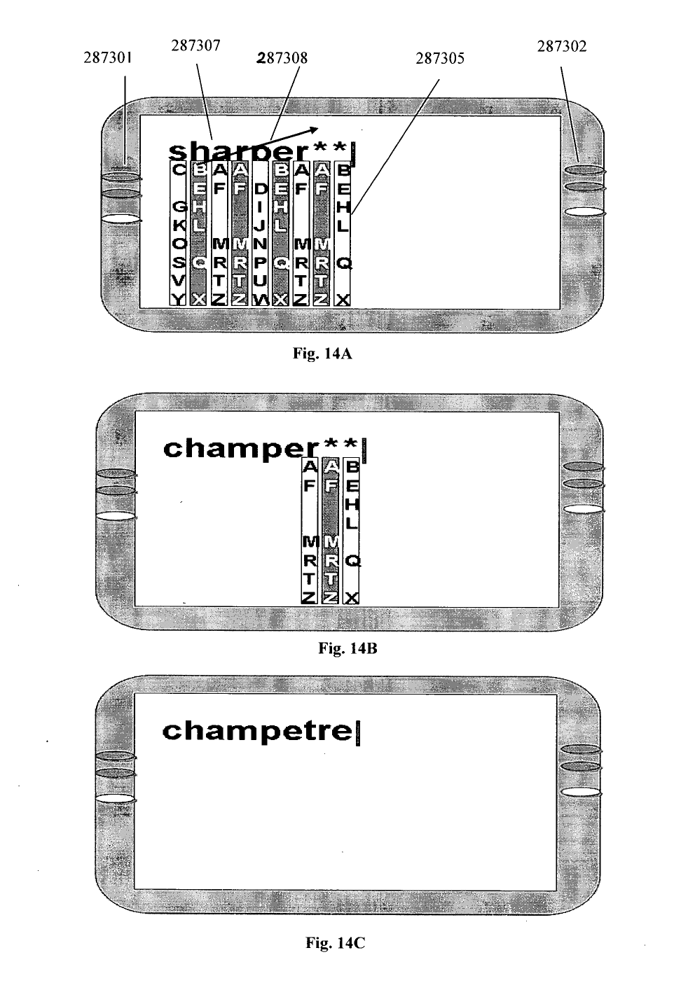

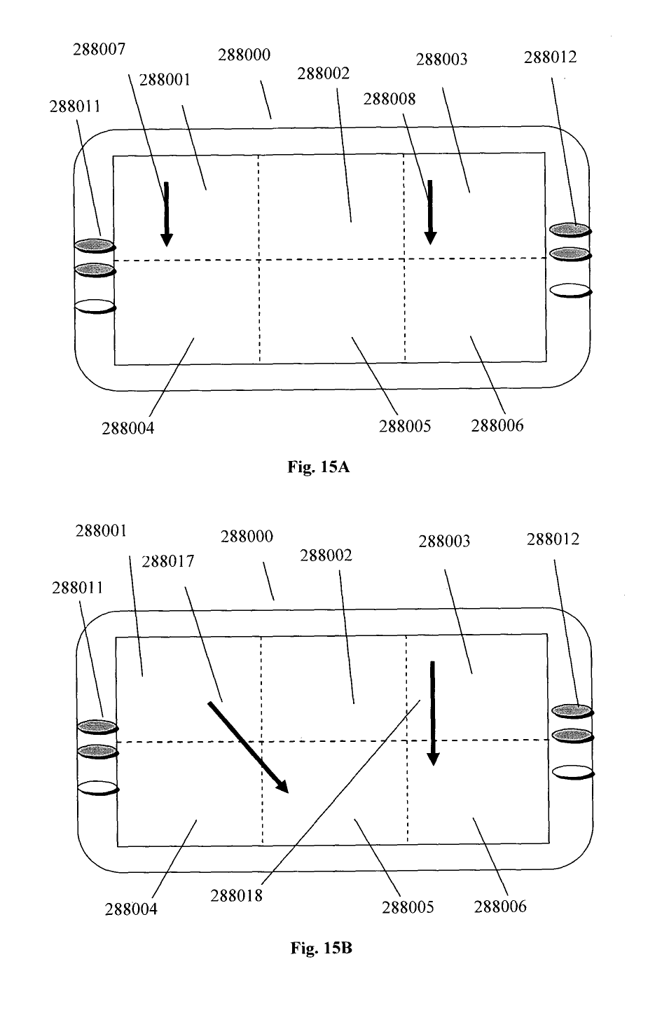

The procedures of distributing symbols among different groups based on certain categories and assigning each group to a mode instance (e.g. provided through predefined mode key interactions) have already been described before. According to one embodiment of the invention, instead of providing said mode instances through key interactions (e.g. key presses), each of at least some of said mode instances may be provided by interacting with a different predefined portion of a touch-sensitive surface such as the touch-screen of the corresponding device. As an example, FIG. 15A shows a device 288000 having the a split first keypad of the invention including key portions 288011-288012 duplicating the keys portions 1051-1052 of FIG. 1. Said electronic device has also a touch screen being preferably virtually divided into six different zones 288001-288006 wherein each zone is assigned to a different mode instance. In this example, when the user touches a zone, the system may enter into the corresponding mode instance (e.g. in this embodiment, the correction procedure of the invention may also be considered as a mode instance). Then, an interaction such as tapping or gliding action within said zone may be interpreted by the system as to duplicate the tapping action with a corresponding key of the second keypad of the invention corresponding to the relating mode instance. For example, the zone 288001 may be assigned to the “TEXT” mode (e.g. punctuation mark characters), and during the correction procedure of the invention, interaction within the zone 288003 may be assigned to interacting with a second keypad of the invention corresponding to the a correction procedure of the invention. Also, for example, the zone 288004 may be assigned to the “NUM” (e.g. digits 0-9) mode, the zone 288006 may be assigned to the “ARITH” (e.g. arithmatich characters) mode, the zone 288002 may be assigned to the “RARE” (e.g. other/rare characters) mode, the zone 288005 may be assigned to the “FUNC” (e.g. functions/commands) mode, etc. As an example, during a correction procedure of the invention, providing an interaction such as a gliding action 288008 within the zone 288003 may correspond to interacting with the letter key of the second keypad (e.g. in this example, a telephone-type keypad) of the invention relating to the letters “tuv”. Also as an example, providing an interaction such as a gliding action 288007 within the zone 288001 may correspond to interacting with the key of the second keypad (e.g. the key “TUV”) to which in this example the character “?” is assigned in “TEXT” mode.

In the current embodiment, when the user touches a zone, the corresponding mode characters and/or direction zones as described earlier may dynamically be shown on the screen.

With continuous description of the current embodiment, for easier interaction, according to one method, the user may begin a gliding action in the corresponding zone and end it in another zone (e.g. or vice-versa). The system may consider said gliding action as being provided entirely in the beginning zone (e.g. or vice-versa). As an example, as shown in FIG. 15B, providing a gliding action 288018 that begins in the zone 288003 but ends in another zone 288006, may predefinely be considered by the system as being (entirely) provided entirely within the zone 288003. Also for example, providing a gliding action 288017 that begins in the zone 288001 but ends in another zone 288005, may be considered by the system as being related to the zone 288001.

According to some embodiments, if an automatic mouse procedure is integrated within the system, then the rules regarding distinguishing between gliding/tapping actions relating to a mouse or to data entry may be implemented within the system. For example, according to one method, a gliding action that begins in a zone and ends quickly (e.g. in any zone) may be related to the data entry system of the invention (relating to said beginning zone), and a gliding action that ends slowly may be related to the corresponding mouse function.

Instead of or in addition to using different zones relating to different modes, each of said modes may be assigned to a different finger of the user, or to a different combination of user's fingers preferably being used simultaneously. For example, according to one embodiment, providing an interaction (e.g. on a touch sensitive surface such as a touch-screen) with the user's right thumb may correspond to an interaction within a first mode. Also for example, providing an interaction (e.g. on a touch sensitive surface such as a touch-screen) with the user's right forefinger may correspond to an interaction in a second mode. Also for example, providing an interaction (e.g. on a touch sensitive surface such as a touch-screen) with two of a user's fingers may correspond to an interaction in a third mode. Also for example, providing an interaction (e.g. on a touch sensitive surface such as a touch-screen) with three of a user's fingers may correspond to an interaction in a fourth mode, and so on.

Alternatively or additionally, different modes (as described in the embodiments) may be assigned to different portions (e.g. tip, flat) of one or more fingers of a user.

Using different combinations of fingers to refer to different modes may be practical in many situations and also may be easily recognizable by the system. For example, gliding with the right hand with combination of forefinger-and-pointer can be easily be distinguished from gliding with right hand with combination of the pointer-and-pinky, for example, because in the first case the forefinger's contact point on a touch-sensitive surface is generally in a higher position relating to the pointer position which is on the left side of the forefinger contact point said touch-sensitive surface, wherein in the second case the pointer contact point on said surface is generally in higher position relating to the pinky position which is on the right side the pointer contact point.

According to one embodiment of the invention, each of the mode instances may be assigned to a different user's finger being recognized by the system based on its fingerprint characteristics, and/or its biological characteristics such as its form/size/shape.

For example, when the user touches the touch sensitive surface with a finger, the system may scan its fingerprint and relate it to the corresponding mode. Also for example, when the user provides a gliding action with said finger, the system may select the character corresponding to said mode and said gliding action.

It should be realized that the gliding actions described in different embodiments of the invention may be provided on the touch-screen of the corresponding device and/or on a touch sensitive surface (e g such as a mouse pad) connected to a corresponding device.

According to one embodiment of the invention, the user may provide a combined gliding action including several continuous (e.g. straight) gliding actions in different directions (optionally, without removing his finger from the touch-sensitive surface) and wherein the system relates each of said gliding actions to the corresponding key of, for example, a second keypad. For such purpose different predefined methods may be considered:

According to a first method, when providing a combined gliding action, the system considers the beginning point of said gliding action as the center of a second keypad and relates the gliding action in the corresponding direction to interacting with the corresponding key of the second keypad. FIG. 16A shows as an example, a device 289000 having a split first keypad having two portions 289021-289024 (arranged similarly to the arrangement of keys in keypad 1000 of FIG. 1), wherein at the beginning the user had pressed the keys 289003, 2890031 and 289004. By considering the word database of the system, the system had proposed the word “you” (not shown). In this example, said word is not the user's desired word, therefore, the user may proceed to the correction procedure of the invention using combined gliding actions. At first the user provides the gliding action 289001. The system may consider that the beginning point of the gliding action corresponds to the center of a second keypad (e.g. in this example, a telephone-type keypad,) and its direction corresponds to interacting with the key of the second keypad having the letters “abc”. In this example, at some point, without lifting his finger from the touch-sensitive surface the user changes the direction of the gliding action towards the right side of the screen to begin to provide a second gliding action 289002 going from left to right. The system understands that the first gliding action is ended and it relates said first gliding action to the letter “c” 289011. The system also considers the changing direction point as the beginning point of the second gliding action 289002 and relates the second gliding action to interacting with the key of the second keypad that corresponds to the letters “mno”. The user then may change the direction of the combined gliding action towards the upper-right side of the screen to begin to provide a third gliding action 289003. The system understands that the second gliding action is ended and it relates said second gliding action to the letter “o” 289012. The system considers the new changing direction point as the beginning point of the third gliding action 289003 and relates the third gliding action to interacting with the key of the second keypad that corresponds to the letters “def”. A representation of the second keypad may be displayed on screen for the user to see his options while entering the characters. For example, gliding action 289003 may display “D” 289013 to the user. The user then ends the third gliding action and the system relates said third gliding action to the letter “d”. At this time the word “you” is replaced by the word “cod” as shown on the screen.

According to a second method, while providing a combined gliding action, the system considers the beginning point of the first gliding action-of the combined gliding action as being in the center of a second keypad, and the beginning point of each one of the following gliding actions of the combined gliding action is considered to be located on the key selected during the previous gliding action of said combined gliding action. Therefore, the system relates each of said gliding actions to the corresponding key of the second keypad based of the direction of said gliding action that departs from said departing point towards the corresponding key of the second keypad. FIG. 16B shows as an example, the same device 289000 of FIG. 16A, having a split first keypad, and wherein in this example, the combined gliding action 289141 provided through the correction procedure of the current embodiment, corresponds to entering the precise letters “cod” wherein originally the system had proposed the word “you” based on key presses provided through the first keypad. In the current example, during the correction procedure, the user first provided the gliding action 289101. The system relates it to the letter “c”. Without lifting the finger from the touch-sensitive surface, the user then provided the second gliding action 289102. The system considered the departing point of said gliding action as being from the key 289202, and by considering the direction of said second gliding action 289102, the system related said second gliding action to interacting with the key 289206 of the second keypad. By considering the same principles, without lifting the finger from the touch-sensitive surface, the user then provided the third gliding action 289103. The system considered the departing point of said gliding action as being from the key 289206, and by considering the direction of said third gliding action 289103, the system related said third gliding action to interacting with the key 289203 of the second keypad. The word “cod” is now being provided through the second method of the combined gliding actions relating to the correction procedure of the invention.

It should be noted that during the correction procedure of a word, the user may provide several combined gliding actions wherein each one of said combined gliding actions may correspond to a different portion of said word.

Using a procedure including use of key press and speech (e.g. during a correction procedure) for entering precisely at least one of the characters of a desired word has been described in the art. According to one embodiment of the invention, in addition to the technologies for the entry of precise characters the system may also include and use speech recognition technology. As an example, during the correction procedure of the invention for entering a word requiring entering precisely a few characters of the word, the user may use a correction procedure (e.g. according to an embodiment of the invention) that does not use speech and speech recognition technology, but for entering a long word which requires entering precisely many characters of said word (e.g. for example a long word not existing in the dictionary database of the system) the user may use a procedure of correction that uses the speech and the speech recognition technology. For example, if the word to be entered is a long word such as the name of a person that does not exist in the dictionary database of the system, then after providing the first input information provided by the user through the keys of the first keypad, the system may propose an undesired long word. At this time the user may speak the letters of said word letter by letter. By considering the first input information corresponding to the letters of said word and the user's corresponding speech the system may propose said word.

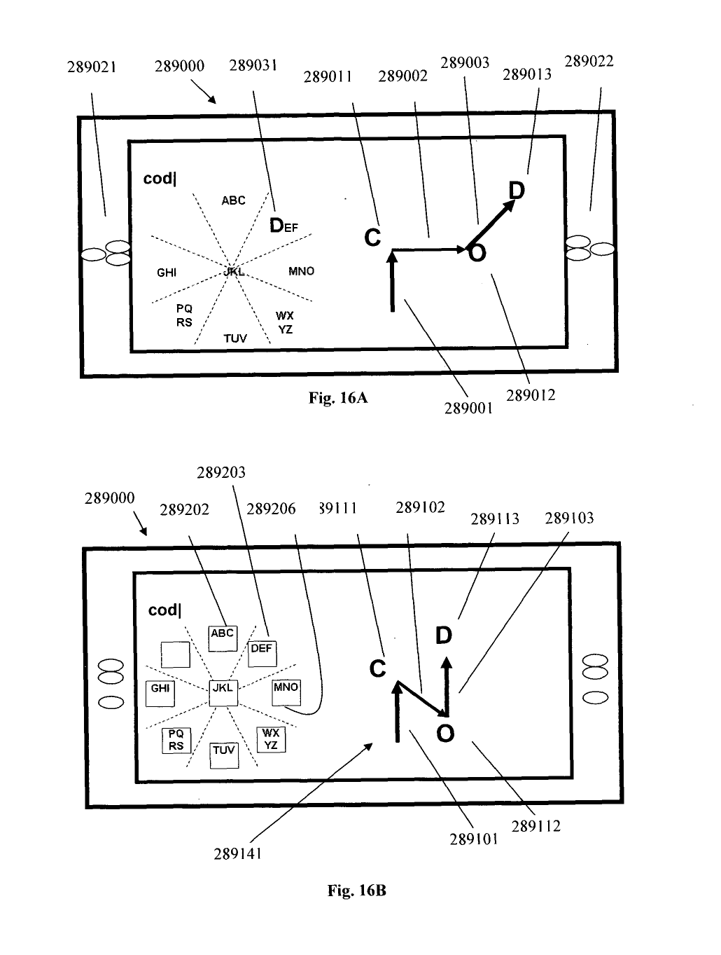

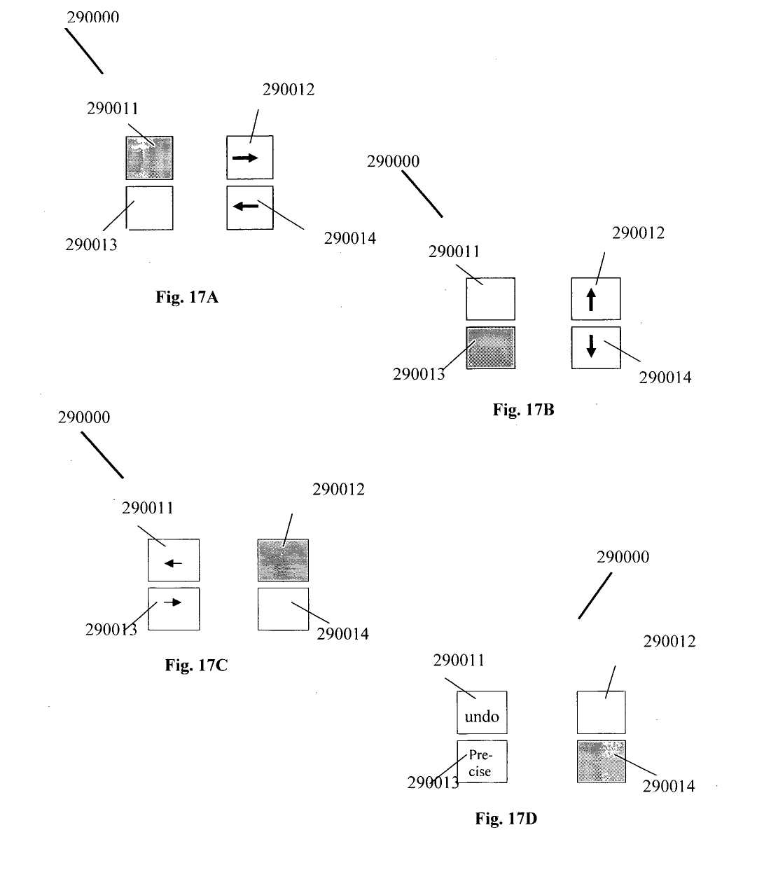

According to one embodiment of the invention, providing predefined interactions with a combination of at least two different keys of at least the letter keys of preferably the first keypad may correspond to entering a different symbol, such as a character or a function (e.g. hereafter referred as shortcut). Some of the frequently used symbols may be assigned to said interactions. FIGS. 17A to 17D show as an example the letter keys of the first keypad 290000 according to one embodiment of the invention wherein different functions are assigned to different interaction (combinations). For example, as shown in FIG. 17A, if the user presses (and holds) the key 290011 and then presses the key 290012, said interaction may correspond to pressing the right-arrow key/function (e.g., of a PC keyboard), and if the user presses and holds the key 290011 and then presses the key 290014, said interaction may correspond to pressing the left-arrow key/function (e.g., of a PC keyboard).

Also as an example, as shown in FIG. 17B, if the user presses (and holds) the key 290013 and then presses the key 290012, said interaction may correspond to pressing the up-arrow key/function (e.g., of a PC keyboard), and if the user presses (and holds) the key 290013 and then presses the key 290014, said interaction may correspond to the down-arrow key/function (e.g., of a PC keyboard).

Also as an example, as shown in FIG. 17C, if the user presses (and holds) the key 290012 and then presses the key 290011, said interaction may correspond to leftward navigation within a word (e.g. left “In-Word”, as described before), if the user presses (and holds) the key 290012 and then presses the key 290013, said interaction may correspond to rightward navigation within a word (e.g. right “In-Word”, as described before).

According to one embodiment of the invention, an “undo” function (e.g. may be similar to the “undo” function used in a word processing software) may be assigned to a predefined key interaction to delete at least some of the latest changes provided by the user in a text. For example, during the correction procedure of the invention, if the user provides an erroneous gliding action and the system changes a word accordingly, erroneously, the user may provide a predefined (e.g. key) interaction that informs the system to go back to the instance immediately prior to said erroneous gliding action. For example, as discussed in an example earlier, if the user desires to enter the word “day” after entering the first input information, the system may propose the word “was”. At this time, the user may proceed to the correction procedure of the invention by providing a gliding action corresponding to interacting with the key of the second keypad of the invention (e.g. in this example, a telephone-type keypad). It may happen that the user mistakenly provides a gliding action in a wrong direction for example in the downward direction that corresponds to the key of the second keypad of the invention that includes the letters “tuv” and the system provides an erroneous word (e.g. “ufo”) based on the erroneous input information. At this time the user may notice that he has provided an erroneous gliding action and in order to move one instance back he may provide a predefined interaction and the system goes one instance back and again proposes the word “was”. At this time the user may provide the gliding action in the correct direction (e.g. a gliding action towards the upper-right direction corresponding to interacting with the key of the telephone keypad that includes the letters “def”) and the system may provide the desired word “day”. The “Undo” function just described may be assigned to interacting with two keys of the first keypad of the invention. For example, as shown in FIG. 17D, pressing and holding the key 290014 and pressing the key 290011 may correspond to providing one “Undo” action. Providing a sequence of undo actions, may move back the system a number of instances corresponding to the number of the “undo” actions provided during said sequence.

As mentioned before, during the entry of a word the system may propose different words/stems some having at least some ambiguous characters. Therefore (the letters on) the screen may fluctuate.

As mentioned before, the data entry system of the invention may include an “in-word” navigation means that automatically and/or manually navigates within the word to select a letter in order to, for example, modify it (e.g. replacing it by another letter).

According to one embodiment of the invention, during the entry of a word, if a word or stem proposed by the system includes one or more ambiguous letters which may be the right letters in right positions within the desired word, when one such letter is selected by the “In-word” navigation-and-selection means, the ambiguous status of said letter may be changed to a precise letter/character by providing a predefined interaction such as a predefined pressing action with one of more keys. By doing so, the user may inform the system that the selected letter must be considered as a precise character/letter of the desired word in said positions. According to one method, the system may immediately consider said precise letter and may propose another word based on the input information provided until said instance. According to another method, the system considers said precise character but does not propose another word or stem immediately. The system may consider said precise character only after the user provides an additional input information through the first keypad of the invention (e.g. adds another ambiguous character of the desired word).

After changing the status of the selected character (from ambiguous to precise) the “in-word” navigation-and-selection means may preferably automatically select another (e.g. the next) ambiguous character of the proposed word/stem.

With continuous description of the current embodiment, as an example, during the entry of the word “information” by a user the system may accept user press the keys of the first keypad of the invention corresponding to the first two letters of the word and the system may provide the word/stem “in”. At this time if the user provides the pressing action on the key corresponding to the third character of the word, the system may propose the word “put”, and so on. To avoid or reduce the on-screen word fluctuation, the user may provide an interaction (e.g. for example, two consecutive predefined pressing actions on one predefined key or on a combination of two of more predefined keys) to inform the system that said two letters (e.g. “in”) are precise characters of the desired word in the corresponding positions within said word. At this time the system may consider said two letters as being precise characters of the desired word and may “lock” said letters and when the user provides the pressing action on the key of the first keypad corresponding to the other characters of the desired word the system considers said precise characters and does not change them during the entry of said word.

It should be noted that the user may select any of the characters of a proposed stem/word and change their status from ambiguous to precise. For example, the system automatically or the user manually, may select a character of a word/stem proposed by the system to the user, and the user may provided a predefined interaction with one or more keys of the system to inform the system that said character must be considered as a precise character of the desired word.

With continuous description of the current embodiment, as an example shown in FIG. 17D, pressing (and holding) the key 290014 and pressing one time the key 290013 may correspond to informing the system that the letter currently selected within the proposed word/stem should be considered as a precise character. According to one embodiment of the invention, after said interaction the system may automatically select another character such as the next character of the proposed word/stem and if the user provides said key interaction again then the system considers said other character also as being precise characters of the desired word, and so on.

It must be noted that the examples of distribution order of symbols corresponding to different shortcuts described above are provided only as examples. Obviously, said distribution order may be changed by people skilled in the art.

Providing an interaction which combines at least two keys of at least the letter keys of the first keypad, may duplicate interaction with the corresponding key of a predefined imaginary/virtual second keypad. For example, a predefined interaction with, a key of a virtual second keypad having a telephone-type key arrangement may be duplicated by interacting with the (letter) keys of the first keypad having four letter keys.

According to one embodiment of the invention, gliding actions or a tapping action imitating interactions with the keys of a second keypad provided during at least the correction procedure of the invention may be duplicated by providing predefined interactions with generally up to two keys of the first keypad. For this purpose, as an example, quick tapping actions on the letter keys of the first keypad of the invention may correspond to entering the first input information corresponding to the letters/characters of a desired word. Accordingly, a second predefined type of interaction such to a press-and-holding action of on one of the keys of the first keypad and then releasing said key or a third predefined type of interaction such as a press-and-holding action of on one of the keys of the first keypad and then pressing another key of said first keypad, may duplicate interacting with a predefined key of the second keypad of the invention.

According to a preferred embodiment of the invention, the second keypad of the invention may be a virtual/imaginary telephone type keypad model and said second predefined type of interaction with a first key of the first keypad may correspond-to or duplicate interacting with the center key (e.g. the key including the letters “jkl”) of the letter keys of said virtual telephone type keypad. When the user releases said first (e.g. the pressed-and-held) key then the system considers said interaction to be duplicating a tapping action on said center key of the virtual second keypad of the invention. Accordingly, if the user does not release said first key (e.g. he continues to pressing it) and presses/taps-on another key (e.g. of the first keypad of the invention), then the system may consider the imaginary trajectory between said first key and said another key (e.g. trajectory departing from said first key towards said another key) which are being pressed and relates said pressing actions on said two keys to a gliding action on said virtual telephone type keypad departing from the center key of said virtual keypad and having the same (or similar) trajectory. The system accordingly relates said another type of interaction to interacting with the corresponding key of the second keypad of the invention.

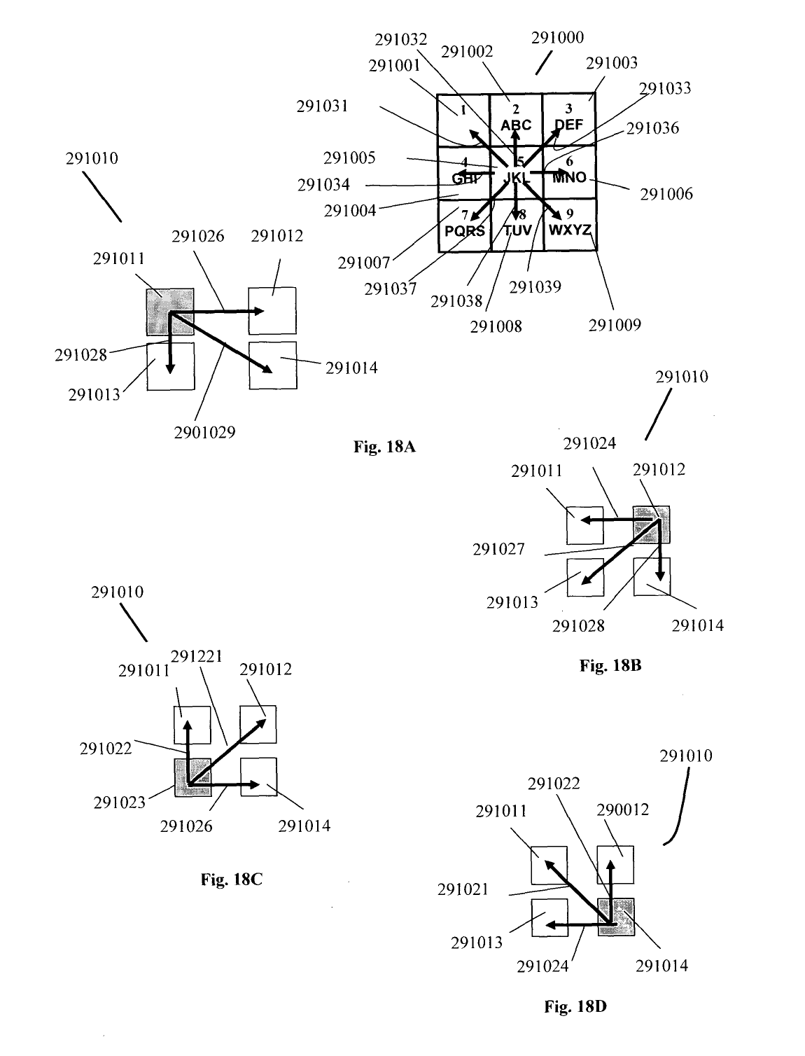

As an example FIG. 18A shows the letter keys of a predefined virtual telephone-type keypad 291000 (e.g. here used as the second keypad of the invention) and the trajectories of the gliding directions departing from the center key 291005 towards the other keys of said keypad. FIG. 18A also shows the letter keys 291011-291014 of a/the first keypad 291010 according to embodiments of the invention. In this embodiment, in addition to being used for providing the first input information corresponding to a desired word said letter keys 291011-291014 of the first keypad according to embodiments of the invention 291010 may also be used for duplicating the interactions with the keys of a virtual second keypad having a telephone type arrangement. For example, as just described, if the user presses and holds a first key 291011 and then presses a second key 291012 of the first keypad 291010, the imaginary trajectory 291026 between said first and second keys is similar to the trajectory of the gliding action 291036 departing from the center key 291005 of the telephone type keypad towards the key 291006 of said telephone type keypad. Therefore, the system may consider the combined interactions provided on/with the first and second keys of the first keypad 291010 of the invention as duplicating an interaction with the key 291006 of the virtual second keypad 291000 of the invention. Based on the same principles, press-and-holding the key 291011 and then pressing the key 291014 (e.g. trajectory 291029) may correspond to the trajectory 291039 on the second keypad 291000 and therefore correspond to interacting with the key 291009. Also based on the same principles, press-and-holding the key 291011 and then pressing the key 291013 (e.g. trajectory 291028) may correspond to the trajectory 291038 and interacting with the key 291008. These principles may be applied to other interactions with the first keypad.

With continuous description of the current embodiment, FIGS. 18B to 18D show other interactions based on the principles just described. For example, as show in FIG. 18B, press-and-holding the key 291012 and then pressing the key 291011 (e.g. trajectory 291024) may correspond to the trajectory 291034 and interacting with the key 291004. Also press-and-holding the key 291012 and then pressing the key 291013 (e.g. trajectory 291027) may correspond to the trajectory 291037 and interacting with the key 291007. Also press-and-holding the key 291012 and then pressing the key 291014 (e.g. trajectory 291028) may correspond to the trajectory 291038 and interacting with the key 291008.

With continuous description of the current embodiment, as show in FIG. 18C, press-and-holding the key 291013 and then pressing the key 291012 (e.g. trajectory 291023) may correspond to the trajectory 291033 and interacting with the key 291003. Also press-and-holding the key 291013 and then pressing the key 291014 (e.g. trajectory 291026) may correspond to the trajectory 291036 and interacting with the key 291006. Also press-and-holding the key 291013 and then pressing the key 291011 (e.g. trajectory 291022) may correspond to the trajectory 291032 and interacting with the key 291002.

With continuous description of the current embodiment, as show in FIG. 18D, press-and-holding the key 291014 and then pressing the key 291011 (e.g. trajectory 291021) may correspond to the trajectory 291031 and interacting with the key 291001. Also press-and-holding the key 291014 and then pressing the key 291013 (e.g. trajectory 291024) may correspond to the trajectory 291034 and interacting with the key 291004. Also press-and-holding the key 291014 and then pressing the key 291012 (e.g. trajectory 291022) may correspond to the trajectory 291032 and interacting with the key 291002.

According to one embodiment pressing-and-holding any of the keys of the first keypad and then releasing said key may correspond to interacting with the center letter key (e.g. the key including the letters “jkl”) of a predefined (virtual) second keypad of the invention having a telephone type arrangement. According to another embodiment of the invention, pressing-and-holding and then releasing a first predefined key (e.g. among the keys of the first keypad) may correspond to interacting with the center letter key of the second (virtual) keypad according to embodiments of the invention having a telephone type arrangement of keys. According to one embodiment, pressing-and-holding and then releasing each of the second, third, and fourth, predefined keys (e.g. among the four keys of the first keypad) may respectively correspond to interacting with one of the three corresponding keys of the virtual second keypad of the invention corresponding, for example, to the characters “0”, “*”, and “#”.

It should be realized that duplicating the interactions with the keys of the second keypad through said other types of interactions with the keys of the first keypad may be used for all of the functionalities assigned to keys of the second keypad. For example, said other interaction may be provided during a correction procedure according to embodiments of the invention. As an example, by considering the letter keys of the first keypad of the invention 291010 as illustrated in FIG. 18A wherein said letter keys duplicate the letter keys of the keypad 1000 of FIG. 1, if the user desires to enter the word “day”, he may first provide corresponding (quick) tapping action on the keys of the first keypad 201010 to provide the first input information corresponding to his desired word. The system may propose the word “was” having the highest priority among the words of the word database of the system corresponding to said input information. At this time the user may provide additional input information by proceeding to the correction procedure and provide a press-and-holding action on the key 291013 and then pressing the key 291012. The combined interaction of the two keys 291013 and 291012 may correspond to (e.g. duplicate) interacting with the key including the letters “def” of a predefined virtual telephone type keypad according to an embodiment of the invention. By considering the combined first and additional input information provided by the user until that moment, the system may propose the word “day” which, in this example, is the desired word.

Imitating interactions with the keys of a second keypad by providing predefined interaction with a first keypad (preferably having fewer keys than the second keypad), may be used for entering symbols or instructions other than letters (e.g. special characters, commands, functions, etc.) such as those assigned to different the modes. After entering to a mode, the user may provide an interaction to duplicate a gliding action as just described so as to enter a symbol assigned to a key of the (optionally virtual) second keypad according to embodiments of the invention. For this purpose, at first the user may provide a predefined interaction such as interacting with one or more keys (e.g. of the first keypad) to enter the system into a desired mode. Said predefined key interaction may be of any type. For example, according to one method, the user may first press and hold a first key and then without releasing said key he may tap on another key. According to another method, the user may provide a double tapping action, or a long pressing action, etc., on a key.

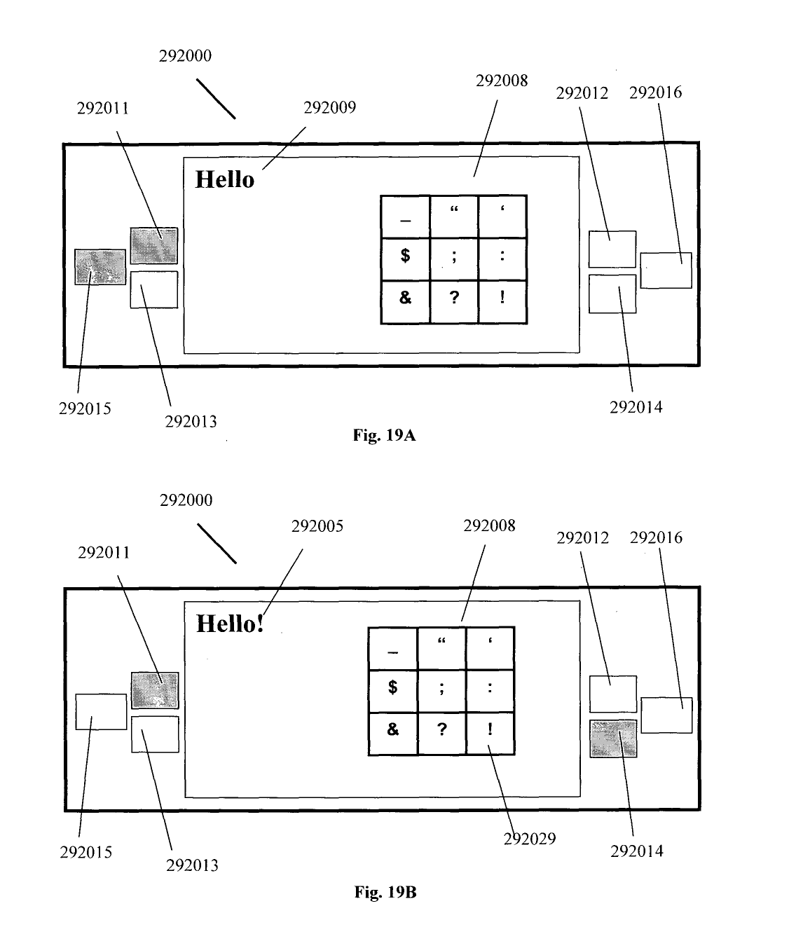

FIG. 19A shows as an example, a device 202000 including the a data entry system according to an embodiment of the invention, here using six keys 292011-292016, wherein four of said keys 292011-292014 are ambiguous letter keys for example duplicating the letter keys 1001-1004 of the keypad 1000 of FIG. 1. In this example, the word “hello” 292009 is being entered (e.g. proposed by the system) by providing tapping actions (e.g. quick pressing actions) on the corresponding ambiguous letter keys. In order to enter the special character “!” (e.g. in this example belonging to the “TEXT” mode instance) at the end of said word, the user may first enter the system into said “TEXT” mode instance by providing a predefined interaction with one or more keys of the first keypad. To do so, in this example, the user may press (and hold) the key 292015 and (e.g. then, while holding said key) he may press the key 292011. Accordingly, the system may enter into the “TEXT” mode instance and preferably may show the predefined imaginary/virtual second keypad 292008 of the invention including the “TEXT” symbols (e.g. example of “TEXT” symbols assigned to the second keypad of the invention is being shown and described earlier) on the screen of the device. At this time, as shown in FIG. 19B, the user may duplicate interacting with the key 292029 of the imaginary/virtual second keypad 292998 according to embodiments of the invention that includes the special character “!” through providing a predefined interaction with two keys of the first keypad of the invention, for example, as described earlier. For this purpose, the user may first press and hold the keys 292011 and then optionally simultaneously press the key 292014. The system may enter the letter symbol “!” 292005 at the end of the word “hello”.

It should be noted that after entering into a mode, the user may enter several times (e.g. consecutively) one or more symbols corresponding to said mode instance. According to one method, if the user provides a quick pressing action (e.g. a tapping action) on a letter key without pressing (and-holding) another key, then the system exits from the/said mode instance and may consider said tapping action as being related to entering an ambiguous letter of said key (e.g. entering at least part of the first input information corresponding to a word). Also, tapping on another key such as the “space” key may also exit the system from the mode instance and enter a “space” character.

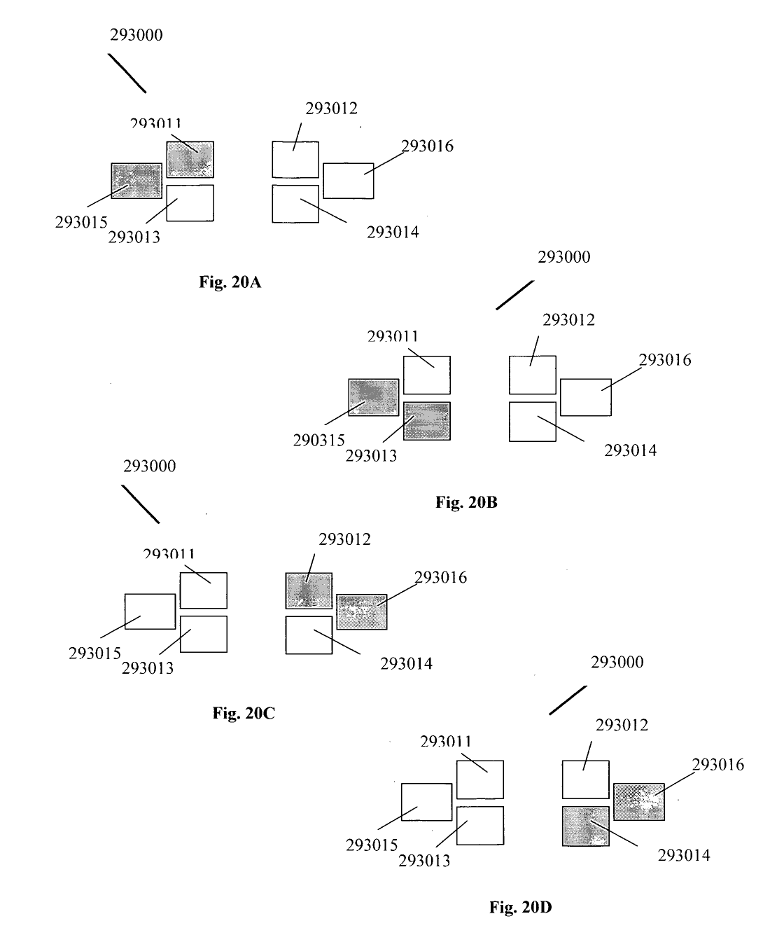

According to one embodiment the special symbols (e.g. special characters, commands, functions, etc.) may be divided into different groups of symbols wherein each group is assigned a different mode (e.g. such as those described earlier). Each of said modes may be assigned to a different predefined interaction with one or more keys of the first keypad. FIGS. 20A to 20D show as an example, four different key(s) interactions possible on a 6 key keypad 2923000, for example, resembling to the keypad 1000 of FIG. 1, each corresponding to a different mode. For example, as shown in FIG. 20A, pressing (and holding) the key 293015 and then (e.g. while holding said key) pressing/tapping the key 292011 may correspond to a first mode. Also for example, as shown in FIG. 20B, pressing (and holding) the key 293015 and then (e.g. while holding said key) pressing/tapping the key 292013 may correspond to a second mode. Also for example, as shown in FIG. 20C, pressing (and holding) the key 293016 and then (e.g. while holding said key) pressing/tapping the key 292012 may correspond to a third mode. Also for example, as shown in FIG. 20D, pressing (and holding) the key 293016 and then (e.g. while holding said key) pressing/tapping the key 292014 may correspond to a fourth mode. Other modes, each corresponding to an additional different predefined key(s) interaction, are possible, according to embodiments of the invention.

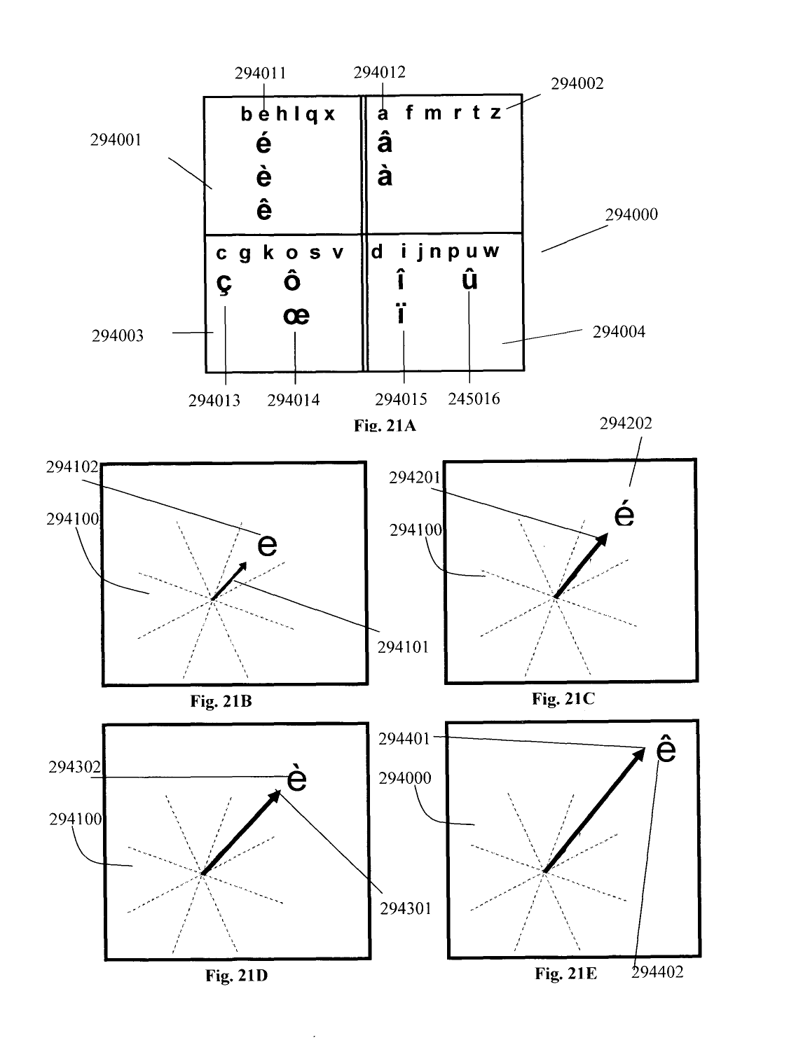

In some languages such as the French language some of the characters of the language may include one of more graphical signs (e.g. grave, aigu, circonflexe, on the vowel characters in the French language) each indicating a different pronunciation or a grammatical indication for said characters (e.g. hereinafter such characters may be named a “derivation”). FIG. 21A shows as an example, the letter keys 294001-294004 of the exemplary first keypad 294000 of the invention used for the entering text in French. As shown, most of the vowels in the French language have more than one pronunciation. For example the letter “e” 294011 may be shown and pronounced in four different manners 294011. During the text entry and correction procedures according to embodiments of the invention in a language including such characters this matter may provide ambiguity. For example, by considering a first keypad 294000 and a virtual second keypad such as a virtual telephone-type keypad model, pressing the key 294001 of the first keypad 294000 and then providing a gliding (e.g. swiping) action (similar to gliding action 291033 in FIG. 18A) on a touch sensitive surface may ambiguously correspond to the letter “e” or any of its derivations. In order to enter easily and quickly such characters and/or words including such characters, different methods may be included within the data entry system of the invention.

To solve the above-mentioned problem, preferably, during at least the correction procedure according to embodiments of the invention, when using a touch-sensitive surface, the length of the gliding action may define the character or any of its derivations. When using hard keys of the second keypad the system may consider the length of the pressing action time on the corresponding key of the second keypad to define the character or any of its derivations.

As an example, FIGS. 21B to 21E, show the procedures of entering the letter “e” or any of its derivations through a touch-sensitive surface according to one embodiment of the invention. As an example, if the user presses the key 294001 of the first keypad the system may propose the letter “l”(e.g. in this example having the highest priority in the French dictionary of the system). The user then may proceed to the correction procedure according to an embodiment of the invention. As shown in FIG. 21B, at the beginning of the corresponding gliding action 294101 on a corresponding touch-sensitive surface 294100 the system may propose the letter “e” 294102. If the user continues the gliding action 294201 in the same direction/zone, then as shown in FIG. 21C, the system may propose a second derivation of said letter. In this example said second derivation is the character “é” 294202. If the user continues the gliding action 294301 in the same direction/zone, then as shown in FIG. 21D, the system may propose a third derivation of said letter. In this example said third derivation is the character “è” 294302. If the user continues the gliding action 294401 in the same direction/zone, then as shown in FIG. 21D, the system may propose a fourth derivation of said letter. In this example said fourth derivation is the character “ê” 294402. The same may be true for the letter “a” and its derivations 294012, the letter “c” and its derivation 294013, the letter “o” and its derivations 294014, the letter “i” and its derivations 294015 and the letter “u” and its derivations 294016.

It should be noted that the user may change the length of the trajectory of the gliding action (typically to shorten it) by gliding back in the same direction/zone and the system may change the proposed letter accordingly. It must also be noted that the order of proposing a letter or its derivations during the gliding action may dependent on different parameters such as the priority of said letters relating to each other.

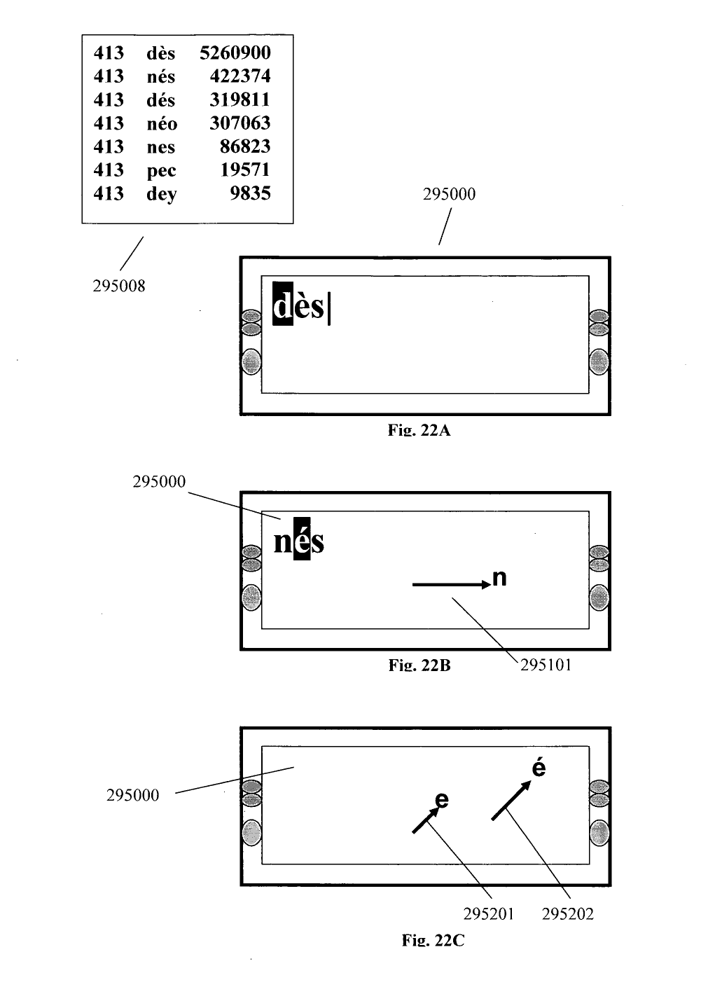

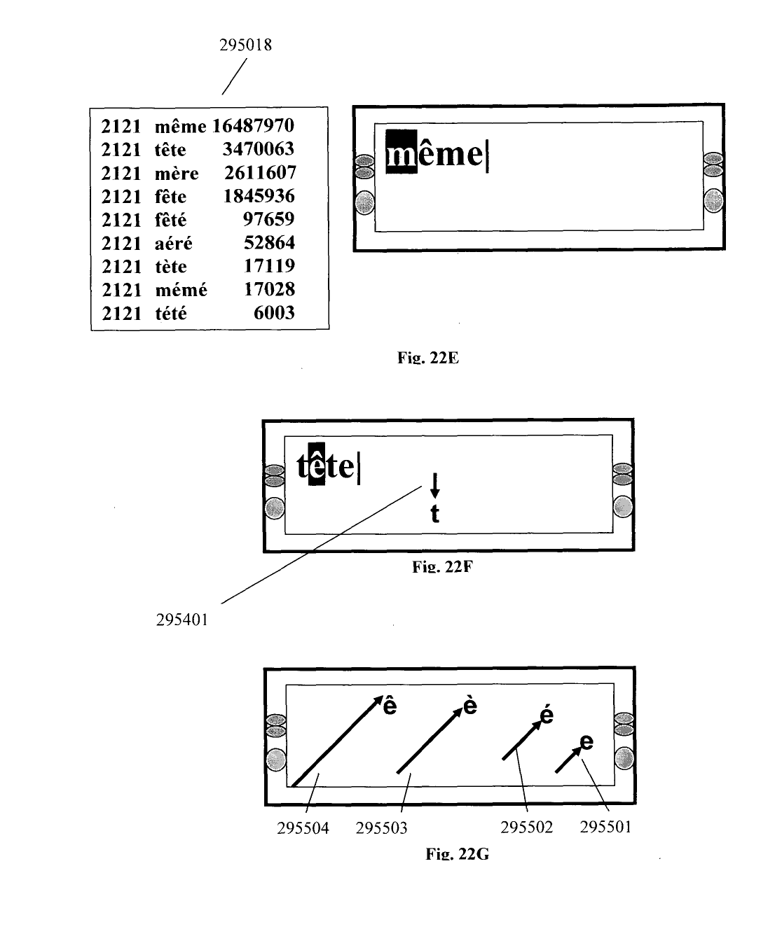

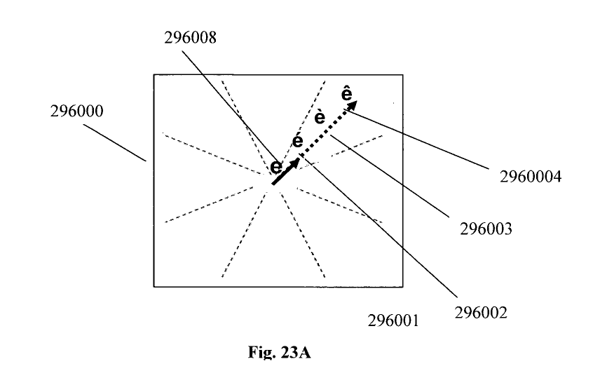

The procedure of the entry of a letter or its derivation as described may be used for entering words. As a first example, by considering the portion 295008 of the French database of words of the system, as shown in FIG. 22A, if the user presses the keys 294004, 294001, and 294003, of the first keypad 294000 of FIG. 21A, the system may propose the word “dès” having the highest priority among the words corresponding to said pressing actions. Then, as shown in FIG. 22B, by considering that the second keypad in this example is a telephone-type keypad, if the user provides the gliding action 295101, then by considering the preferable rules of the data entry system of the invention, the system may propose the word “nès”. At this time, as shown in FIG. 22C, in two ways:
if the user provides the shortest gliding action 295201 then by considering the corresponding pressing action of the first keypad and said gliding action 295201 the system may relate said gliding action to the letter “e” and accordingly propose the word “nes” corresponding to the (combined) input information provided for entering the current word.
if the user provides a predefined longer gliding action 295202 then by considering the corresponding pressing action of the first keypad and said gliding action 295202 the system may relate said gliding action to the letter “é” and accordingly propose the word “néo” corresponding to the (combined) input information provided for entering the current word.

As an additional example, by considering the portion 295018 of the French database of words of the system, as shown in FIG. 22E, if the user presses the keys 294002, 294001, 294002, and 294001, of the first keypad 294000 of FIG. 21A, the system may propose the word “même” having the highest priority. Then, as shown in FIG. 22F, by considering that the second keypad in this example is a telephone-type keypad, if the user provides the gliding action 295401, then by considering the preferable rules of the data entry system of the invention, the system may propose the word “tête”. Then, in four ways, as shown in FIG. 22G:
if the user provides a shortest gliding action 295501 then by considering the corresponding pressing action of the first keypad and said gliding action 295501 the system may relate said gliding action to the letter “e”. Because there is not any word in the dictionary that corresponds to the first input information provided by the user and that its first precise character must be the letter “t” and its second letter must be the letter “e”, then the system can not propose any word and may only change the second letter of the current proposed word “tête” by the letter “e” and provides the chain of characters “tete”.
if the user provides a gliding action 295502 having a second different predefined (e.g. longer) length then by considering the corresponding pressing action of the first keypad and said gliding action 295502 the system may relate said gliding action to the letter “é” and accordingly propose the word “tété”.
if the user provides a gliding action 295503 having a third different predefined (e.g. still longer) length then by considering the corresponding pressing action of the first keypad and said gliding action 295203 the system may relate said gliding action to the letter “è” and accordingly propose the word “tète”.
if the user provides a gliding action 295504 having a fourth different predefined (e.g. longest) length then by considering the corresponding pressing action of the first keypad and said gliding action 295204 the system may relate said gliding action to the letter “ê”. Because there are no more words in the dictionary that correspond to the first input information provided the user and that its first precise character must be the letter “t” and its second letter must be the letter “e”, then the system can not propose another word and maintains the current proposed word.

For easier interaction at the beginning and/or while providing a gliding action, preferably the corresponding letter and all of its derivations at their corresponding portions of the trajectory of said gliding may be shown on the screen. As an example FIG. 23A, shows the gliding action 296008 that has begun by the user. In addition to the corresponding letter the system may show its derivations along the portions 296001 to 296004 of the trajectory of the projected or provided (straight) gliding action 296008. The system may show said information so that at any moment during a gliding action the user may glide back and forth to select his desired letter or derivative.

According to one embodiment of the invention, a gliding action may correspond to more than one character. This may be extremely beneficial for entering and/or correcting words in some languages such as French.

In some languages such as the French language in some cases two consecutive words may be (shortened) and combined within one word being separated with a special character such as an apostrophe (e.g. contracted word). Some examples in French are shown as follow:
ne aurais→n'aurais
se aime→s'aime
que importe→qu'importe

Including substantially all of the contracted words in the dictionary database of the data entry system of the invention specially when it is used in devices with low memory or slow processor may not be recommended or practical.

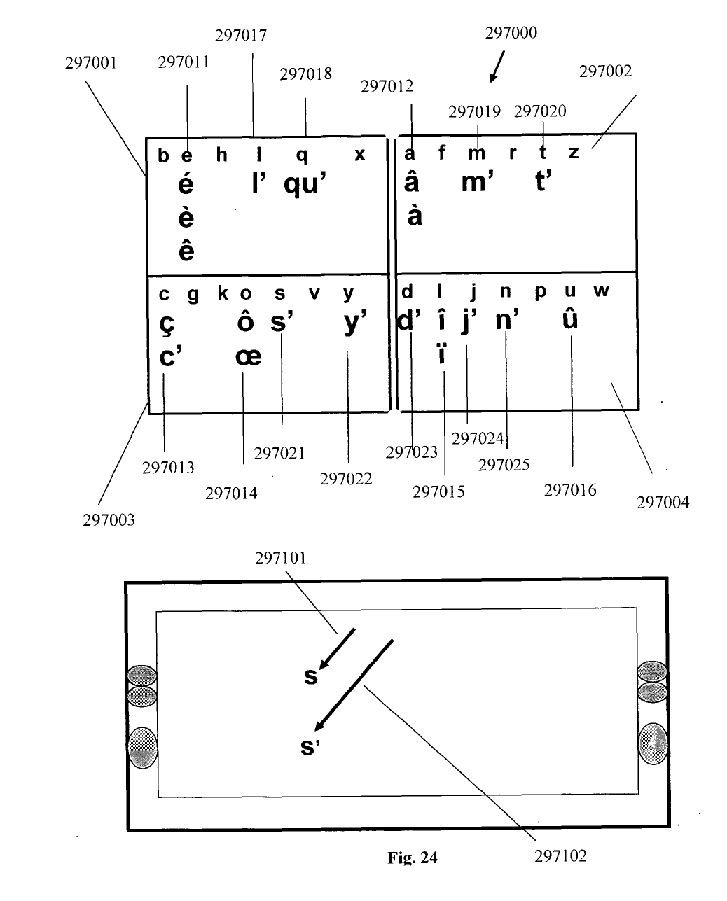

According to one embodiment of the invention, a gliding action during the correction procedure of the invention may correspond to more than one character (hereinafter referred to as “combined-characters”). FIG. 24 shows as an example, the four letter keys 297001-297004 of a first keypad 297000 according to an embodiment of the invention showing letters and their derivatives and some combined-characters on some keys. In this example each of the combined-characters begins with a letter assigned to the corresponding key. It must be noted that the combined-characters are shown on the keys of the first keypad only for indicative purposes in this example. Said combined-characters may or may not be assigned to or represented by the first keypad of the invention.

According to one embodiment when a user enters an ambiguous letter through the first keypad of the invention, he may change said letter by replacing it with a combined-character. A predefined gliding action, for example, provided during the correction procedure of the invention may correspond to at least one of the a character, its derivation, and one or more of the combined-characters assigned to said gliding action. For example, as shown in FIG. 24, after pressing the key 297003 of the first keypad 297000 according to an embodiment of the invention, a predefined short gliding action 297101 in the direction of the key of the telephone-type second keypad according to an embodiment of the invention (to which the digit “7” is assigned) may correspond to the letter “5”, and providing a gliding action 297101 with a longer trajectory in the same direction may correspond to the combined-characters “s'”.

According to one embodiment, after entering a combined-characters during the correction procedure, the system may provide an end-of-the-word signal (e.g. preferably without providing any additional character). In other words, the entry of the word may end if a combined character is entered.

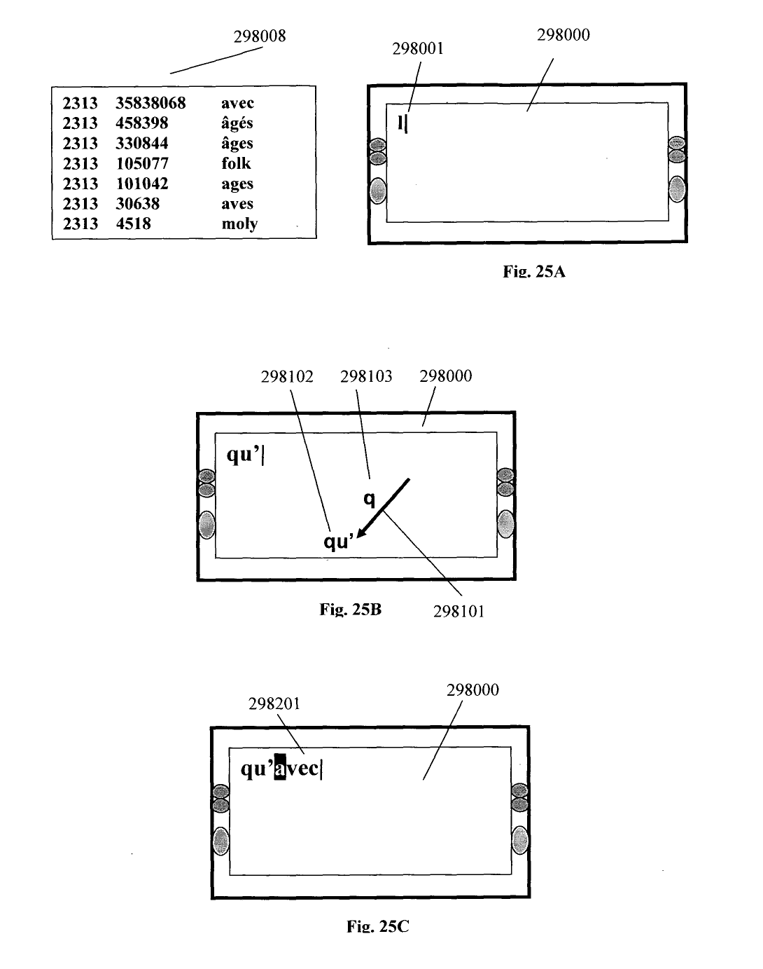

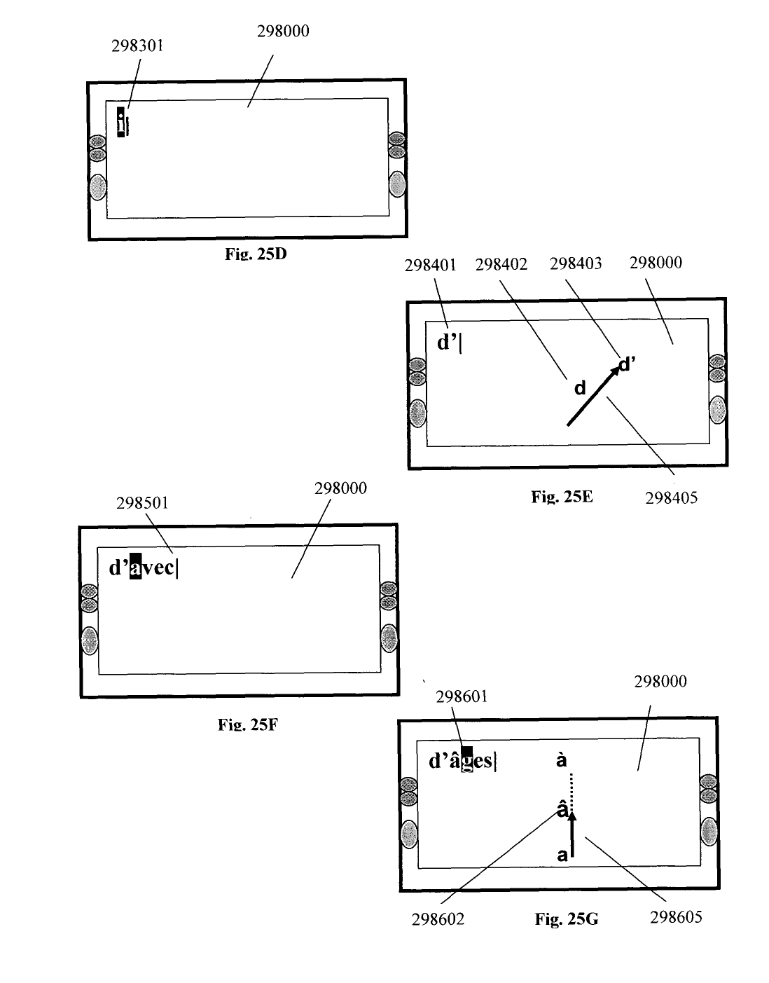

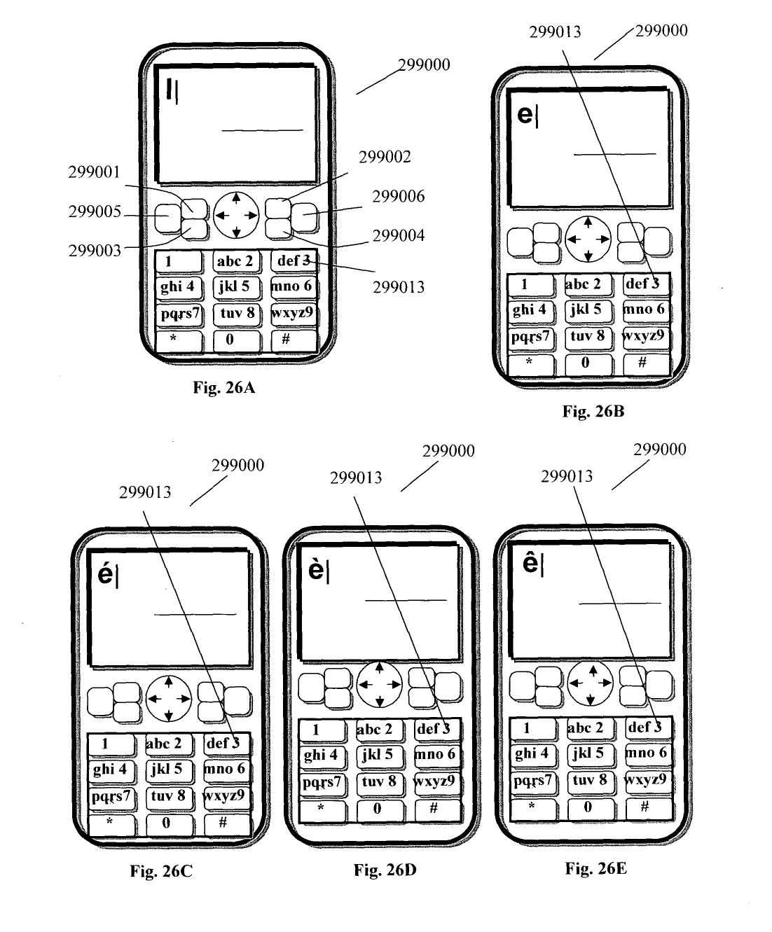

The procedure of entering combined characters may significantly ease the entry of contracted words without integrating them in the dictionary database through the data entry system of the invention. For this purpose, the first portion of the contracted words in a language may be assigned to the gliding actions provided during the correction procedure of the invention. As an example, FIG. 25A shows a device having a touch-sensitive surface 298000. By considering the portion 298008 of the database of the system and the first keypad 297000 as show in FIG. 24 and using a telephone-type keypad as the second keypad, if the user presses the key 297001 of the first keypad the system may propose the ambiguous letter “l” 298001. At this time, as shown in FIG. 25B, the user may provide a gliding action 298101. Based on the principles of the gliding actions and their lengths as just described, at the beginning of said gliding action the system may propose the better “q” 298103. If the user continues said gliding action in the some direction, starting from a predefined point the system may propose the combined-characters “qu'” 298102. At this time, it the user ends said gliding action (e.g. by lifting his finger from the touch-sensitive surface), the system may replace the character “l” by the combined-characters “qu'” 298102 and preferably provide an end-of-the-word signal. Now, if the user provides pressing action through the keys of the first keypad, the system relates said input information to entering a new word. At this time, as shown in FIG. 25C, if the user presses the keys 297002, 297003, 297001, and 297003, the system may propose the word “avec” (e.g. having the highest priority among the word corresponding to the first input information) immediately after the combined-characters “qu'” and provides the contracted word “qu'avec” 298201.

According to another example, in order to enter the combined word “d'âges”, as shown in FIG. 25D, the user may first press the key 297004 of the first keypad 297000. The system may propose the ambiguous letter “i” 298301. At this time, as shown in FIG. 25E, the user may proceed to the correction procedure according to an embodiment of the invention and provide a gliding action 298405. At the beginning of the gliding action the system may propose the letter “d” 298402 but if the user provides a longer gliding action then the system may propose the combined-characters “d'” 298403.

At this time the user may end the gliding action and the system may enter said combined-characters and display them on screen (298401) and provides an end-of-the-word signal. At this time, as shown in FIG. 25F, the user may press the keys 298402, 2403, 298401 and 298403. The system may propose the word “avec” 298501 having the highest priority. Then, the as shown in FIG. 25G, the user may begin to provide a gliding action 298605 towards the key of the virtual second keypad including the digit “2”. At the beginning of said gliding action the system may propose the letter “a” and may also show the derivations of said letter so as to inform the user that if he continues said gliding action he may be able to select one of said derivations at a corresponding predefined point during said gliding action. In this example, if the user continues said gliding action the next character being proposed to the user is the character “â” 298602. If the user stops gliding action 298605 when the character “â” 298602 is reached (e.g. and for example, becomes highlighted), said character is selected. By combining the first and the additional input information provided by the user, the system may propose the word “âges” (e.g. having the highest priority among the word corresponding to said combined input information) immediately after the combined-characters “d'” and provides the contracted word “d'âges” 298601.

According to one embodiment, instead of using the gliding actions, the above-mentioned procedures of the entry of the combined characters and contacted words may be provided by using a timer. For example, if the device using the data entry system does not include a touch-sensitive surface, the system may use an integrated timer for the same purpose. For example, if the device is a telephone without a touch-screen, the user may provide a first input information by using the first keypad. The user then may use the keys of the second keypad of the invention (e.g. in this example a telephone keypad) for the correction procedure according to embodiments of the invention. When the user begins to press a corresponding key of the first keypad, the system may show a first character corresponding to said pressing action. If the user continues said pressing action, the system may show a second character or a combined-character as described earlier, and so on. According to one method, at the end of proposing the last character/combined-character assigned to said pressing action, if the user still continues said pressing action, the system may begin to propose said characters and combined characters again accordingly (e.g. in a cycle).

FIG. 26A, shows as an example, a device 299000 such as a telephone having a first keypad including the letter keys 299001 to 299004. The device uses the telephone keypad as the second keypad. In this example, if the user presses the key 299001 of the first keypad, the system may propose the ambiguous letter “l”. At this time, as shown in FIG. 26B, the user may proceed to the correction procedure by providing a pressing action on the key 299013 of the second keypad. As mentioned, according to one embodiment the system may include a timer. At the beginning of the pressing action provided by the user on the key 299013 and by considering the corresponding pressing action provided through the key 299001 the system may propose the letter “e”. If the user continues said pressing action on the key 299013, as shown in FIG. 26C, after a predefined additional laps of time the system may propose another character(s) which in this example is the character “é”. If the user still continues said pressing action on the key 299013, then as shown in FIG. 26D, after a predefined additional laps of time the system may propose another character(s) which in this example is the character “è”. Finally, in this example, if the user continues said pressing action on the key 299013, as shown in FIG. 26E, after a predefined additional laps of time the system may propose another character(s) which in this example is the character “ê”. According to one embodiment, if the user still continues to the pressing action on the key 299013, the system may begin the presentation of characters from the beginning again.

A timer may also be used to replace the necessity of providing a gliding action having a predefined length. According to one embodiment of the invention, the user may provide a gliding action of any length. At the beginning the system may propose a predefined character to the user. At the end a gliding action the user may stop the gliding action but does not lift his finger from the touch-screen surface. At this time a timer may start counting the time and after a predefined laps of time the system may propose a next character or combined-characters as described. If the user continues holding his finger in the same position on the touch-screen, then after an additional predefined laps of time the system may propose a next character or combined-characters as described, and so on. At any moment:
if the proposed character or combined-character is the desired one the user may
lift his finger from the touch-sensitive surface and the system selects said character or combined-characters.
if the user moves his finger on the touch-sensitive surface, the timer may stop counting the time and the system may propose a character or combined-characters corresponding to the gliding action provided by the user, and so on.

The procedure of assigning more than one character to a gliding action may be beneficial for entering words in non-alphabetical languages such as those using phonetic symbols such as the Chinese and Japanese languages.

It should be noted that such procedure of gliding and pressing actions based on the length of the gliding action and based on the timer may be used for entering other information such as functions in general in any computer application.

According to one embodiment of the invention, providing a pressing action on a predefined key of the first keypad according to embodiments of the invention and (optionally simultaneously) pressing on a key of the second keypad according to embodiments of the invention or providing a predefined interaction such as a tapping action or a predefined gliding action on the touch-sensitive surface may enter the system into the another mode such as the mouse mode. At this time some of the keys of the keypad, preferably not the letter keys, may be assigned to be used as mouse buttons. According to a preferred embodiment of the invention, providing a pressing action on a letter key of the first keypad may bring back the system into the data entry mode of the invention.

According to one embodiment of the invention, while entering a word such as an out-of-the-dictionary word, the user may not use the first keypad of the invention and enter said word by using the gliding/tapping actions relating to interacting with the keys of another keypad. For example, if the user provides a gliding action from the center key towards the upper center key the system may show the letters “abc” to the user. The user may then select one of said letters based on the length of the corresponding gliding action on said touch sensitive surface.

According to one embodiment of the invention, during a correction procedure, each time the user begins to enter a precise character of a desired word in a character position selected by the system or by the user in the corresponding (none-desired) proposed word, the system may show at least one (preferably all) of the words/stems corresponding to the combined input information (e.g. information caused the system to propose the none-desired word in the text and the additional information that will be provided by the user if he provides the current interaction in the correction procedure) so that preferably the user selects one of, said at least one of the words.

For example, if the device has a touch sensitive surface, during the correction procedure when the user begins an interaction such as a pressing/gliding action on said surface, then preferably the system may show one or all of the words/stems corresponding to said interaction in the corresponding direction/zone. The order of location of the words in each direction may be based on their frequency of use relating to each other such that preferably, the shortest gliding action in said direction may be related to the word having the highest priority relating to other words in said direction, and so on (or vice versa).

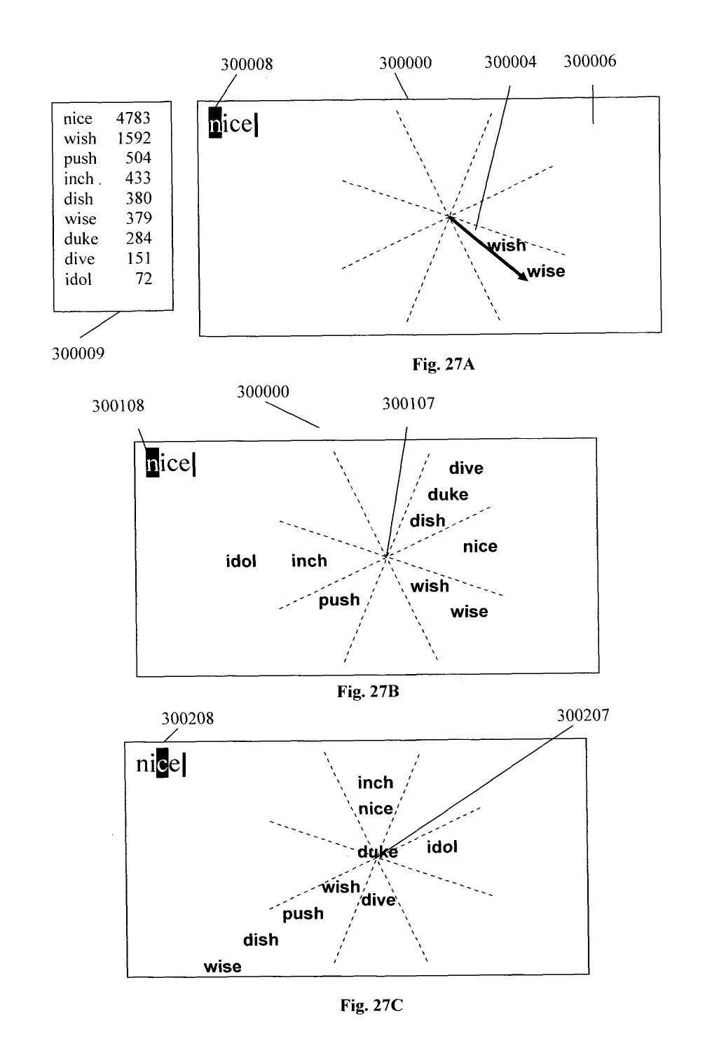

As an example, FIG. 27A shows a device 300000 having a touch sensitive surface 300006 and using the data entry system according to embodiments of the invention. By considering the first keypad 1000 of FIG. 1, and a portion 300009 of the dictionary of words of the system, the word “nice” has been provided by pressing the keys of the first keypad and its first character 300008 is selected by the system. At this time, by considering that the second keypad of the invention in this example is a telephone-type keypad, if the user begins to provide a gliding action 300004 corresponding to interacting with the key of the second keypad relating to letters “wxyz”, based on the principles of the system, the system may select the letter “w” and may show all of the words (e.g. in this example, the words “wish” and “wise”) corresponding to the gliding action in said direction. According to one method, the beginning portion of the gliding action may correspond to the first word which here is the word “wish”. If the user continues said gliding action, starting at a predefined point said (longer) gliding action may be related to the next word “wise” which in this example has lower priority than the word “wish”. At this time, for example, if the user removes his finger from the touch sensitive surface, the word “wise” will be entered and eventually automatically the next character in the next (e.g. in this example, the second) character position may be selected.

It should be noted that in the current embodiment, optionally, the words relating to the tapping action related to the key having the letters “jkl” may be selected by the duration of said tapping action. Alternatively, instead of being assigned to a tapping action said words may be assigned to a gliding action in the direction of the key relating to the digit “1” for example, if the virtual keypad model of the second keypad of the invention is a telephone type keypad.

According to another embodiment, when the user proceeds to the correction procedure and touches the screen, the system shows all of the words corresponding to said pressing action and to all of the gliding actions that may be provided in different directions. As an example, FIG. 27B, shows the same device 300000 wherein the word “nice” is being proposed by the system based on pressing actions provided on the keys of the first keypad. At this time, according to the current example, if the user touches/presses-on a point 300107 of the touch sensitive surface, the system may show in their corresponding zones (e.g. shown within dashed lines), the words relating to gliding actions which may be provided in different directions. In this example, said words are the words of the dictionary that correspond to the ambiguous key presses provided by the user and the precise character corresponding to the selected character in position 300108 that will be provided if the user provides the gliding action in the corresponding direction. In this example, the selected character position is the first character position.

With continuous description of the current embodiments, as another example shown in FIG. 27C, after the word “nice” is proposed, if the user/system selects the third character position 300208, then:
according to one method, when the user touches the touch sensitive surface the corresponding words in each of all of the zones will be shown based on the input information provided by the user until that moment and the precise character relating to the third character position 300208 that will be provided if the user provides the gliding action in a corresponding direction/zone. In this example, the word “duke” 300207 which its third character corresponds to the center key of the second keypad relating to the letters “jkl”, is shown at the touching point. Also, for example, the words “wish”, “push”, “dish”, “wise”, the third character of which corresponds with the key of the second keypad relating to the letters “pqrs” are shown in their corresponding zone/direction and arranged based on their priorities. And so on;
according to another method, when the user touches the touch sensitive surface based on said input information as just described at first only the corresponding words relating the center key may be shown, and if the user begins a gliding action, then only the corresponding words relating to said gliding action will be shown.

After providing an interaction during the correction procedure, if there is not any word/stem in the dictionary that correspond to the combined input information, then according to one method, the system shows only the precise character in said direction. Alternatively, the system shows the proposed word wherein in the selected character position said precise character replaces the corresponding proposed character.

It should be noted that instead of selecting a word based on the length of the gliding action according to one method the gliding action may have any length and the system may use a timer to show the corresponding words one by one so that the user can select one on them.

If the device does not have a touch sensitive surface, then after the user presses a hard key (for example) of the second keypad to select a precise character, then the words corresponding to the combined input information may be shown (e.g. one by one, or all together) on the screen so that the user can select one of them. It must be noted that the same method may be used to assign more than one special character or function ambiguously to a predefined pressing action with a key of the second keypad and be used during the correction procedure of the invention (e.g. using a timer rather than a mode key to switch between two modes).

It should be noted that although gliding/tapping actions are being used to show the embodiments just described, any time a user selects by any means a character (or position) of the proposed word, the system may show one or all of the corresponding words based on the combined input information provided by the user until that moment (e.g. said combined input information may include the first input information based on ambiguous key presses provided through the first keypad, the additional input information providing precise letters/characters, and selecting said character position, etc.) on any location on the screen, and the user may use any means to select one of them.

It should be noted that optionally a word of the dictionary may be a phrase or a compound word including several words. In such case, a special character such as an underscore or even a space character may be used as a separator between words. Optionally, said special character such as the space character may also ambiguously be assigned to one of the ambiguous keys of the first keypad. When the user provides the first input information corresponding to a compound word he may press the keys of the first keypad corresponding to the characters of the (compound) word including said separator(s).

The embodiments just described may be used within a search engine. It also can be used for searching an item by its name. The name of the item may be a compound word. Optionally, said capabilities may be used in an entertainment system such as Media Center PC for entering text for purposes such as to select an item such as a song, a movie, a name in a telephone directory, etc.

By using the data entry system of the invention and its user interfaces (e.g. the first and the second keypad according to embodiments of the invention), a unique standard user interface may be provided for both entering arbitrary data such a text or providing entertainment functionalities through searching and providing textual information. For example, if the user desires to search for an item such as a song by its title, at first using the first keypad accordin to embodiments of the invention he can narrow down the choices to a few items' titles and then select one of them through the second keypad according to embodiments of the invention based on principles of the correction procedures of the invention proposing words through the second keypad. In some cases for example when the searched item such as the title of a song, a movie, or the name of a person, is long, entering the beginning characters of the item's title may be enough to provide/select the desired item.

By using the first keypad of the invention, if desired, the user may enter at least some of the characters such as the beginning characters of the desired item. Then the user may use the second keypad to select one of the choices proposed by the system. As an example, in order to enter/search an item such as the title of a song, the user may enter at least the beginning characters of the item through the first keypad of the invention. At this time the user may proceed to the correction procedure of the invention and provide a tapping/gliding action on the touch sensitive surface corresponding to for example the first (precise) character of the desired item. By considering said first and the additional input information and if needed by using a word completion system, the system may propose one or more corresponding items such as titles of the songs to the user. Said items may be printed for example, in the direction of user's gliding action and the length of the gliding action may define the selected song.

Entering the name of a song may be part of a multi purpose entertainment system. An example of such system will be shown and described in detail hereafter.

According to one example, when the system is used for entertainment purposes, the mode of each of the keys of the first keypad may correspond to entering the system into a corresponding entertainment mode. For example, the user at first may enter the system into a corresponding mode by providing a predefined interaction such as a long pressing action on a corresponding key of the first keypad. For example, the first key of the first keypad may correspond to the text entry mode. The second key of the first keypad may correspond to a GPS mode (e.g. address entry). The third key may correspond to dialing a telephone number mode. The fourth key may correspond to song (search) mode. The fifth key may correspond to movie (search) mode. The sixth key may correspond to game (search) mode, and so on. Typically, each mode is connected to a database relevant to that mode:

After the user enters the system into a desired mode, for example into searching a song mode, the system may ask the user to enter one or more predefined keywords such as the song's title, or the singer, etc. These questions may be provided in different steps, wherein in each step the user may user the first and/or the second keypad of the invention to provide the necessary information.

As an example, the user may have the choice to enter at least some of the characters, preferably the beginning characters, of his desired item such as a song by using the keys of the first keypad. The system selects the corresponding items in a corresponding database. Then the user may use the second keypad of the invention to select at least one of said items. Optionally, in a next step the system may also ask what the user desires to do with the selected item (e.g. play, copy, send to someone. etc.). For this purpose, as an example, the user may use the first keypad of the invention to enter ambiguously the first character of the desired action for example corresponding to the word “copy”. Then he may provide the corresponding interaction through the second keypad, by providing a gliding action in a desired direction. For example, by gliding in the direction of the key of the second keypad corresponding to the letters “abc”, the system may show the word “copy” beginning with the letter “c”. According to some embodiments, instead of using the first and the second keypad, optionally, the user may enter the word “copy” through the first keypad (e.g. if it has the highest priority) or he may directly use the second keypad and glide in the direction of the corresponding (e.g. first) character of the desired word (action) without using the first keypad. By using the first keypad (e.g. through writing the item's name) and/or the second keypad (e.g. through selecting one of the few corresponding (name of) items) the user may provide a desired action. For example said action may be playing, sending, copying, or any other action relating to said selected item.

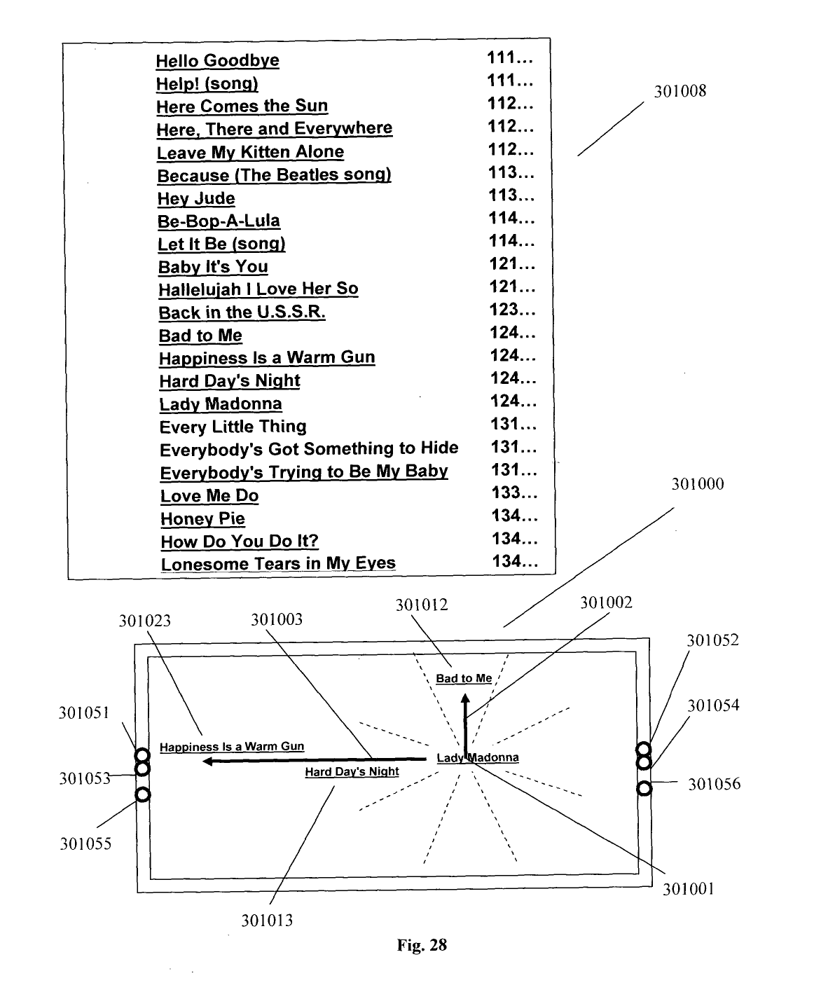

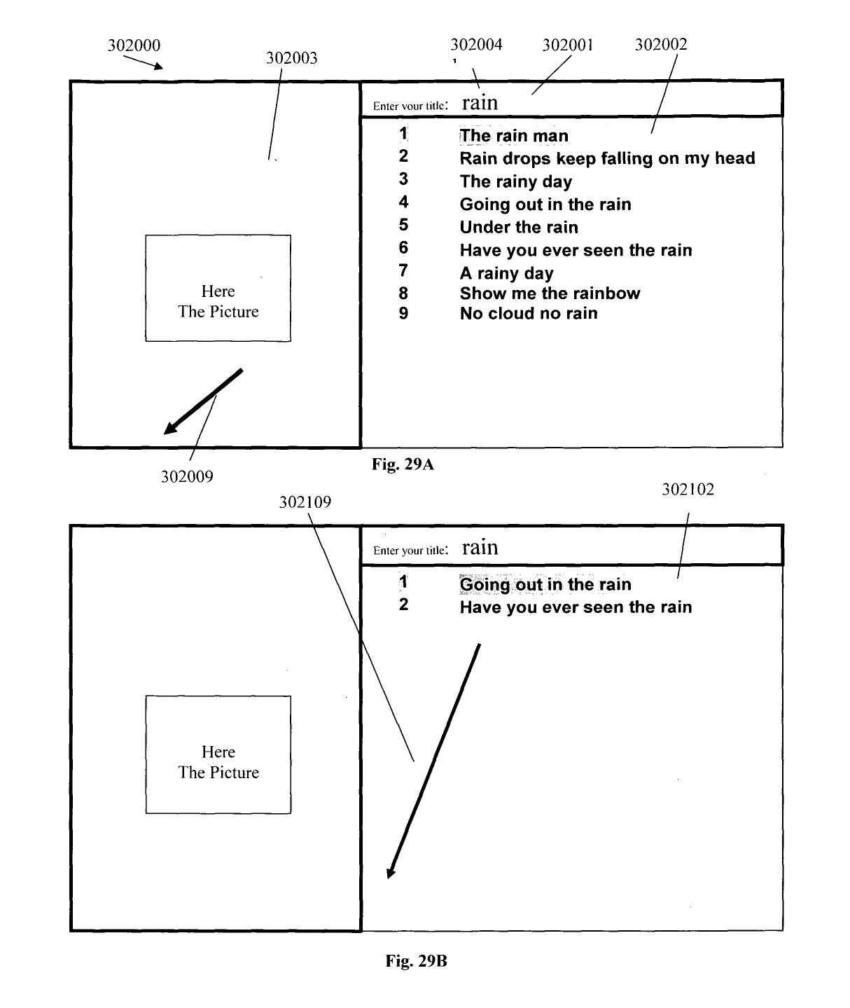

FIG. 28 shows, as an example, the entertainment system according to an embodiment of the invention, after having been entered into the searching mode relating to the songs of Beatles. In this example, for such purpose, at first the user entered the system into song search mode through the corresponding key of the first keypad. Then the user entered the system into searching the songs of the Beatles for example, through a step of the system requiring the name of the group or the singer, etc. During said step the user may have used the first and/or the second keypad (e.g. for entering the name ambiguously, and then if needed selecting one of the names proposed by the system). FIG. 28 shows an exemplary portion 301008 of the database relating to some of the titles of the songs of The Beatles. After narrowing down the search to the songs of the Beatles, the user may now enter at least a portion of the title of the desired song. For example, if the user presses on the keys 301051, 301052, and 301054, of the first keypad, said ambiguous key presses may correspond to four of titles of The Beatles songs. At this time the user may provide different actions, some of which are described as examples hereafter:
if the user touches/presses on a point of the sensitive surface, based on the principles of the data entry system of the invention, if the second keypad of the invention is a telephone-type keypad, the system may show the song which title begins with the letter “l”. The only song relating to the combined input information is the song “Lady Madonna”. The system may show said title 301001 on the screen. If the user removes his finger from the touch sensitive surface the system selects this song.
if the user provides the gliding action 301002 relating to interacting with the key of the second keypad to which the letters “abc” are assigned, then the system selects a title whose first character is the letter “b”. In this example the only relating song is “Bad to me”. The system may show it 301012 to the user. If the user removes his finger from the touch sensitive surface the system selects this song.
if the user begins to provide the gliding action 301003 relating to interacting with the key to which the letters “ghi” are assigned, then the system selects the titles whose first character is the letter “h”. In this example there are two relating songs. The system may show them (301013, and 301023), in the direction of the gliding action 301003 on the screen. If the user removes his finger from the touch sensitive surface according to one method the system selects one of said song titles based on the length of the gliding action.

It should be noted that the databases used with the system may be a built in database and/or an external databases such as those available on the Internet or a cable TV provider, etc.

Based on the principles just described, many different kinds of search interfaces may be designed by people skilled in the art. For example, according to one method, in order to select the desired symbol/item, the system may require several steps of interaction and search, wherein each step may require using the first and/or the second keypad of the invention. Also for example, according to another method, instead of having several steps to select a desired item, a direct search consisting of entering all of the characters of a desired item may be provided.

According to one embodiment of the invention, the user may enter a text such as the title of a song through the first keypad. In most cases the desired word/text may be proposed to the user based on the first input information. Optionally, the system may also use a word completion system to help the system complete a word before the user enters all of the characters of the word. If the proposed word is not the desired word, then, the user may proceed to the correction procedure according to embodiments of the invention.

According to one method, if the list of the words/items/stems in a gliding action direction is long, then according to one method, several gliding actions in said direction may be provided wherein each of said gliding actions may correspond/include some of said words/items/stems. The order of said words/items/stems may be based on a predefined principle such as frequency of use or alphabetical order.

After entering into a mode, if the user desires to exit from said mode, he may provide a predefined interaction such as a gliding action corresponding the key of the second keypad to which the digit “1” is assigned.

For dialing a number, the user may first enter into the dialing mode through the first keypad, and then use the tapping/gliding actions to enter the number.

If the second keypad of the invention is not touch sensitive and has hard keys, then when necessary, a timer may be used to select one of the proposed choices.

According to one embodiment of the invention, the special symbols corresponding to a mode may be assigned to the keys of the second keypad based on the alphabetical order of for example their appellation. Said symbols may be assigned to consecutive keys, wherein each key has at least one of said symbols. According to one method (e.g. if the second keypad is a telephone-type keypad) symbols whose appellation begins with the letters assigned to a key of the second keypad may be assigned to said key. For example, one of the modes may include the functions of at least a corresponding application such as copy, cut, that may be assigned to the key representing the letter “c:, and function such as paste may be assigned to the key representing the letter “p”. The same principles may be used for the searching procedure of the invention that were described before. For example, the name of the movies beginning with a letter corresponding to a gliding action duplicating an interaction with a key may be presented to the user in alphabetical order.

As mentioned before, according to one method, during the entry of a word or during a mode instance for the entry of a special symbol, the system may relate a tapping/gliding action provided by the user to the entry of said word or said special symbol. Accordingly, when the user is not entering a word or a special symbol, a tapping/gliding action provided by the user may be related to a predefined symbol such as a function (e.g. as a mouse function, a function of another application such as a function of the operating system of the corresponding device, etc.). For example, a gliding/swiping action which is not provided during the entry of a word or other mode, may be related to navigating between different pages of a document (e.g. paging), etc.

The advantage of using few virtual keys such as on-screen keys as the first keypad of the invention has been described before. According to one method, said keys may be transparent or semi-transparent so that the text printed on the screen under said keys may be visible. In this case, an interaction with the zone of a virtual key may be ambiguous for the system. The system may not know whether said interaction is related to interacting with said virtual key or it is related to interacting with the text under said key. Different methods may be used to inform the system of the user's intention when interacting with said zone.

According to one method, only short/long pressing actions on the virtual keys may be considered as an interaction with said keys. Accordingly, a gliding action of which at least a portion is provided on a virtual key may not be considered an interaction with said keys. As an example, during the entry of a word, at least a portion of a gliding action corresponding to the correction procedure of the invention may be provided over any of the virtual keys of the first keypad and the system may relate said interaction to the correction procedure. According to another example, when the user is not in the process of entering a word or another mode, if he provides a gliding action which at least partially passes over a virtual key, the system may relate said gliding action to a first predefined function (e.g. a function of another application, such as a paging function, etc.).

Accordingly, when the user is not in the process of entering a word or another mode, if he provides a long pressing action on a virtual key at the beginning of a gliding action which at least partially passes over said key, the system may relate said gliding action to a second predefined function such as the text selecting function of mouse selecting at least the corresponding portion of the text under said virtual key.

According to one embodiment of the invention, when the user provides a gliding action in a direction, the symbols relating to said interaction may be presented to the user at least one by one in a predefined order (e.g. forward order). According to one method, the speed of the gliding action may define the speed of presenting the symbols to the user (e.g. for selecting one or more of them). If the user changes the direction of his gliding action to the opposite direction, the system may respectively change the order of the symbols shown to the user in the opposite order (e.g. backward order). According to one method, if the interaction must be provided with the center key of the second keypad, then a long tapping action (while holding) followed by gliding action in a direction using the same principles (e.g. speed, backward/forward, etc.) may be used for presenting/selecting the symbols relating to interacting with the center key of said second keypad may be provided.

According to one embodiment of the invention, a single gliding action (e.g. in a predefined direction) may correspond to a first symbol such as a character or function, and each consecutive additional gliding action in said direction may correspond to a different symbol. For example, by considering FIG. 21A, after entering the system into the mode instance, providing first time the gliding action 294101 in the direction provided may correspond to the character “e”, and providing a double gliding action in the same direction may correspond to the character “é”, and so on. If the user desires to enter consecutively two similar symbols, according to one method at the end of the corresponding gliding action he may hold his finger in touch with the touch-sensitive surface for a while and the system may provide said symbol each predefined laps of time until the user removes his finger from the surface. According to another method at the end of the corresponding gliding action the user may exit from said mode and instance and re-enter into said mode to re-enter said symbol. The same principles may be used for the searching procedure of the invention that described before. For example, during the correction procedure, the name of the movies beginning with a letter corresponding to a gliding action duplicating an interaction with a key may be presented to the user in alphabetical order. For example, by referring to the example of FIG. 27B, a single gliding action in the direction of the key corresponding to the letter “d” may correspond to the word “dish”, a double gliding action in the same direction may correspond to the word “duke”, and a triple gliding action in the same direction may correspond to the word “dive”, and so on. It must again be noted that each of the gliding actions may correspond to more than one symbol. In this case, as mentioned before, other parameters such as the length of the gliding action and/or a timing parameter (e.g. using a timer) as described before may be considered to relate a gliding action to its corresponding symbol.

It must be noted that any type of interaction may be used to define a vector representing a gliding action in a direction. For example, a first pressing action on a location on a touch sensitive surface may define the beginning point of said vector, and (e.g. while holding said first pressing action) a second pressing action on another location of said touch sensitive surface may define the ending point of said vector.

Obviously, the (media) search described earlier may be designed and provided in a different manner.

According to another embodiment of the invention, the user may enter at least one stem and/or at least one word corresponding to a predefined complete text information available in the database that corresponds to a target (e.g. the title of a media such as a song or movie, the (name of) a person, etc.) and the system provides a selection of the targets corresponding and preferably shows it to the user.

If the selection comprises more that one target, then according to one method, the user may:
either provides more text information (e.g. more words or stems corresponding to the target) until there is only one target corresponding to the user's text entered, or
he may provide another type of information to select one of the targets in the selection. Different methods may be designed and used for such purpose, for example:

1) according to a first method, (after providing an end-of-the-word signal such as a space character) the user may use the second keypad of the invention (e.g. using its keys, or providing gliding actions to duplicate interacting with its keys) to (e.g. ambiguously) inform the system of the first character of the target within the selection and if needed continues the same procedure for the following characters of the target until there is only one target in the selection, or;

2) according to a second method, (after providing an end-of-the-word signal) a gliding action in a first predefined direction may inform the system to select the next target in the selection, and a gliding action in a second predefined direction may inform the system to select the previous target in the selection or;

3) according to a third method, the first and second methods described above may be combined such that to not require an and-of-the-word signal. For example, during the entry of a word corresponding to a target, if the user provides a gliding action corresponding to one of the letter keys of the second keypad, then said gliding action corresponds to the word correction procedure of the invention, and if the gliding action does not correspond to any of the letter keys of second keypad, then each of such gliding actions may predefinely correspond to navigation within and/or selecting one (e.g. the next, or previous) target within the selection. For example, a long gliding action downward or left-downward may correspond to the next target in the selection, and a long gliding action upward or right-upward may correspond to the previous target in the selection;

4) according to another method, the user may use a point and selection method such as a mouse, or an scrolling means to navigate between the targets to select one of them;

With continuous description of the current embodiment, preferably, each time the user adds a new character or provides a correction procedure of the invention to provide a precise character (e.g. that may also cause the system to propose another word/stem), the system may update the selection (to be proposed), accordingly.

According to a preferred embodiment, using the second keypad of the invention (tapping on a letter key, or gliding corresponding to a letter key) during the entry of a word may correspond to the correction procedure of the invention, and using said second keypad not during entering a word may correspond to navigating and/or selecting one of the targets (proposed) in the selection.

As an example, FIG. 29A shows the screen of a device such as a computer or a TV. The screen shows as an example, a media search interface 302000 having different zones, a first zone 302001 for entering keywords to search a media such as a song title, a second zone 302002 printing the selection of the titles shown by the system based on the keywords entered by the user, and a third zone 303003 showing the cover page of the first title in the selection. In this example, FIG. 29A shows the interface 302000 after the word “rain” 302004 being entered (by pressing the corresponding keys of the first keypad and providing a short gliding action 302009 during the correction procedure) as the first searching keyword, wherein a selection of titles corresponding to said word is listed in the zone 302002 and for example the first title is highlighted and its cover is shown in the zone 302003. As mentioned before, in order to select another title such as the title “Have you ever seen the rain”, the user may have different choices:
According to a first method, the user may provide an additional word of the song the word “ever”. The only title having said two keywords is the desired title “Have you ever seen the rain”. The system selects it.
According to another method, the user may provide five times long (e.g. downward) gliding actions to navigate between the titles until the system reaches the sixth title which in this example is the desired title and selects/highlights it.
According to another method, illustrated in FIG. 29B the user may provide a short gliding action 29109 duplicating the interaction with the key of the second (telephone-type) keypad having the letters “ghi”. Then as shown in FIG. 29B, the system provides a selection of titles 302102 each having the word “rain” and beginning with one of the letters “ghi”, and highlights the first title. At this time a long downward gliding action 302109 provided by the user informs the system to select the next title in the list “have you ever seen the rain”, which is the desired title.

As mentioned, the data entry system of the invention may, be used in or may provide, many applications. For example, the system may be used in a (learning) game so that to ease and accelerate the learning of the location of the letters on the keys of the first keypad of the invention.

According to one embodiment of the invention, a game may be designed as described hereafter:

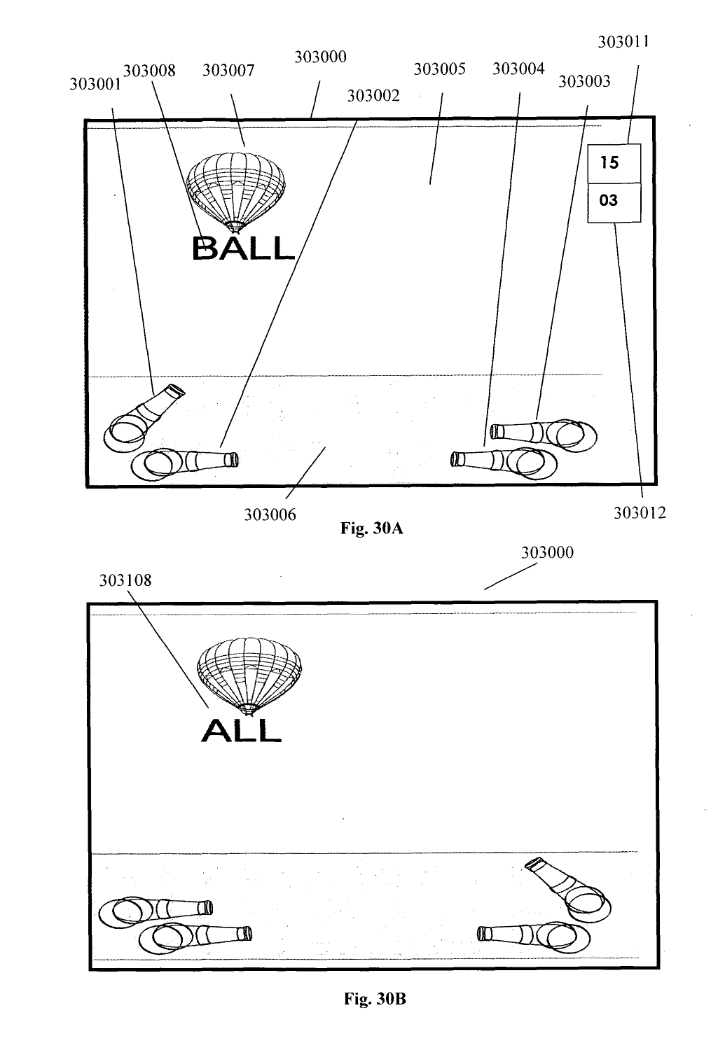

As an example of a game, FIG. 30A shows four canons 303001 to 303004 representing four (ambiguous) letter keys of the first keypad of the invention. It also shows the sky 303005 and the sea 303006. After the user starts the game, a montgolfier 303007 including a word/stem 303008 may descend from the sky 303005 towards the sea 303006. At this time, the user may press on the canon 303001 or on (e.g. or a button corresponding to said canon) relating to the first letter of the word 303008. If the user uses the correct canon/button, then the system shoots a bullet toward the first character of the word/stem and, as shown in FIG. 30B, destroys said character and the system shows the remaining characters of said word 303108. If the word includes more than one character the user then presses on the buttons/canons corresponding to the following letters of the word until all of the characters are destroyed. At this time the montgolfier preferably will ascend upwards towards the sky, and generally another montgolfier including another word/stem will descend from the sky, and the user provides the procedure, and so on.

With reference to FIG. 30A, according to a preferred method, shooting all of the letters must occur before the mongolfier reaches the sea 303006. If the mongolfier reaches the sea before all of its characters are destroyed, the user gets “Unsuccessful” (e.g. negative) point(s) 303012.

According to one method, during shooting a character, if the user uses a wrong canon/button, then the bullet hits the montgolfier itself and it becomes destroyed and falls into the sea, and preferably, the user gets “Unsuccessful” (e.g. negative) point(s) 303012.

Each time the user succeeds to shoot all of the characters of a word/stem, the system (depending on laps of the time used for said purpose) may provide/add “Successful” (e.g. positive) points to user's score 3030011, and each time the user does not succeed to shoot all of the characters of a word/stem, the system may provide/add points to the “Unsuccessful” score 303012 of the user, or alternatively may deduct points from the “Successful” score 303011.

The system may also have different menus to define different parameters used by the user and accordingly by the game. For example, different descending speeds of the montgolfier downwards, or different lengths (e.g. number of characters) of the words/stems may be used to define different levels of easiness or hardness of the game to fit the game to a beginner, expert, etc.

As mentioned before, different methods may be used to duplicate the interactions with the keys of the second keypad of the invention. For example, instead of gliding actions a trackball (e.g. mouse trackball) may be used for the same purpose. As an example, rolling the trackball towards right may correspond to interacting with the key of a telephone type keypad to which the letters “mno” are assigned. And so on.

The first and second keypads according to embodiments of the invention may have any number of keys, any configuration of keys, any configuration of symbols on their keys, any type of keys (hard, soft, on-screen, etc.), etc. For example, the first keypad of the invention may have eight keys (e.g. including four letter keys) divided into two groups of keys (e.g. wherein each group including two letter keys) and being located on opposite sides (on a surface) of a device. Also, the symbols of the system may be grouped in any number of groups based of any (e.g. arbitrary) category, etc. For example, the special characters on the second keypad may be assigned mainly to a same key so that the user can more easily remember their location. If the second keypad is a standard telephone-type keypad said special characters may be assigned to the key to which the digit “1” is assigned. According to embodiments of the invention said special characters may be assigned also to the keys of the first keypad such that a key of the first keypad and a key of the second keypad (preferably) have at most one common special character.

It should be noted that although different embodiments of the invention relate to different features and methods for entering a word the methods and features may also be used for entering sterns and other data, such as numerical data.

It is noted that the first and second groups of keys may include substantially any suitable number of keys which may be hard or soft keys or combinations of hard and soft keys. The keys may be organized in various configurations and the characters and symbols may be assigned to the keys in any suitable manner. The symbols of the system may be grouped in any number of symbol modes based of any (e.g. arbitrary) category. Optionally, the first group of keys has fewer keys than the second group, as mainly the first group of keys are intended to be used in entering text.

The term key is meant to include an input signal. It also is meant to include any device which identifies finger actuations including pressure sensors, thermal sensors, acceleration sensors, optical systems for tracking movements of the finger, finger caps and gloves with sensors. The sweeping gestures of embodiments of the invention including embodiments for dialing telephone numbers may be identified using various touch sensitive surfaces including internal or external touch screens and a mouse pad. Alternatively, sweeping gestures may be identified by an electronic stylus, acceleration sensors and/or other sensors for identifying user finger movements. The sensors may be mounted on a surface, on finger caps, on gloves and/or on any other suitable mount. The keys or touch screen may be included with processor in the same housing or may be included partially or entirely in a separate unit connected through wires or wirelessly to the unit including processor.

According to one embodiment of the invention the sweeping gestures may be provided in the air and are detected by suitable sensors such as a camera and/or acceleration sensors.

In some embodiments of the invention, the data entry systems are adapted to provide synthesized voice feedback on the letters or symbols entered and/or the current symbol mode such that the user need not look at the screen while entering data.

While the above description relates to the Latin alphabet, the principles of the invention may be implemented on other alphabets.

The special characters on the second keypad may be assigned mainly to a same key so that the user may easily remember their location. If the second keypad is a standard telephone-type keypad said special characters may be assigned to the key to which the digit “1” is assigned.

The data entry device in accordance with any of the above described embodiments may be included in a mobile phone, a PDA, a computer or any other device.

It must be noted that throughout this patent application examples features and methods such as means such as keys, keypads, sensitive surface, number of said means, arrangement of them, interactions such as tapping/gliding, manner of an interaction such as strong, soft, short, long, combination of them such as pressing two keys simultaneously, or pressing a key and providing a gliding action, etc., for entry of a symbol such as a letter or a special characters, a function, etc., have been used to described the principles of the invention through different embodiments, obviously, said features and methods have been used to demonstrate some of the different aspects of the invention. Obviously, said features and methods may be interchanged and/or be combined, and/or other features and methods may be considered, and used by the people skilled in the art. For example, if a predefined interaction in a predefined situation is described to be assigned to a predefined symbol such as a function, obviously, said interaction in said situation may be assigned to another predefined symbol such another function by people skilled in the art.

Thus, while there have been shown and described and pointed out fundamental novel features of the invention as applied to alternative embodiments thereof, it will be understood that various omissions and substitutions and changes in the form and details of the disclosed invention may be made by those skilled in the art within the spirit and/or by using the principles of the invention. It is the intention, therefore, to be limited only as indicated by the scope of the claims appended hereto. It is to be understood that the drawings are not necessarily drawn to scale, but that they are merely conceptual in nature. For example, although the keys are being named and shown as the input means in this patent application, other input means such as user's fingers, sensors used with a glove, and finger caps, may be used. Furthermore, any type of input signals such as any predefined interactions, such as glide actions, different duration actions and/or different pressure levels may be used for the first set and/or second set of keys, including any of those described in PCT applications and Israeli patent applications incorporated here by reference. In addition, any of the features described in these patent documents may be added to any of the above described embodiments.

1. A. system for data entry comprising
a touch sensitive pad for inputting user gestures; and
a processor to assign a virtual keypad to the touch sensitive pad such that user gestures on the pad correspond to keys of the virtual keypad.

2. The system of claim 1, comprising a word predictive application.

3. The system of claim 1, comprising a display to display entered data.

4. The system of claim 1, wherein the virtual keypad is a cellular phone type keypad.

5. The system of claim 4, wherein the processor assigns a predetermined user gesture to the center key of the cellular phone type keypad.

6. The system according to claim 1, wherein the touch sensitive pad comprises a plurality of zones, each zone corresponding to a different mode.

7. The system according to claim 1, wherein different user gestures are assigned to different modes.
